(19) United States
(12) Patent Application Publication
(10) Pub. No.: US 2007/0182114 A1
(43) Pub. Date: Aug. 9, 2007

(54) INDUSTRIAL CART

(76) Inventors: Eric X. Fernandes, Franklin, WI (US); Scott D. Bublitz, Hartland, WI (US); Brian P. Wattenbach, Menomonee Falls, WI (US); Andrew J. Weber, Cudahy, WI (US); Jonathan A. Zick, Waukesha, WI (US); Melissa A. Ottens, Waukesha, WI (US)

Correspondence Address: MICHAEL, BEST & FREIDRICH LLP, 100 EAST WISCONSIN AVENUE, SUITE 3300, MILWAUKEE, WI, 53202, US

(21) Appl. No.: 11/622,877

(22) Filed: Jan. 12, 2007

Related U.S. Application Data
(63) Continuation-in-part of application No. 11/136,618, filed on May 23, 2005.
(63) Continuation-in-part of application No. 11/136,305, filed on May 23, 2005.
(60) Provisional application No. 60/758,788, filed on Jan. 12, 2006.
(60) Provisional application No. 60/785,126, filed on Mar. 23, 2006.
(60) Provisional application No. 60/573,410, filed on May 21, 2004.
(60) Provisional application No. 60/637,634, filed on Dec. 20, 2004.
(60) Provisional application No. 60/573,410, filed on May 21, 2004.
(60) Provisional application No. 60/637,634, filed on Dec. 20, 2004.

(51) Int. Cl. B62B 3/00

(52) U.S. Cl. 280/47.35

(57) ABSTRACT

A cart includes a cart frame having a wall and a wheel connected to the cart frame, which is operable to support the cart for movement over the ground. The cart also includes a reel rack assembly coupled to the wall. The reel rack assembly has a pair of support brackets coupled to the wall in a spaced apart relationship, whereby each support bracket includes a support arm extending outwardly from the support bracket such that the support arms are generally aligned with each other. A shaft is selectively supported by the support arms and extends between the support arms wherein reels are removably positionable on the shaft.

### CROSS-REFERENCE TO RELATED APPLICATION

This application claims priority from U.S. Provisional Patent Application No. 60/758,788, entitled “Industrial Cart”, filed Jan. 12, 2006 by Eric X. Fernandes, Scott D. Bublitz, Brian P. Wattenbach, Andrew J. Weber, Jonathan A. Zick and Melissa A. Ottens-Rendon; and from U.S. Provisional Patent Application No. 60/785,126, entitled “Industrial Cart”, filed Mar. 23, 2006 by Eric X. Fernandes, Scott D. Bublitz, Brian P. Wattenbach, Andrew J. Weber, Jonathan A. Zick and Melissa A. Ottens-Rendon.

This application is also a continuation-in-part of and claims priority from U.S. patent application Ser. No. 11/136,618, entitled “Industrial Cart”, filed May 23, 2005 by Eric X. Fernandes, Scott D. Bublitz, Brian P. Wattenbach, Andrew J. Weber, Jonathan A. Zick, Melissa A. Ottens-Rendon, Jerry Brown, Travis Shamp, Jeff Boll, Guy Lyon, and Doug Hardesty; and from U.S. patent application Ser. No. 11/136,205, entitled “Industrial Cart”, filed May 23, 2005 by Eric X. Fernandes, Scott D. Bublitz, Brian P. Wattenbach, Andrew J. Weber, Jonathan A. Zick, and Melissa A. Ottens-Rendon; both of which claim priority from U.S. Provisional Patent Application No. 60/573,410, entitled “Industrial Cart”, filed May 21, 2004 by Eric Fernandes and Scott Daniel Bublitz, and U.S. Provisional Patent Application No. 60/637,634, entitled “Industrial Cart”, filed Dec. 20, 2004 by Eric Fernandes, Scott Daniel Bublitz, Brian P. Wattenbach, Andrew J. Weber, and Jonathan A. Zick.

The entire contents of all of these applications are hereby incorporated by reference.

### BACKGROUND

The present invention relates to carts and, more particularly, to carts for industrial purposes and accessories for use with such carts.

Carts are often used for storing and transporting various items. Carts provide a wheeled apparatus that may be moved by a user to a remote location. The cart enables a user to transport a variety of items that may be necessary to perform a task to a desired location where the task is to be performed. The user may save time and effort by having the necessary supplies for the task available in one centralized and mobile cart.

### SUMMARY

In some aspects and in some constructions, the present invention provides a cart including a cart frame having a wall and a wheel connected to the cart frame, which is operable to support the cart for movement over the ground. A reel rack assembly is coupled to the wall. The reel rack assembly includes a pair of support brackets coupled to the wall in a spaced apart relationship, each support bracket having a support arm extending outwardly from the support bracket such that the support arms are generally aligned with each other. A shaft is selectively supported by the support arms and extends between the support arms wherein reels are removably positionable on the shaft.

In some aspects and in come constructions, the present invention provides an industrial cart including a base having a base support surface for supporting an item, and a wheel connected to the base and operable to support the car for movement over ground. A table has a table support surface for supporting an item, the table being supported in spaced relation from and being at least partially above the base. A plurality of uprights cooperate to support the table in spaced relation from the base wherein at least one of the plurality of uprights is provided by a wall. The industrial cart also includes a reel rack assembly coupled to the wall. The reel rack assembly includes a pair of support brackets coupled to the wall in a spaced apart relationship, each support bracket has a support arm extending outwardly from the support bracket such that the support arms are generally aligned with each other. A shaft is selectively supported by the support arms and extends between the support arms wherein reels are removably positionable on the shaft.

In some aspects and in some constructions, the present invention provides a cart including a cart frame having a wall and a wheel connected to the cart frame, which is operable to support the cart for movement over the ground. A reel rack assembly is coupled to the wall. The reel rack assembly includes a pair of support brackets coupled to the wall in a spaced apart relationship, each support bracket having a support arm extending outwardly from the support bracket such that the support arms are generally aligned with each other. A shaft is selectively supported by the support arms and extends between the support arms wherein reels are removably positionable on the shaft. A frame is removably coupled to the shaft and extends between opposite ends of the shaft. The frame includes a central portion extending between first and second end portions, wherein each end portion is generally V-shaped and includes a first leg and a second leg. The second leg defines a support surface of the frame and the shaft is coupled to each end portion at an intersection of the first and second legs. The frame has a height defined between the shaft and the support surface, and the height is greater than a radius of the reel removably positionable on the shaft.

Independent features and independent advantages of the present invention will become apparent to those skilled in the art upon review of the following detailed description and drawings.

### BRIEF DESCRIPTION OF THE DRAWINGS

FIGS. 1A-1I are views of alternative constructions of an industrial cart.

FIGS. 2A-2I are views of a further construction of an industrial cart.

FIGS. 3A-3G are views of an alternate construction of the industrial cart shown in FIGS. 2A-21 and illustrating an “open” cart construction.

FIG. 4 is a view of portions of the industrial cart shown in FIGS. 3A-3G and illustrating assembly and packaging of the industrial cart.

FIGS. 5A-5O are views of a portion of an industrial cart including an assembly for supporting a reel.

FIGS. 6A-6L are views of a portion of an industrial cart including a work piece holder or vise assembly.

FIGS. 7A-7F are views of a portion of an industrial cart including a storage assembly.

FIGS. 8A-8K are views of a portion of an industrial cart including a tank storage assembly.

FIGS. 9A-9N are views of a portion of an industrial cart including an alternative construction of an assembly for supporting a reel.

FIGS. 10A-10E are views of a portion of the assembly shown in FIGS. 9A-9N.

FIGS. 11A-11E are views of a portion of an industrial cart including an alternative construction of a work piece holder or vise assembly.

FIGS. 12A-12E are views of a portion of the vise assembly shown in FIGS. 11A-11E.

FIGS. 13A-13E are views of a portion of an industrial cart including an alternative construction of a tank storage assembly.

FIGS. 14A-14C are views of a portion of the tank storage assembly shown in FIGS. 13A-13E.

FIGS. 15A-15D are views of another portion of the tank storage assembly shown in FIGS. 13A-13E.

FIGS. 16A-16D are views of a portion of an industrial cart and illustrating connection of the table assembly and the uprights.

FIGS. 17A-17C are views of a two-wheeled cart for use with modular accessories or assemblies.

FIGS. 18A-18C are views of a wall for use with a two-wheeled cart, such as the cart shown in FIGS. 17A-17C.

FIGS. 19A-19H are views of an alternative construction of a wall for use with an industrial cart, such as the cart shown in FIGS. 2A-21 and 3A-3G, or with a two-wheeled cart, such as the cart shown in FIGS. 17A-17C.

FIGS. 20A-20D are views of brackets or supports for use in an assembly for supporting one or more reels and for use with a wall, such as the wall shown in FIGS. 18A-18C or in FIGS. 19A-19H, or with a two-wheeled cart, such as the cart shown in FIGS. 17A-17C.

FIGS. 21A-21C are views of the brackets, shown in FIGS. 20A-20D, used with a wall, shown in FIGS. 18A-18C.

FIGS. 22, 23 and 24A-24C are views of a two-wheeled cart, shown in FIGS. 17A-17C, usable with a wall, shown in FIGS. 18A-18C, and with brackets, shown in FIGS. 20A-20D.

FIGS. 25A-25B and 26A-26D are views of an alternative construction of a connecting arrangement for the brackets shown in FIGS. 20A-20D and illustrating the use of the connecting arrangement to connect the brackets to a two-wheeled cart, shown in FIGS. 17A-17C.

FIG. 27 is a front view of an alternative construction of brackets and illustrating a stored position of the brackets on a portion of a two-wheeled cart.

FIGS. 28A-28C are views of a storage/carrying assembly for use with an industrial cart, such as the cart shown in FIGS. 2A-2I and 3A-3G, or with a two-wheeled cart, such as the cart shown in FIGS. 17A-17C.

FIGS. 29A-29C are views of a tank storage assembly for use with an industrial cart, such as the cart shown in FIGS. 2A-2I and 3A-3G, or with a two-wheeled cart, such as the cart shown in FIGS. 17A-17C.

FIGS. 30, 31 and 32 are views of a two-wheeled cart, shown in FIGS. 17A-17C, usable with a storage/carrying assembly, shown in FIGS. 28A-28C, and with a tank storage assembly, shown in FIGS. 29A-29C.

FIGS. 33A-33B are views of a two-wheeled cart, shown in FIGS. 17A-17C, usable with a work piece holder or vise assembly and illustrating operation of the assembly.

FIGS. 34A-34B are views of a two-wheeled cart, shown in FIGS. 17A-17C, usable with a storage container, tool box or similar structure and illustrating operation of the assembly.

FIGS. 35A-35C illustrate another construction of a two-wheeled cart, such as the cart shown in FIGS. 17A-17C, usable with a storage container, tool box or similar structure.

FIG. 35D illustrates an alternative construction of the two-wheeled cart shown in FIGS. 35A-35C.

FIGS. 36A and 36B illustrate another construction of a wheeled cart, such as the cart shown in FIGS. 17A-17C, usable with a storage container, tool box or similar structure, whereby the cart may be oriented for use as a two-wheeled cart or a four-wheeled cart.

FIG. 37A illustrates another construction of a wheeled cart, such as the cart shown in FIGS. 2A-2I and 3A-3G, usable with a storage container, tool box or similar structure.

FIGS. 37B and 37C illustrate a slidable storage container assembly for use with the cart shown in FIG. 37A.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

Although references are made below to directions, such as left, right, up, down, top, bottom, front, rear, forward, back, etc., in describing the drawings, they are made relative to the drawings (as normally viewed) for convenience. These directions are not intended to be taken literally or limit the present invention in any form.

### DETAILED DESCRIPTION

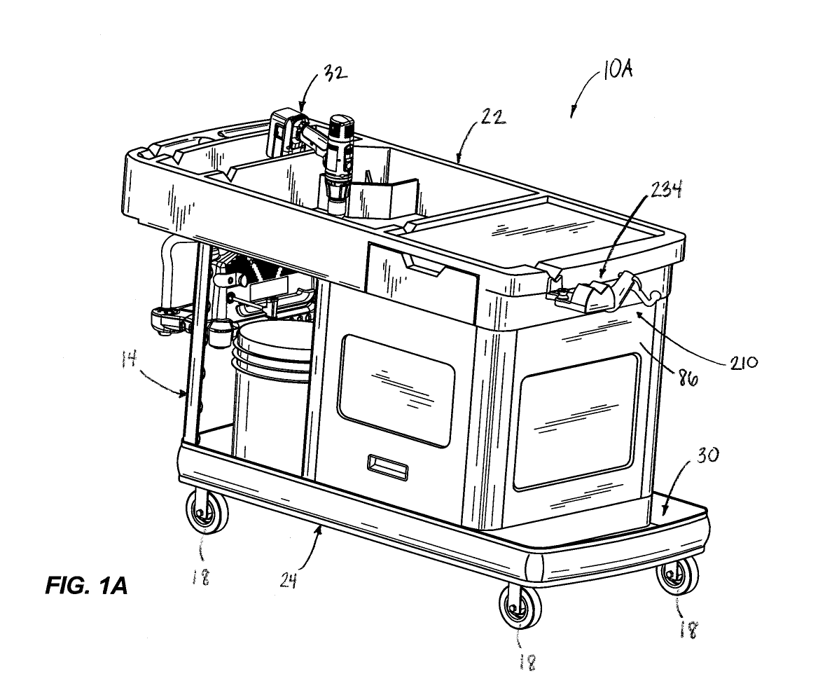

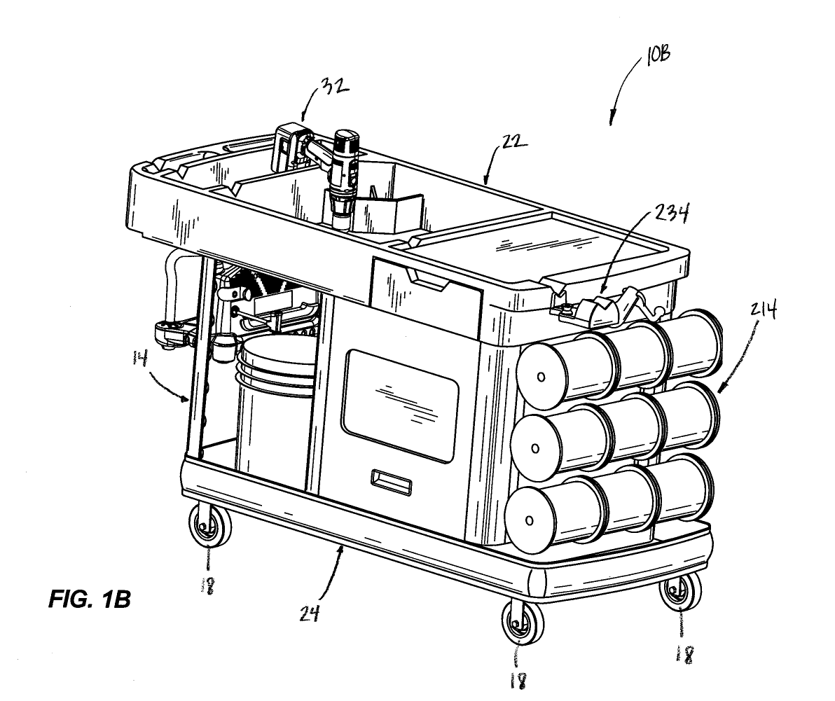

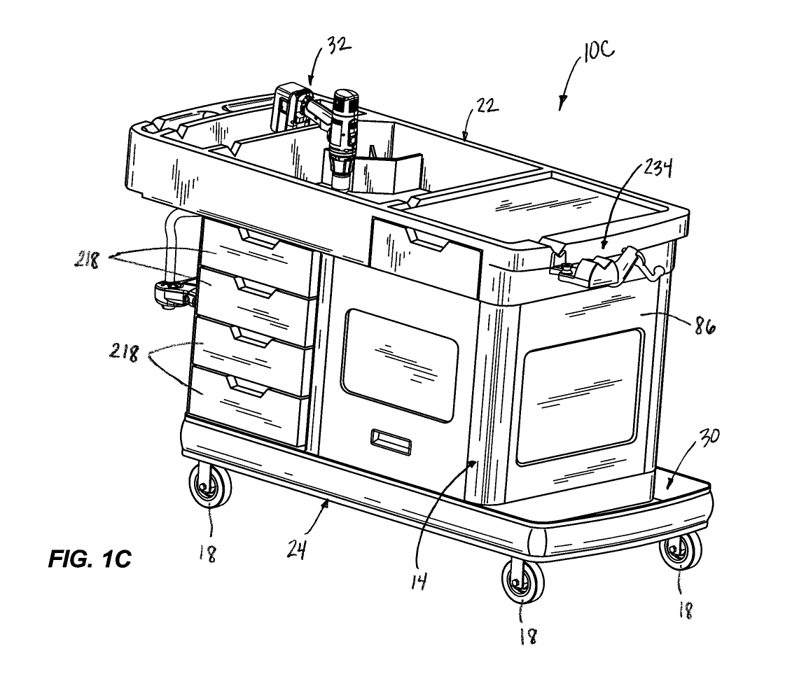

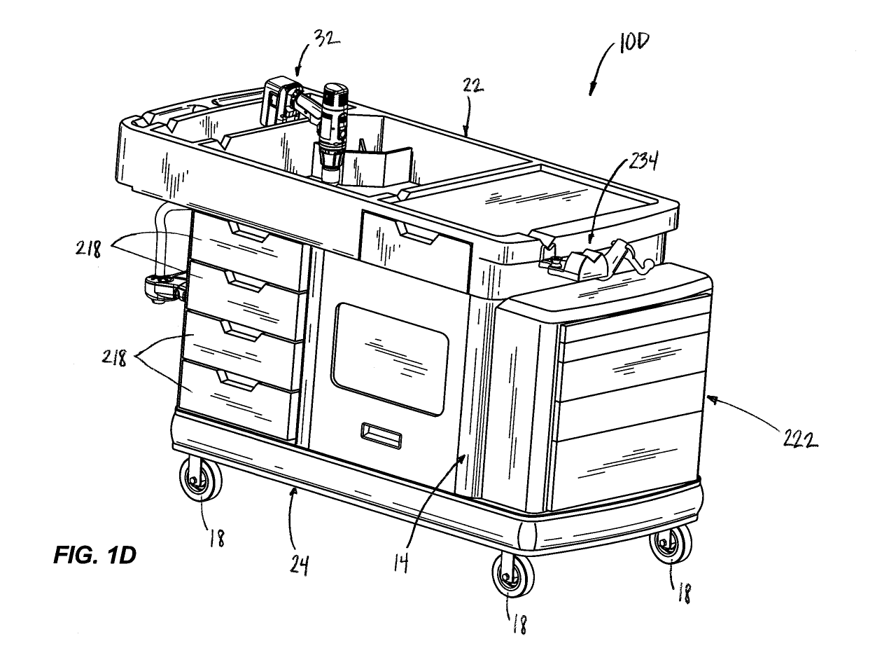

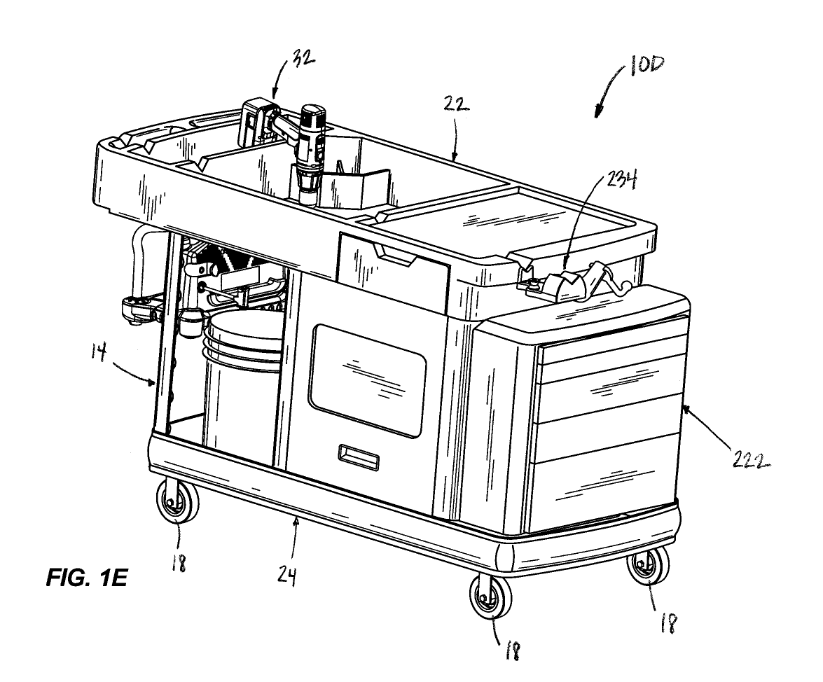

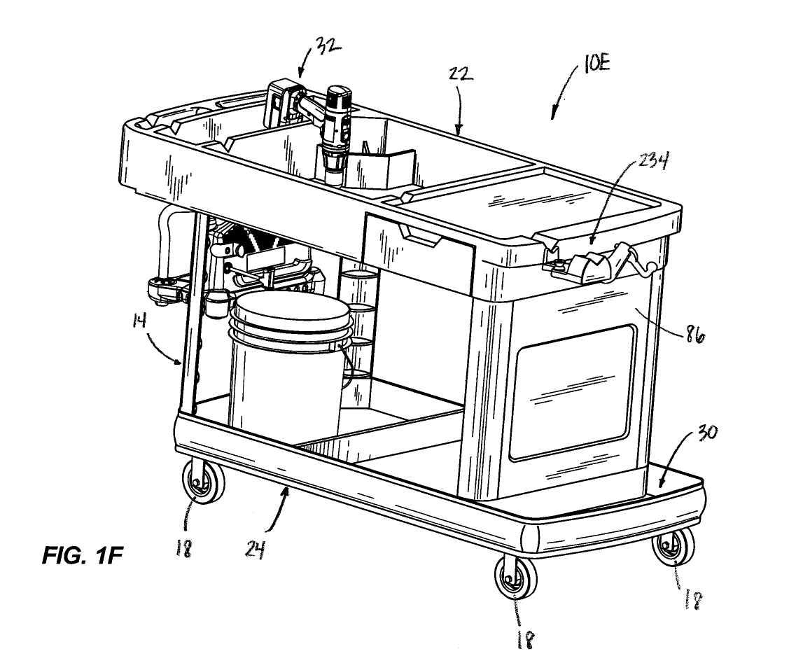

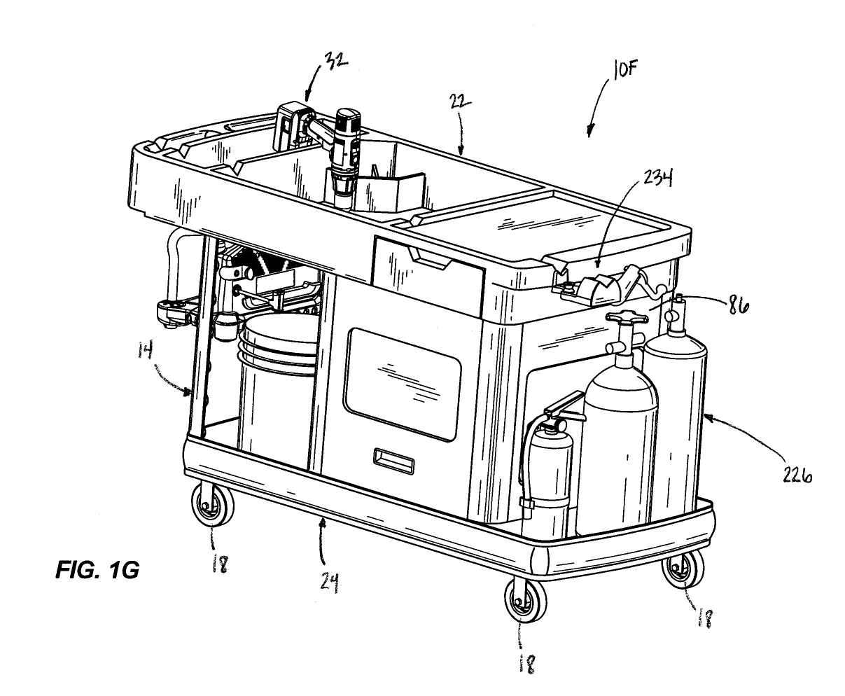

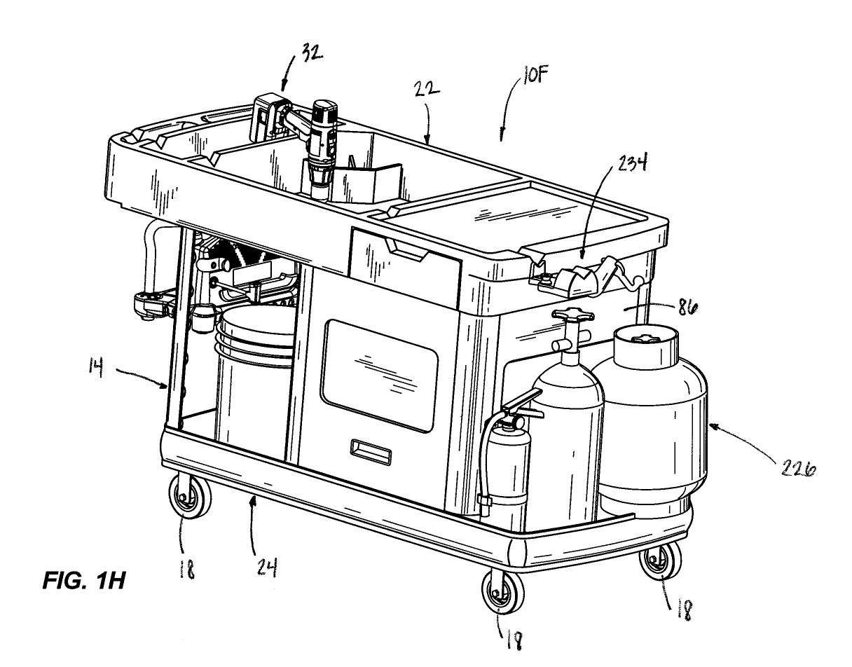

FIGS. 1A-1I, 2A-2E, 3A-3G and 4 illustrate constructions of a cart, such as an industrial cart 10. In some aspects and in some constructions, the cart 10 (and the carts, described below) provide a modular structure that may support various sub-assemblies, apparatus, equipment, supplies, etc. The sub-assemblies may be selectively added on or removed from the cart 10 to customize the cart 10 for a particular purpose. The modular frame and sub-assemblies permit a user to have a single cart 10 capable of being configured for a wide variety of tasks.

The cart 10 may be configured by the manufacturer, seller or user for a particular purpose. For example, the cart 10 may be customized or customizable to include various apparatus, equipment and/or supplies that are useful for a particular task. Alternatively, the manufacturer and/or seller may initially provide a base cart 10 generally configured for a particular purpose, and the seller and/or user may specifically configure the cart 10 for the particular purpose. The apparatus, equipment and/or supplies supported on the cart may be selected depending on the tools and items helpful for performing tasks associated with, for example, a particular construction trade. The cart and its contents may be specialized for various trades, such as, for example, carpenters, metal workers, electricians, plumbers, other similar trades, etc. In the constructions illustrated in FIGS. 1A-1I, 2A-2E, 3A-3G and 4, the cart 10 is configured to be used by a general contractor, a framer, a finisher, a wood worker, etc. The cart 10 generally provides a mobile work bench that may be transported to various work sites and that stores and supports tools, equipment and/or supplies in on convenient place.

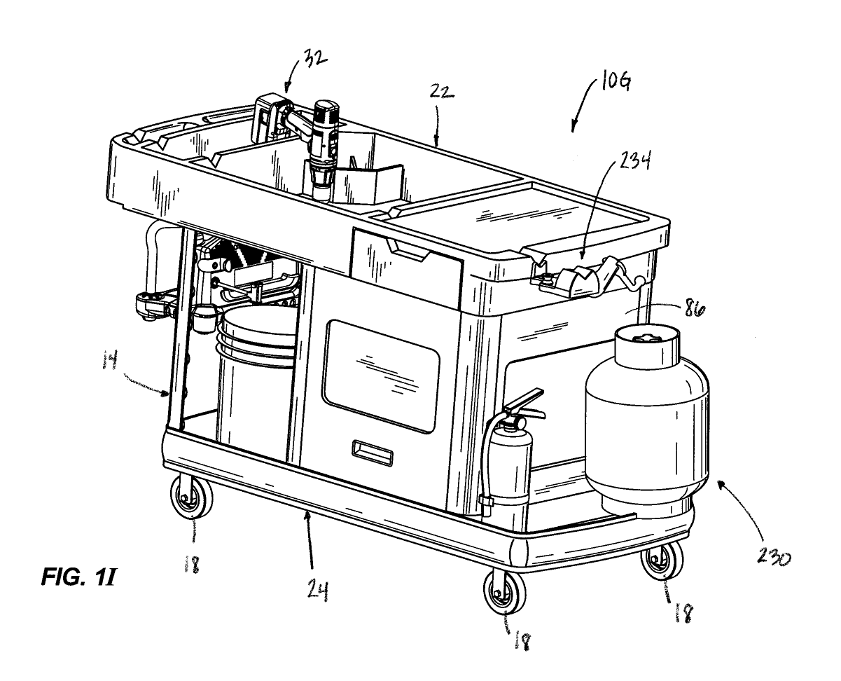

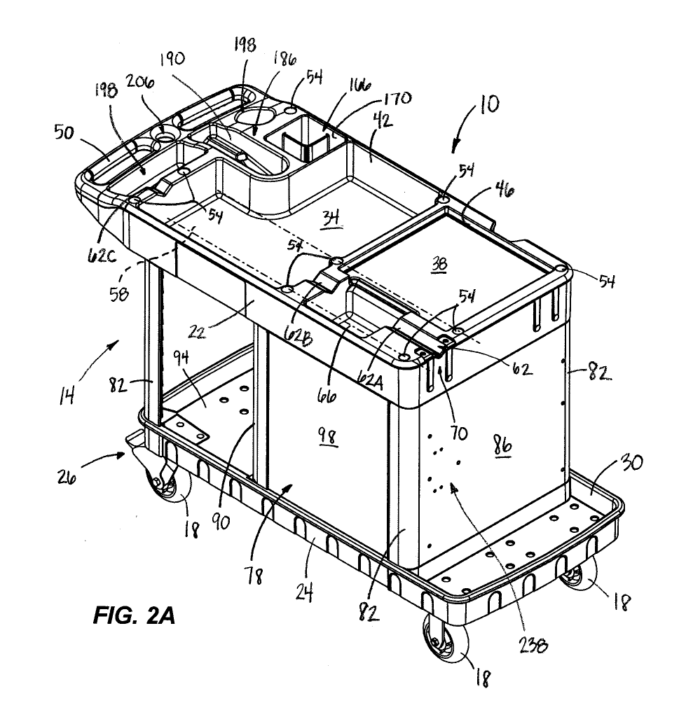

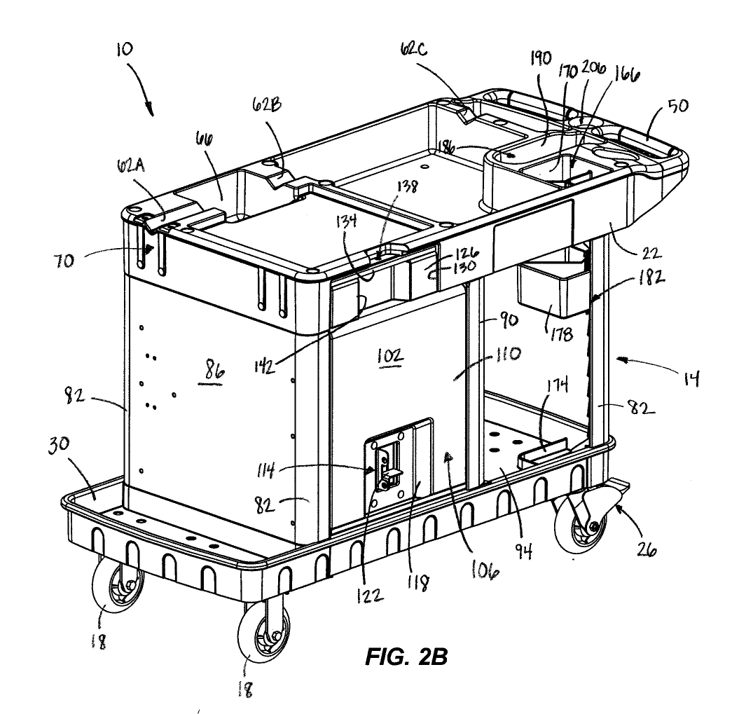

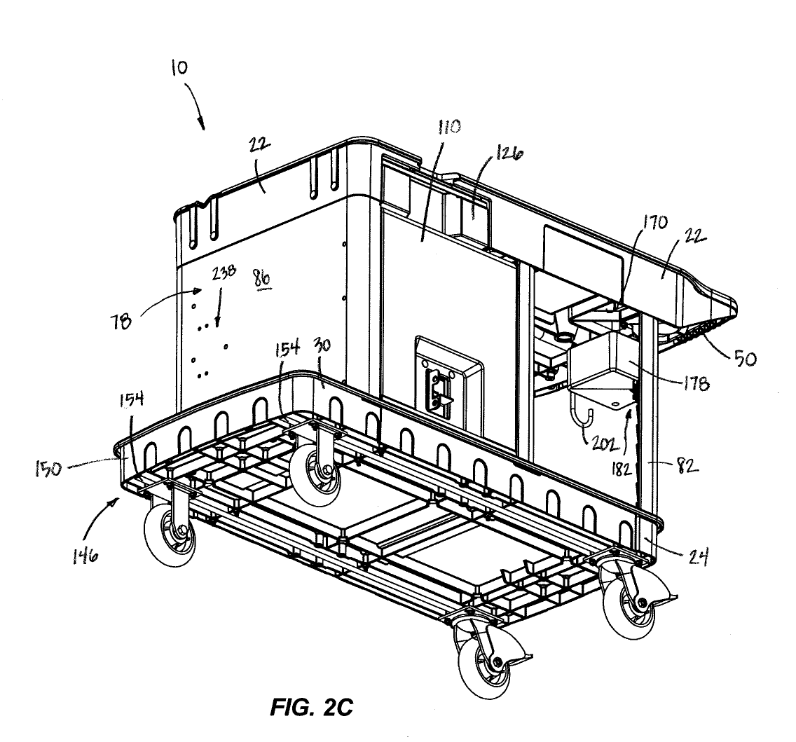

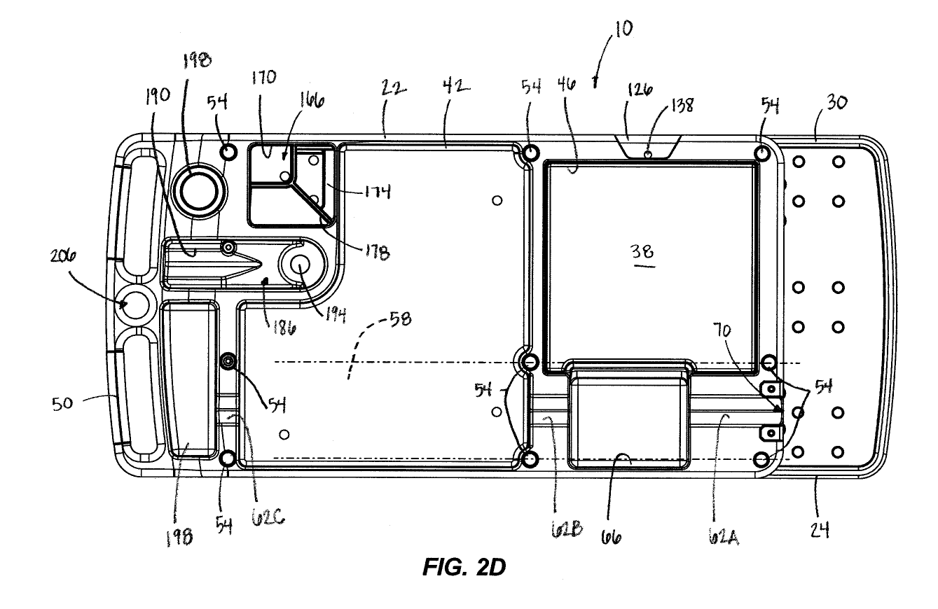

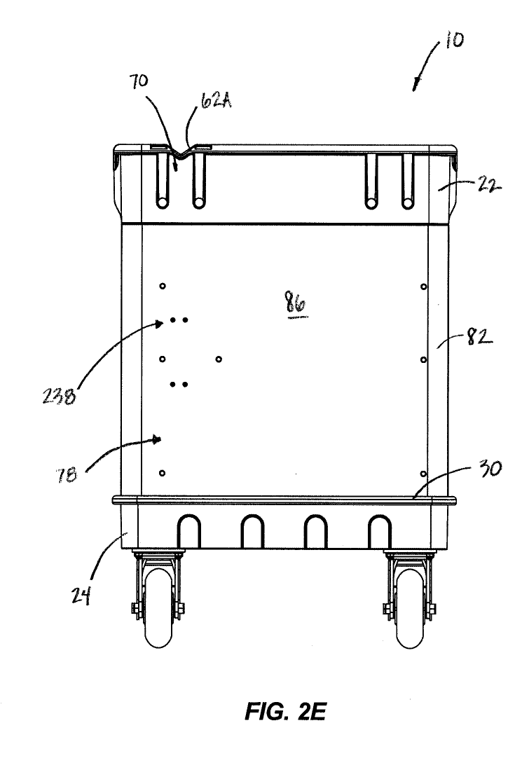

Many of the elements illustrated in 1A-1I, FIGS. 2A-2E, 3A-3G and 4 are the same, and the following description will be directed to the elements as shown in the relevant figures of FIGS. 2A-2E. It should be understood that, unless otherwise indicated, the elements are shown in the relevant figures of FIGS. 1A-1I, 3A-3G and 4 are the same.

As shown in FIGS. 2A-2E, the cart 10 generally includes a frame 14 and wheels 18 supporting the frame 14 for movement to, from and around a work site. The frame 14 includes a top shelf 22 or surface for supporting tools and other accessories, and providing a work surface. The wheels 18 are connected to a bottom, a lower shelf or a base 24 of the cart 10. The wheels 18 facilitate transport of the cart 10 and may include structure to secure the cart 10 in position (e.g., for transport, storage, etc.). Such structure may include wheel locks 26 which may selectively prevent rotation of the wheels 18 to prevent unwanted movement of the cart 10 and to provide a stable work area for the user.

The cart 10 provides a modular frame 14 for supporting a variety of sub-assemblies or features. The sub-assemblies may be added to the modular frame 14 by the manufacturer and/or by the user to customize the cart 10 for various tasks.

In some constructions, the cart 10 may include tie down hooks or eyelets (not shown) to aid in securing the cart 10 for transport or overnight on the job site. In some constructions, the cart 10 may include a towing hitch option (not shown) to aid in securing the cart 10 to a powered vehicle for towing to, from and/or around a job site.

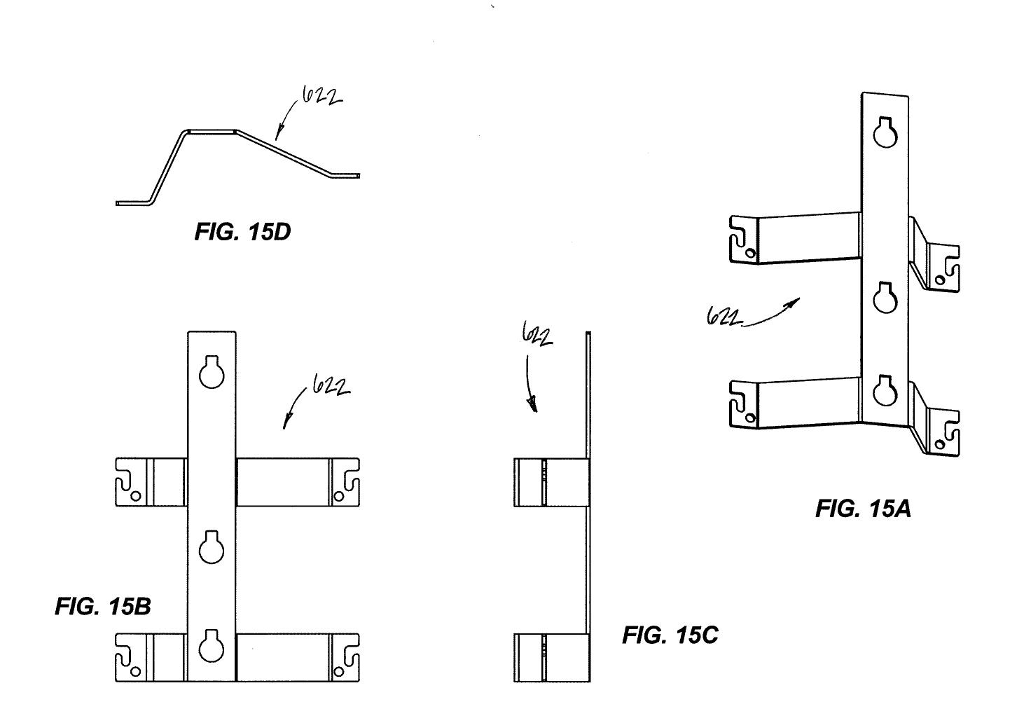

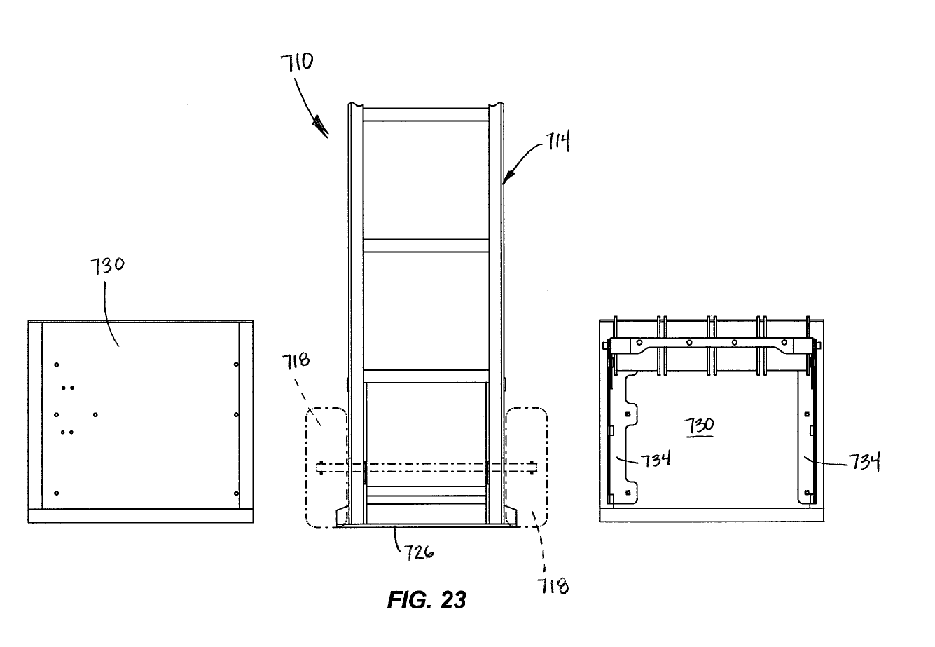

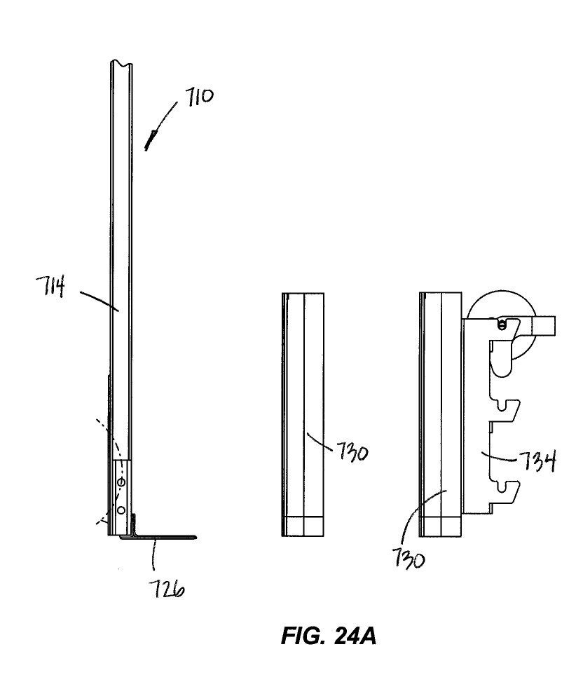

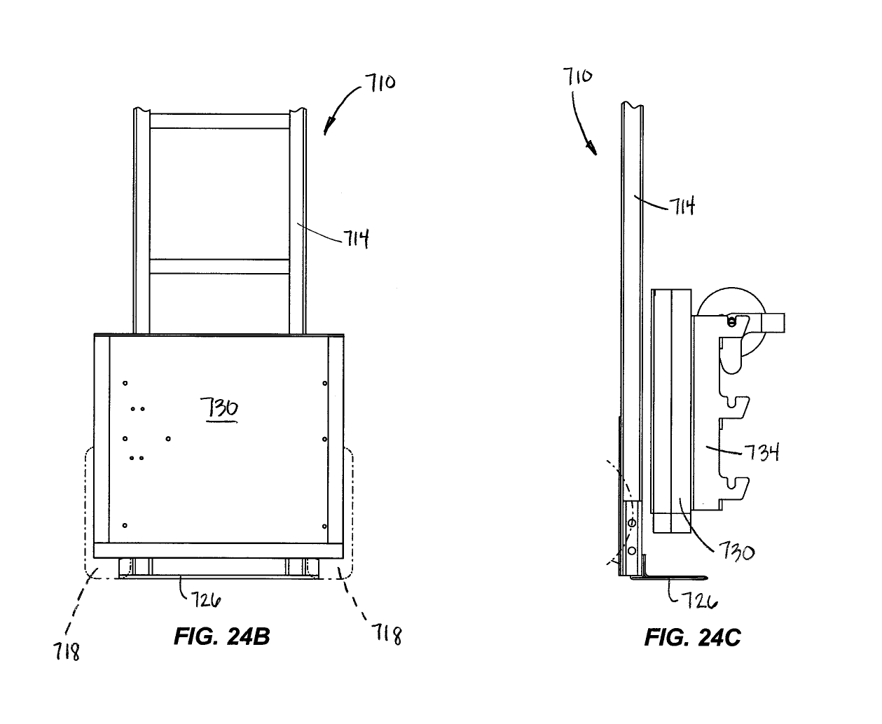

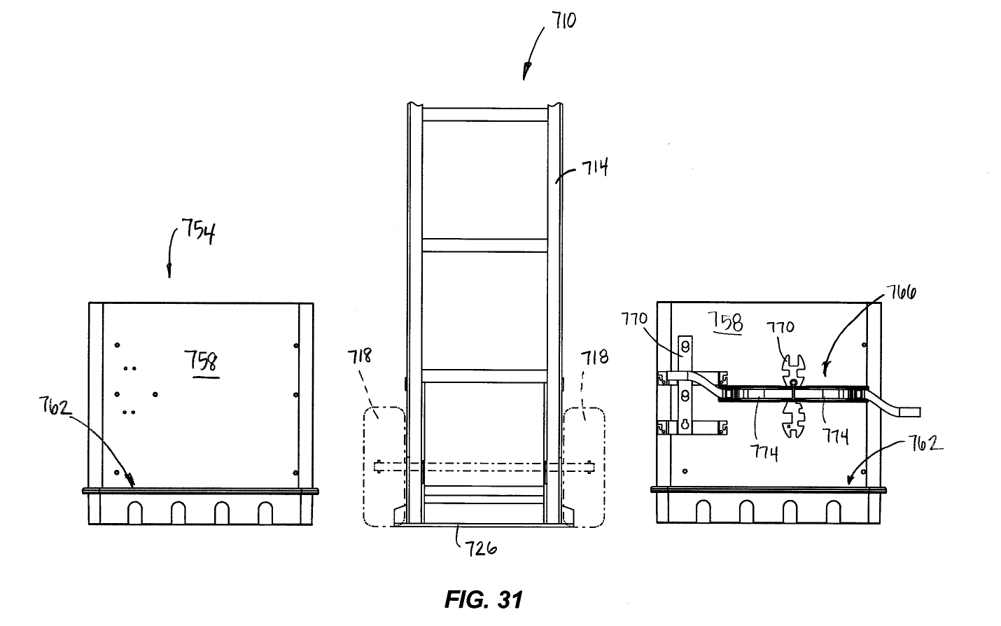

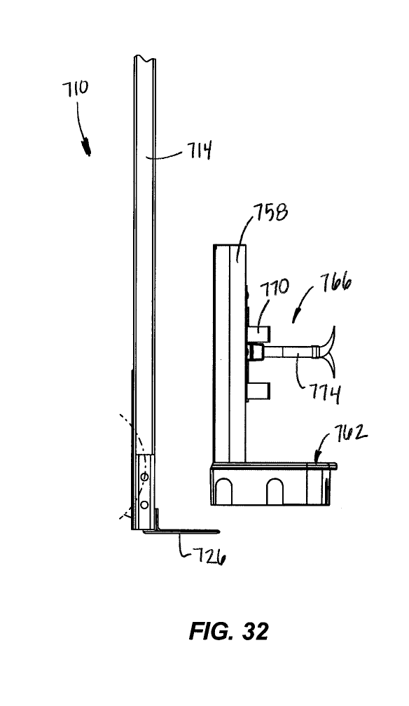

In some constructions and in some aspects (see FIGS. 2A-2E, 3A-3G, 5A-50, 6A-6L, 7A-7F and 8A-8K), the industrial cart 10 may include an extended front deck 30 on the lower shelf 24. FIGS. 1A-1I show a similar front deck 30.

As explained below, in some constructions (see, for example, FIGS. 1B, 1D, 1E, 17B, 17D, 17E, 5A-50, 6A-6L, 7A-7F and 8A-8K), the extended front deck 30 may, for example, allow for storage and attachment of modular accessories. The modular accessories may be quickly attachable, removable, replaceable, etc. For example, a uniform connector may be provided on the front of the cart (e.g., a uniform hole pattern on a surface of the cart 10) allow for the attachment of modular accessories having a complementary connector.

As shown in FIGS. 2A-2E, the cart 10 also includes the table, top shelf or work surface 22 near the top of the cart 10 opposite the wheels 18. In some constructions and in some aspects, the top shelf 22 is tiered or has varying height shelf portions. FIGS. 1A-1I show a similar top shelf 22. A power tool 32 (FIGS. 1A-1I) may be mounted on the work surface 22. In the illustrated construction, the power tool 32 includes a drill; although in a further construction, the power tool may alternatively include a miter saw, jigsaw, band saw, other similar power tool, other equipment, etc. In an alternative construction, the work surface 22 includes table top portions positionable on opposite sides of the power tool 32 and slidable relative to one another to uncover a support surface for the power tool 32.

In the illustrated construction (see FIGS. 2A-2B and 2C), the top shelf includes two tiers to generally provide a storage area 34 and a work area 38. The storage area 34 generally includes a relatively deep recessed open area (having a 3-½″ to 5″ lip) on the handle side of the cart 10 (e.g., for storage of small parts, boxes, tools, etc.). Inner supports or ridges 42 may be provided to allow a cover (e.g., a ¾″ sheet of plywood (not shown)) to cover open area of the storage area 34.

The work area 38 may generally include a shallow depth work surface area (having a ¾″ to 1-½″ lip 534) on front of the cart 10. For example, a shallow lip 46 allows plywood to be used as a sacrificial, replaceable work surface. Also, the shallow lip 46 allows for sheet steel to be inserted to protect the cart from high temperature work operations. In addition, because the height of the lip 46 on the work area 38 is relatively low, heavy items may be easily placed on the work area 38 for transport on the cart 10, to be worked on, etc. A main handle 50 is generally positioned at the same height as or slightly lower than the work area 38 and storage area 34 so that larger components (e.g., fluorescent light fixtures, pipe systems, etc.) that are longer than the cart 10 can be easily staged and/or assembled on the cart 10. Electrical work commonly includes relatively small pieces, such as, for example, wire endings, outlets, small screws, connectors, or other similar pieces, and relatively small hand tools, such as, for example, pliers, crimpers, wire strippers, soldering devices, or other similar tools. The recessed main surface 38 and raised ridges 46 may prevent small electrical accessories, pieces, or tools form sliding off the table top portion 30.

As shown FIGS. 2A-2B and 2C, in some constructions and in some aspects, the top shelf 22 may have multiple (e.g., 6-9) flat-bottomed holes 54 positioned at the corners and/or mid-points of the cart 10. These holes 54 accept posts (not shown) and may be sized to accept either ¾″ conduit (EMT) or PVC pipe to create stakes or posts that help to, for example, secure both loose and bundled building materials (e.g., pipe, threaded rod, studs, etc.) so that the material(s) can be easily moved around the job site while on top of the cart 10 without falling off. In the illustrated construction, several (e.g., 3) holes 54 that run down the middle of the cart are offset and are positioned about 6″ inside of the complementary (e.g., 3) holes 54 that run down one side of the cart to create a storage zone 58 that fits common material bundles while leaving the remaining portions of the top shelf 22 open for work and assembly activity.

In some constructions, a user could also use a pipe bender to bend conduit to create a removable second handle (not shown) at the front of the cart 10 above the front deck 30. A user could also use a pipe bender to bend conduit to create removable long handles/material supports (not shown) that run the length of the cart 10 to which supplies and equipment could be hung along the sides of the cart 10. In addition, a user could use a pipe bender to bend conduit to create a removable means (not shown) of securing cases of fluorescent bulbs vertically on the front deck 30 of the cart 10.

As shown in FIGS. 2A-2E, in some constructions and in some aspects, the industrial cart 10 may include one or more material cutting aids. FIGS. 1A-1I show similar material cutting aids.

For example, as shown in FIGS. 2A-2E, the cart may include a channel 62 molded into the upper shelf 22. Material (not shown), such as, for example, lengths of pipe, conduit, wood, etc., may be positioned in the channel 62 and retained in position by engagement with the side walls of the channel 62. The channel 62 may have a generally V-shape and may be positioned on the top shelf 22 extending along the length (the longest side) of the cart 10 to allow for use in relatively narrow work areas (e.g., in a hallway). The channel 62 may receive and retain electrical conduit sections of varying cross-section and/or diameter with the slanted surfaces supporting the conduit. The retained conduit sections may be cut to desired lengths while retained in the channel 62. The open ends of the channel 62 permit a conduit section having a length longer than the channel 62. The open ends of the channel 62 permit a conduit section having a length longer than the channel 62 or top shelf 22 to be supported.

In the illustrated construction, the channel 62 is provided by one or more channel portions 62A, 62B, 62C extending along the axis of the channel 62. The channel portions 62A-62C are formed in portions of the upper shelf 22 adjacent the top surface of the upper shelf 22. In other constructions (not shown), a single channel portion may provide the channel 62. In one construction, the channel 62 is positioned along a length of the cart 10.

As shown in FIGS. 2A-2B and 2D, a lateral opening or pocket 66 may be formed under the channel 62 near the cutting location to allow a user to grip around the material that is being cut for improved control of the material. This pocket 66 may act as both a location to grip the material and as a storage location for building supplies, equipment, etc.

In another construction, the cart may include uprights providing the channel 62. The uprights may be pivotable (e.g., to change the orientation of the axis of the channel 62, to move the upright to a stored, non-upright position, etc.) and may be movable (e.g., slidable) along the length and/or width of the cart 10. Further, the height of the uprights may be adjustable. In the illustrated construction, the uprights are positioned lengthwise (front to back) on the cart 10.

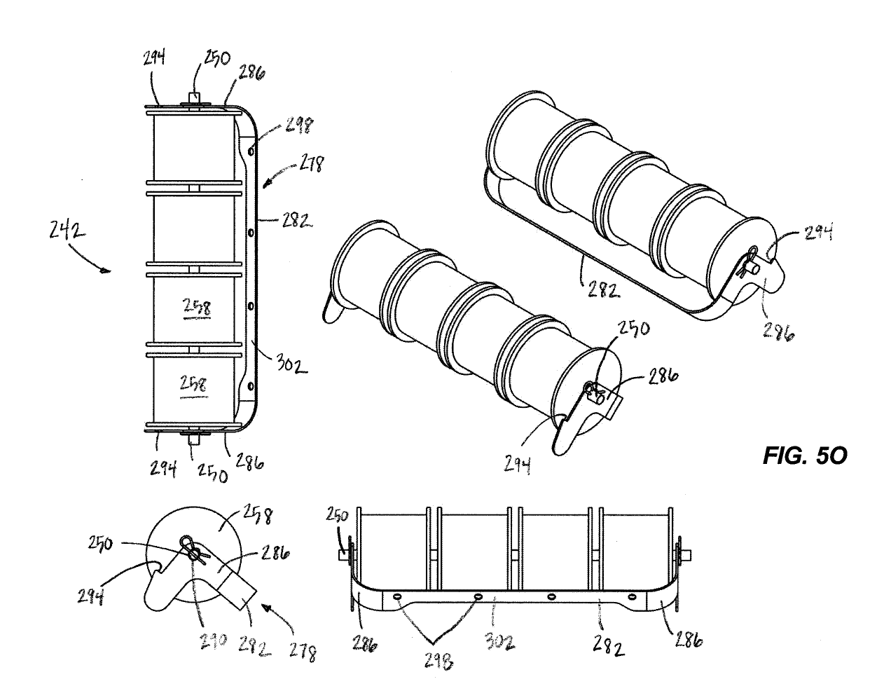

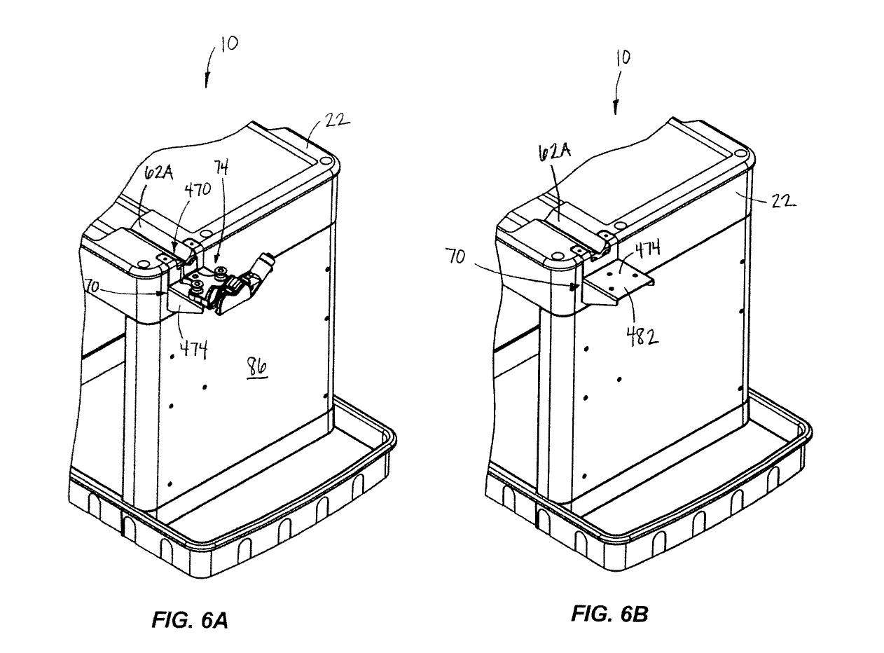

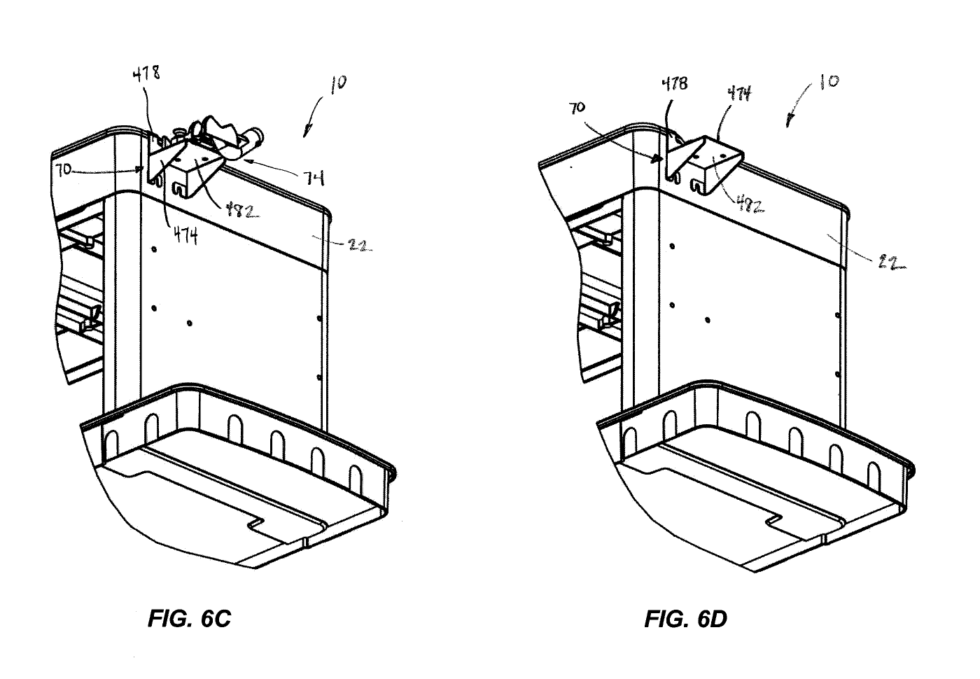

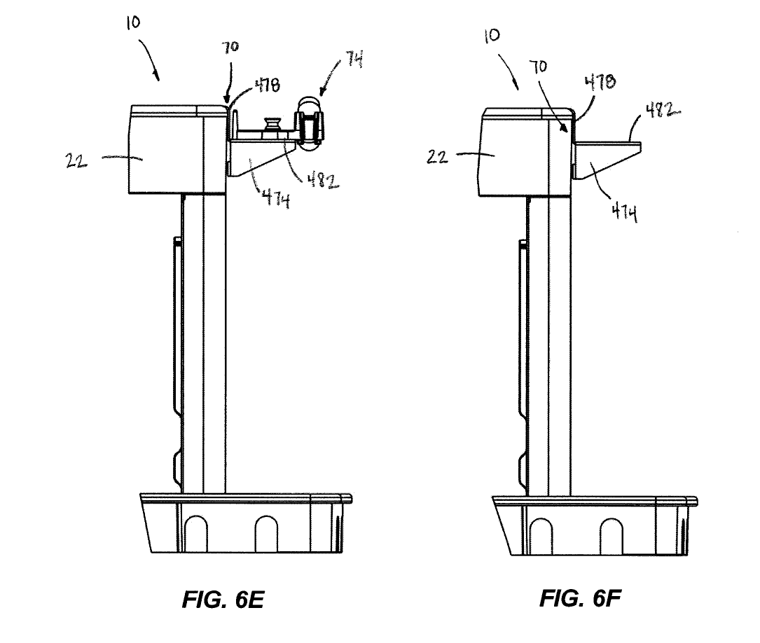

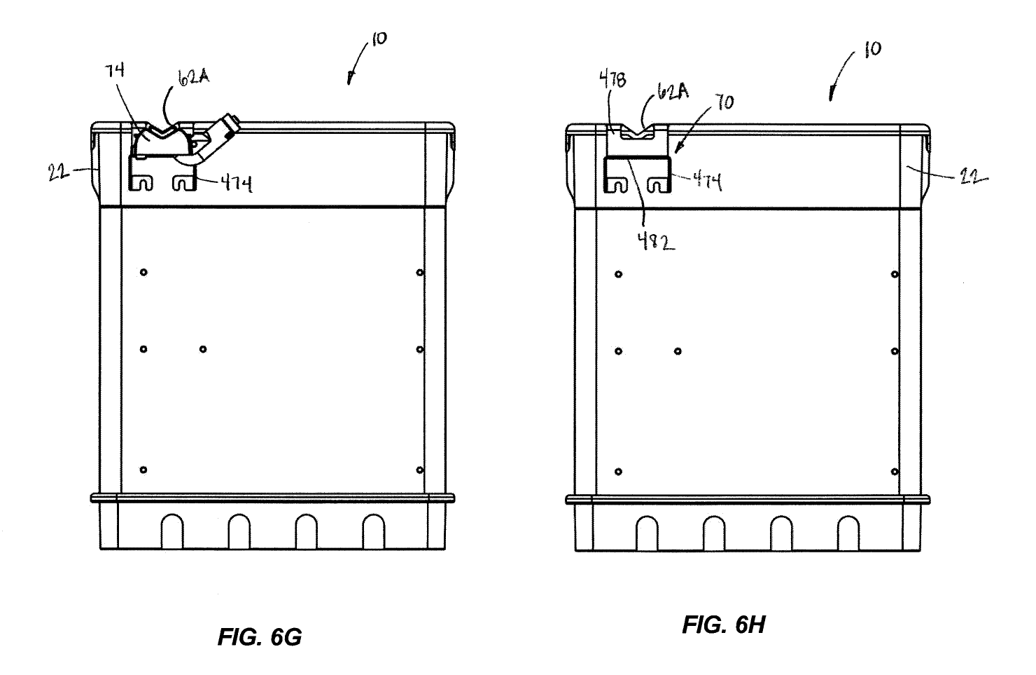

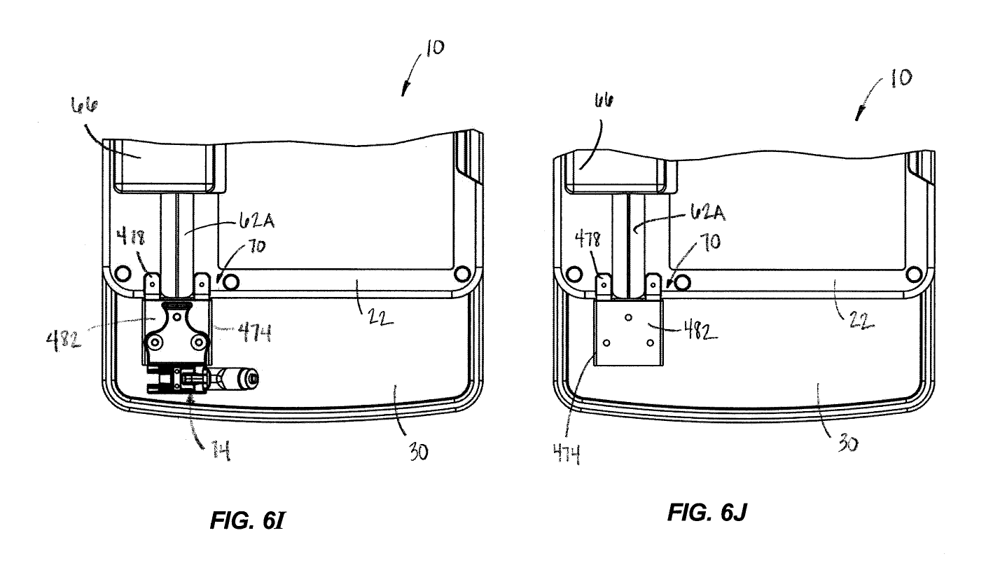

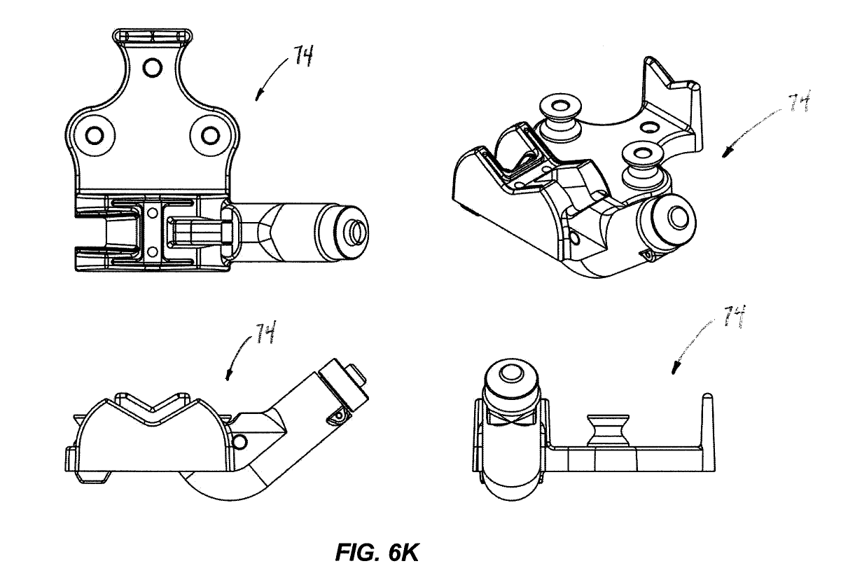

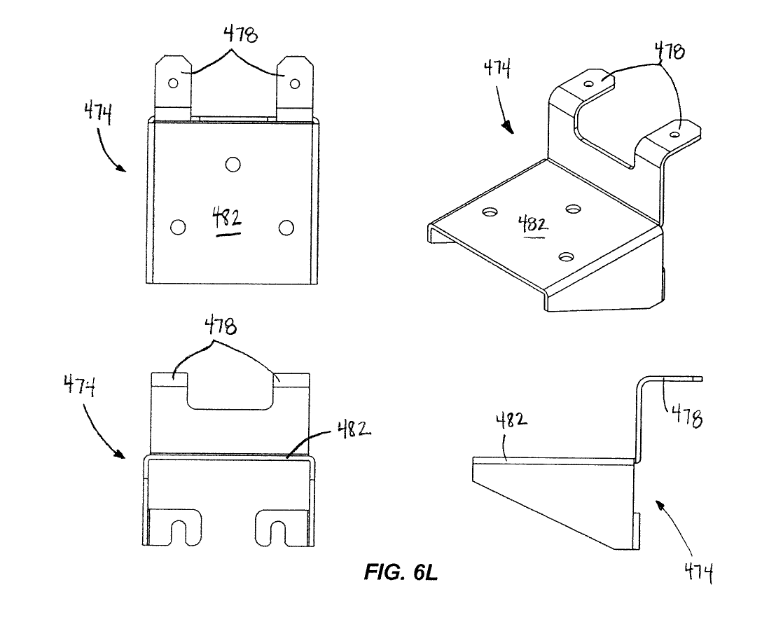

In some constructions (as shown in FIGS. 2A-2E; see also FIGS. 1A-1I), the cart 10 may include a location 70, or area, as explained below with respect to FIGS. 6A-6L, for mounting a vise 74 (e.g., a chain vise, other material vise, etc.), a clamp or other device for securing a work piece, a tool, or other device or material to the cart 10 and/or relative to a component (e.g., the work surface 22, a tool, etc.) of the cart 10. The location 70 may be positioned to align the clamp or vise with the channel 62 or uprights (if provided).

In some constructions and in some aspects, the industrial cart 10 may include a hanging storage location (not shown) for a power tool (e.g., a corded or cordless band saw a grinder, a drill, a reciprocating saw, etc.). Using a support on the power tool (e.g., the front “T” handle on a band saw), the cart 10 may provide a location (e.g., on or adjacent a vise mounting plate (see FIGS. 6A-6L) or location 70) to quickly hang the power tool for out-of-the-way secure storage both between cutting operations and when transporting (rolling) the cart and for quick retrieval of the power tool once the material to be cut is secured in position.

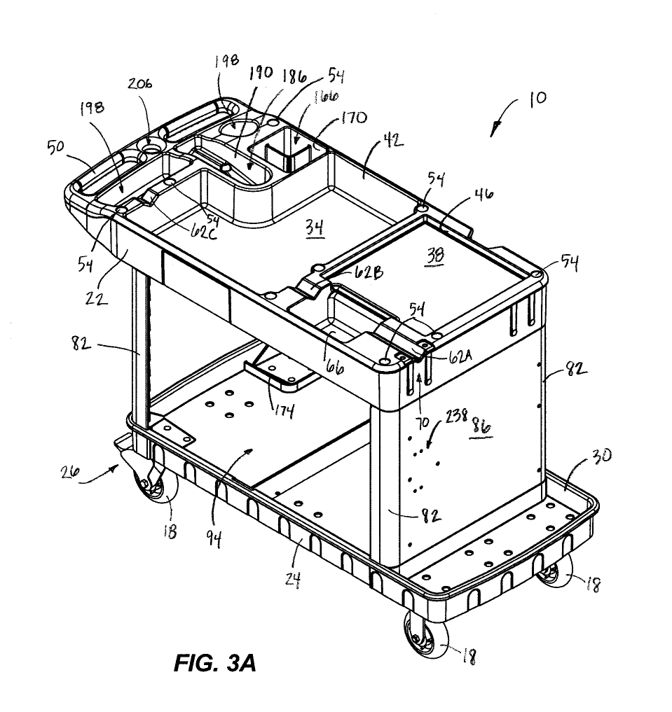

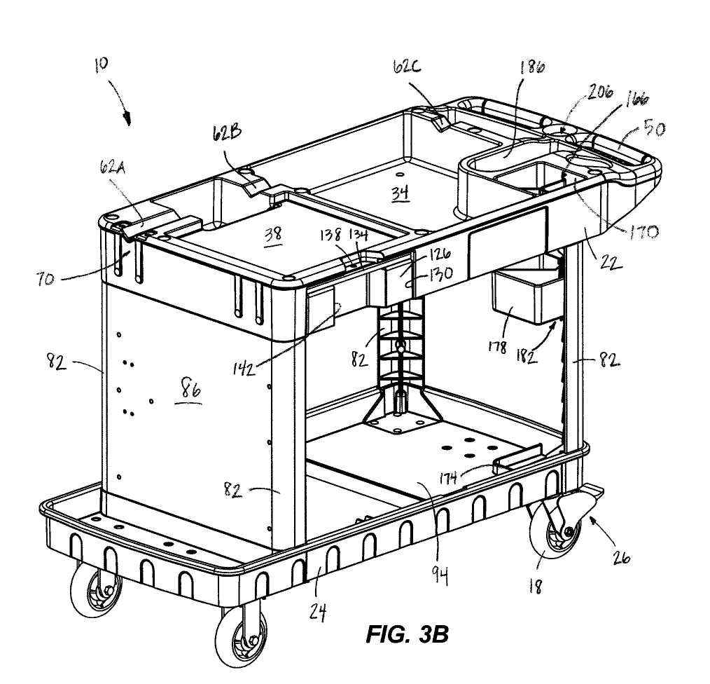

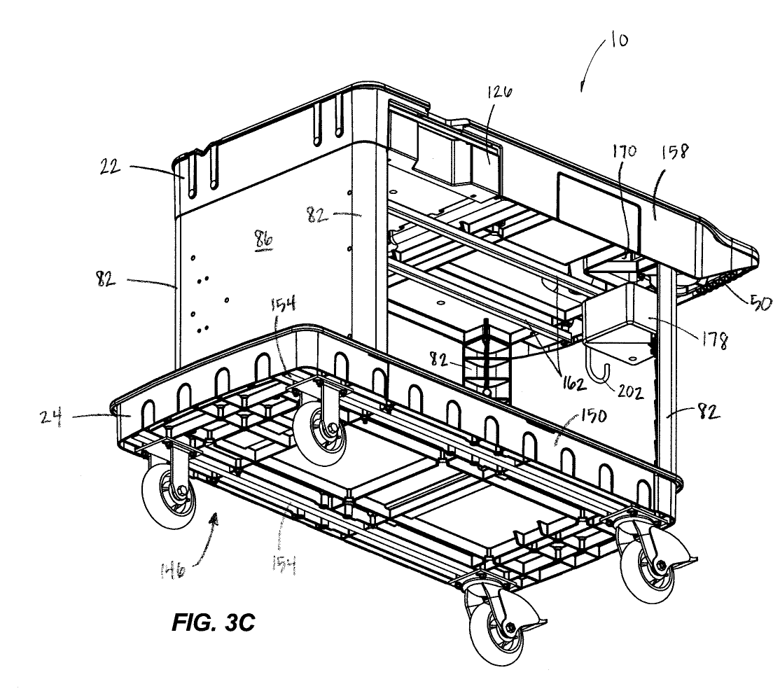

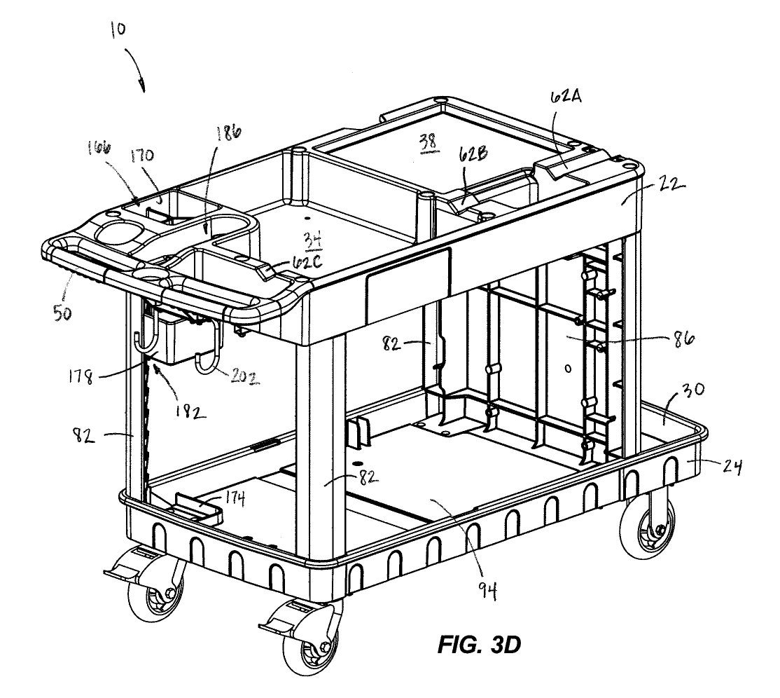

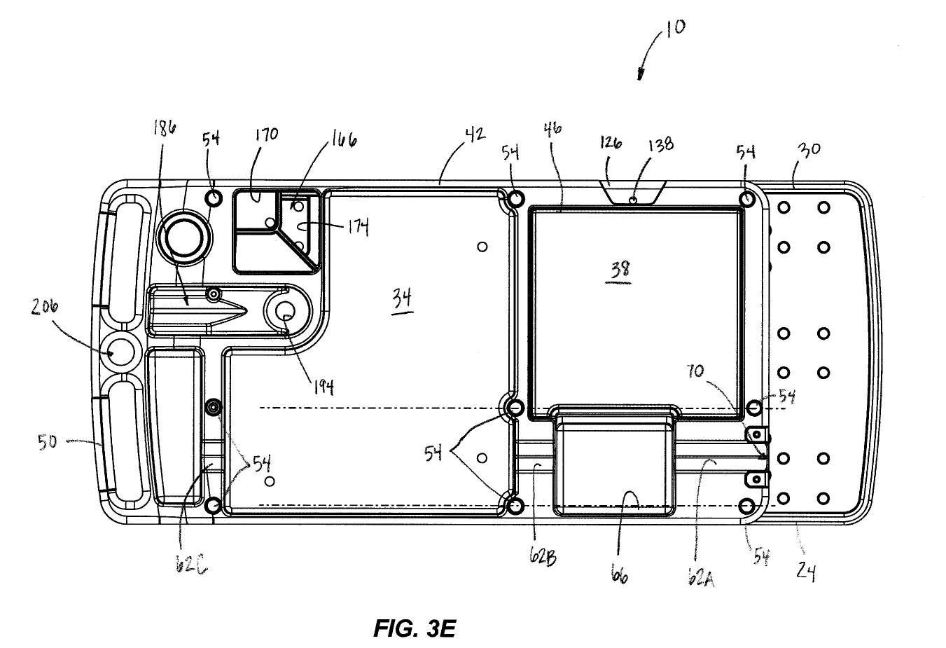

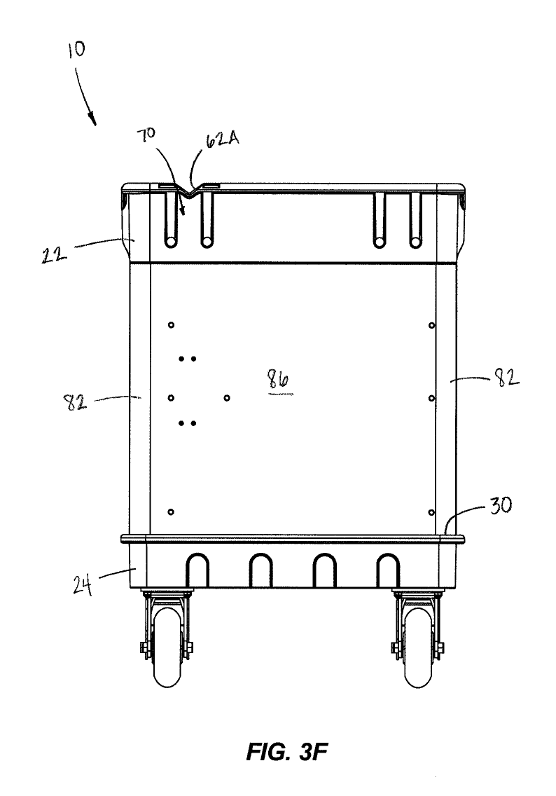

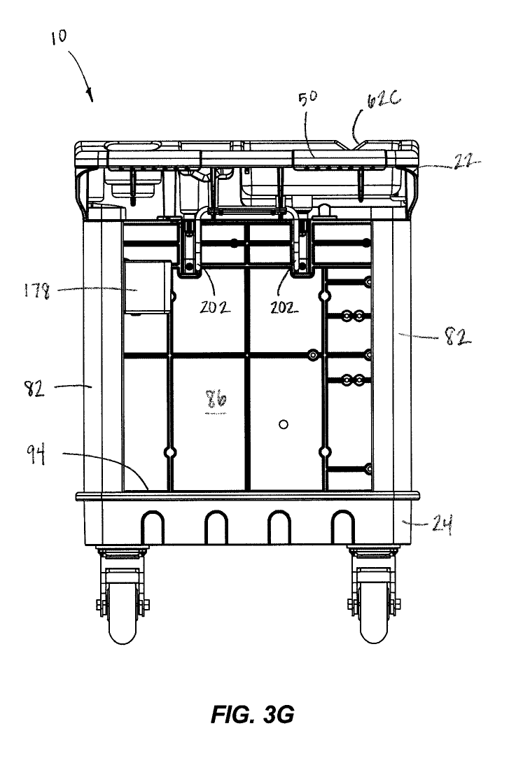

The industrial cart 10 has multiple configurations. In one configuration (see FIGS. 2A-2E), the cart 10 includes a cabinet 78 to provide a “cabinet” cart configuration. In another configuration (see FIGS. 3A-3G), the cart 10 does not include the cabinet 78 and provides a generally “open” cart configuration. As discussed below, the “cabinet” cart and the “open” cart include many common components. Accordingly, at least the two illustrated configurations are easily provided with a minimum of extra not-common components and with a minimum of modification.

Uprights 82 are provided between the base 24 and the table 22. In the illustrated construction, a front wall 86 extends between the front upright(s) 82. As discussed below, the front wall 86 includes structure to support and/or connect with other components to form an enclosed cabinet 78, if provided.

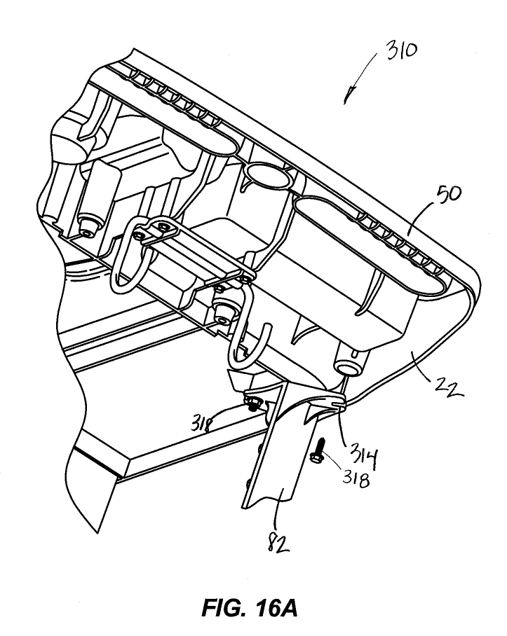

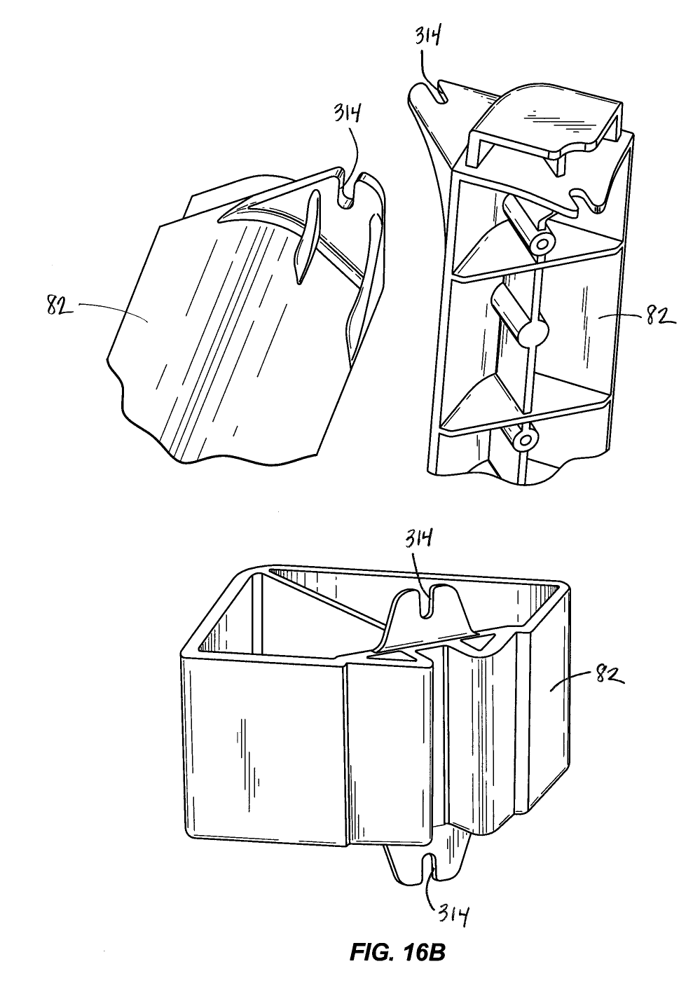

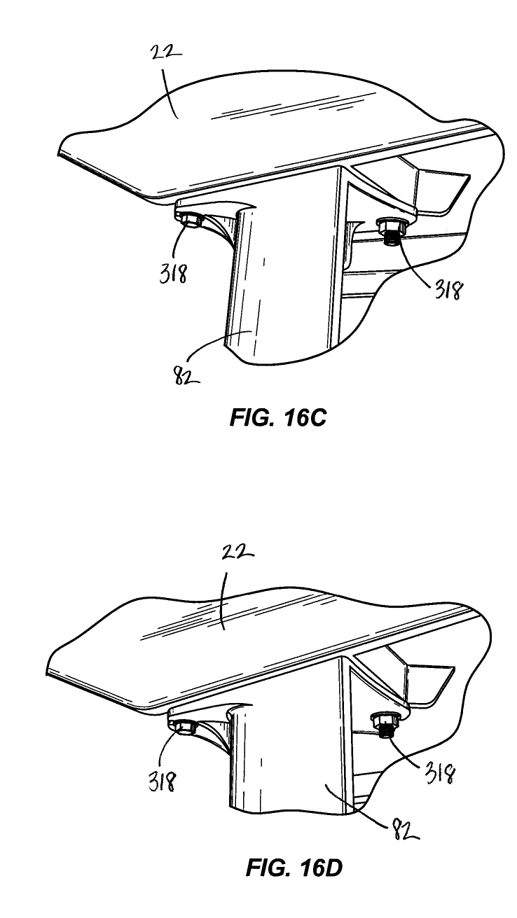

FIGS. 16A-16D are views of a portion of an industrial cart 310 similar to the cart 10 shown in FIGS. 2A-2E and 3A-3G; therefore, like structure will be identified by the same reference numerals. FIGS. 16A-16D illustrate connection of the table assembly 22 and the uprights 82. As shown in FIGS. 16A-16D, one or more lateral slots 314 may be provided in the upright 82 for engagement with a fastener 318 (e.g., a bolt) to fasten the upright 82 and the table 22. In the illustrated construction, each upright 82 is connected to the table 22 with two fasteners 318 to, for example, provide additional strength, sturdiness, etc. In the illustrated construction, a laterally-open slot 314 is provided instead of a hole to, for example, improve manufacturability (e.g., a “slide” mold member/operation is not required during molding operations for the uprights), improve assembly (e.g., reduce effect of manufacturing tolerance stack-up), etc. FIG. 16B illustrates a similar connecting arrangement for an intermediate or mid-height support (similar to the support 178).

With respect to the “cabinet” cart configuration (see FIGS. 2A-2E), the cart 10 also includes a cabinet rear wall 90. In the illustrated construction, the rear wall 90 is spaced forwardly of the rear of the cart 10 such that an open or storage area 94 is provided. In contrast, in the “open” cart configuration (see FIGS. 3A-3G), the storage area 94 is larger and includes the area between the base 24 and the table 22 almost the full length of the cart 10 (e.g., at least from the front wall 86 to the rear uprights 82).

Side walls 98 and 102 are connected between the walls 86 and 90 to provide an enclosed storage area (not shown) for storing additional tools, accessories, other similar implements, supplies, etc. In the illustrated construction (see FIGS. 2A-2E), at least one wall (e.g., the side wall 102) is provided by an openable door assembly 106. The door assembly 106 includes a door member 110 movably supported by the frame of the cabinet 78 (e.g., the walls 86 and 90). The door 54 includes a lock to lock the door 54 in a closed position and to secure the storage area.

In the illustrated construction, the door member 110 is pivotable between a closed position (shown in FIGS. 2B and 2C) and an open position. The door member 110 is also supported for movement to a stored position. In the stored position, the door member 110 is stored in the cabinet 78 and does not extend outside of the periphery of the cart 10 so that the door member 110, when open, does not increase the overall dimension (e.g., width, length, etc.) of the cart 10. Such an arrangement allows the door member 110 to remain open so that the cabinet 78 is accessible even in relatively-small work areas (e.g., a hallway).

Hinge assemblies (not shown) support the door member 110 for pivoting movement. Each hinge assembly includes a hinge pin defining the pivoting axis of the door member 110 and a hinge housing supported by a wall 86, 90. The hinge assemblies are supported for sliding movement in respective tracks defined in the walls 86, 90 to enable movement of the door member 110 from the open position to the stored position. In one construction (not shown), the door 110 is pivotally connected to the frame 14 with the hinges near the bottom of the door 110 and the door 110 pivots downwardly to open. Alternatively, the door 110 may open in another manner (e.g., pivot upwardly, to one side, etc.) or may be the front wall of a sliding drawer in which the storage area is provided. In any such construction, the door 110 may pivot and/or move (e.g., slide) to a position in which the open door 110 does not extend outside of the periphery of the cart 10 so that the door 110, when open, does not increase the overall dimension (e.g., width, length, etc.) of the cart 10. In another construction, the door 110 is connected to the frame 14 with hinges near the top of the door 110, and the door 110 pivots upwardly to open. The door 110 may swing open such that the front portion of the door 110 rests on the top of the cart 10 and the back portion of the door 110 is exposed and provides a table top surface 110 near the work surface 22 of the cart 10. In the open position, the door 110 may be positioned within the periphery of the cart 10 so that the door 110, when open, does not increase the overall dimension (e.g., width, length, etc.) of the cart 10.

A locking arrangement is provided to selectively lock the door member 110 in the closed position and to secure the storage area. In the illustrated construction, the locking arrangement includes a latch member 114 slidably supported on the door member 110. The latch member 114 is supported in a recessed area 118 of the door member 110. Cooperating locking structure is provided on a fixed portion of the cabinet 78. In the illustrated construction, the base 24 provides a locking surface (not shown) engageable by the latch member 114 when the door member 110 is in the closed position.

The latch member 114 is movable between a locked position, in which the latch member 114 engages the locking surface to lock the door member 110 in the closed position, and an unlocked position, in which the latch member 114 is disengaged from the locking surface so that the door member 110 may be opened. The latch member 114 includes an opening (not shown) alignable (in the locked position) with fixed openings (not shown) on the door member 110 for receiving a separate lock (e.g., a padlock) to secure the latch member 114 in a position (e.g., the locked position) or for maintaining the latch member 114 in a position (e.g., the unlocked position).

A handle 122 is provided to move the latch member 114 between the locked and unlocked positions. Among other things, the recessed area 118 of the door member 110 ensures that the latch member 114, the handle 122 and any separate lock do not extend beyond the periphery of the cart 10. A biasing member (not shown) may bias the latch member toward a position (e.g., the locked position).

A biasing member (not shown) may be provided to bias the door member 110 toward a position (e.g., toward the open position). In such constructions, the biasing member may maintain the door member 110 in the open position so that an operator can use both hands to access the storage area. The biasing member may be an over-center member which applies a biasing force after the door member 110 has moved close to the biased position (e.g., close to the open position).

A support arrangement (not shown) may be provided to selectively hold the door member 110 in the open position. In a manner similar to many folding shelf arrangements, such a support arrangement may include a support surface formed on the door member 110 which is selectively engageable with a fixed support surface formed, for example, formed on a wall 86, 90, when the door member 110 is in the open position. For example, in the open position, the door member 110 may be laterally shifted so that the support surfaces are engageable to hold the door member 110 in the open position. The door member 110 is laterally shifted in the opposite direction to move the support surfaces out the range of engagement so that the door member 110 is freely pivotable between the open position and the closed position.

As shown in FIGS. 2B-2D, in some constructions and in some aspects, the industrial cart 10 may include a drawer 126. FIGS. 1A-1I show a similar drawer arrangement. The upper shelf 22 has an opening 130 for an integral drawer 126. In the illustrated construction, the drawer 126 is positioned within the vertical and lateral periphery of the upper shelf 22 (e.g., does not beyond the outer surfaces of the upper shelf 22). When the drawer 126 is in the closed position, the drawer 126 does not extend beyond the width of the cart 10. In the illustrated construction, the opening 130 for the drawer in the upper shelf 22 may be under the work area 38 and adjacent to the open storage area 34.

A sliding mechanism (not shown) is provided between the opening 130 and the drawer 126 to allow the drawer 126 to slide between a closed position (shown in FIG. 2B-2D) and an open position. A handle 134 is engageable by an operator to move the drawer 126 between the open and closed positions.

In one construction, a locking arrangement is provided to selectively lock the drawer 126 in the closed position and to secure the storage area of the drawer 126. The drawer 126 has an opening (not shown) alignable (in the locked position) with a fixed opening 138 on the upper shelf 22 for receiving a separate lock (e.g., a padlock) to secure the drawer 126 in the locked position. A recessed area 142 in the drawer 126 ensures that any separate lock do not extend beyond the periphery of the cart 10. FIGS. 1A illustrate similar closeable and/or lockable storage for the cart 10.

An interior of the drawer 126 may include slots for receiving dividers (not shown) to divide the storage area. A releasable latch arrangement (not shown) may be provided to maintain drawer in a position (e.g., in the closed position), for example, during transport. A biasing member (not shown) may be provided to bias the drawer 126 toward a position (e.g., the closed position).

In some constructions, the cart 10 may include an electronic or remotely-operated security system. In such constructions, the locking arrangement may be electronically operated. For example, movement of the latch member 114 and a locking arrangement for the drawer 126 may be controlled by an electronic component or components in a manner similar to a vehicle door lock. In some constructions, the electronically-operated lock may replace the illustrated padlock for the lockable storage. Also, in such constructions, an electronically-operated lock may replace the foot-operated locks 26 on the lockable wheels 18. A remote operation device (e.g., a key fob for an automobile/vehicle security system) may be provided to remotely operate the lock to selectively lock and unlock the storage, the lockable wheels, etc.

In some constructions, the cart 10 may be provided with an alarm system to provide an alert if the cart 10 is moved and/or if unwanted access is gained to the storage. The alert may be an audible, visual or other alert. In some constructions, the alert may be transmitted remotely (e.g., a signal provided to a distant monitor (a computer, a cell phone, etc.)).

The alarm system may be remotely-operated by the key fob. The alarm system may provide an alert if the storage is opened when the alarm is set. The alarm may also provide an alert if the cart 10 is moved or moves when the alarm is set. In such constructions, a motion detector may be provided on the cart 10. The motion detector may sense motion of the cart 10, motion of one or more wheels 18, etc.

In some aspects and in some constructions, the cart 10 is constructed to be durable and to carry tools, equipment, materials, etc. required on a typical job site while maintaining a reasonable unloaded weight (e.g., less than 150 lbs.) so that the cart 10 may be carried by, for example, two people. In such aspects and in such constructions, the cart 10 may include a frame assembly 146 including relatively lightweight material portions 150 (e.g., plastic, foam, etc.) providing large portions of many components (e.g., the base 24, the table 22, the cabinet 78, etc.) reinforced by stronger but heavy reinforcing members 154 (e.g., steel bars supporting and/or reinforcing the base 24, the table 22, etc.).

In the construction illustrated in FIGS. 2A-2E, 3A-3G and 4 (see FIGS. 2C, 3C and 4), the base 24 is formed as a base assembly including a base body 150, providing the majority of the structural dimension of the base 24, and one or more reinforcing members 154, providing additional structural strength to the base 24. In the illustrated construction, the body 150 is formed of structural foam, and the reinforcing members 154 are formed of metal, such as 1020 steel. In the illustrated construction, the reinforcing members 154 extend along the length of the base 24. In other constructions (not shown), lateral reinforcing members may also be provided.

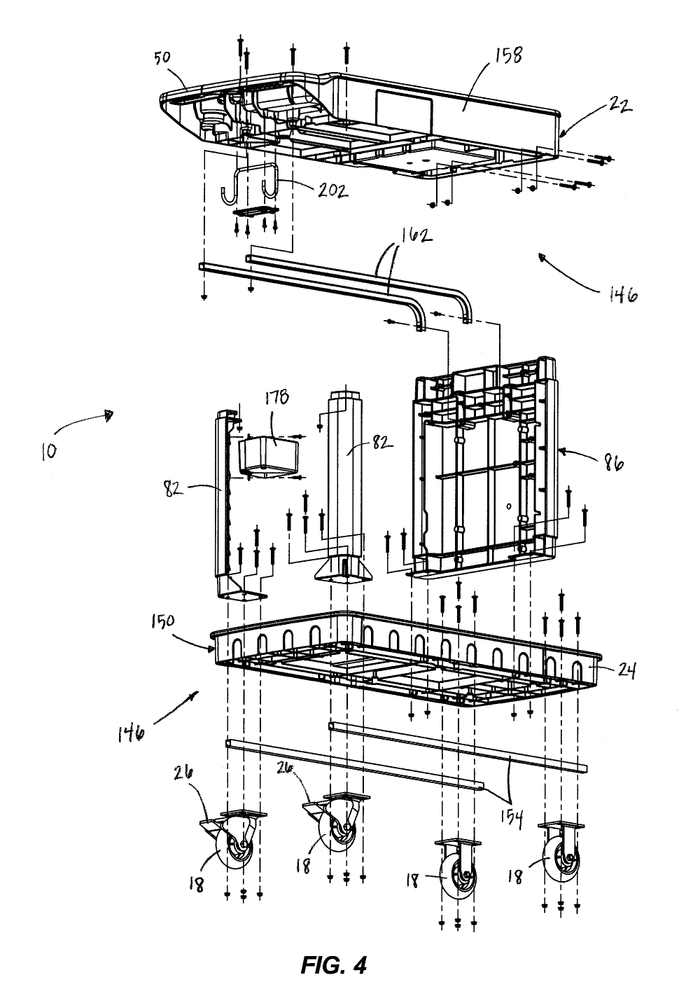

In the “open” cart configuration illustrated in FIGS. 3A-3G and 4 (see FIGS. 3C and 4), the table 22 is formed as a table assembly including a table body 158, providing the majority of the structural dimension of the table 22, and one or more reinforcing members 162, providing additional structural strength to the table 22. In the illustrated construction, the body 158 is formed of structural foam, and the reinforcing members 162 are formed of metal, such as 1020 steel. In the illustrated construction, the reinforcing members 162 extend along the length of the table 22. In other constructions (not shown), lateral reinforcing members may also be provided.

In the “cabinet” cart configuration, a similar reinforced table assembly may be provided. However, in the configuration illustrated in FIGS. 2A-2E, the components of the cabinet 78 provide additional structural support/reinforcement to the table 22 such that additional reinforcing members are not typically necessary.

In the constructions illustrated in FIGS. 2A-2E, 3A-3G and 4, the reinforcing members 154 and 162, if provided, are formed separately from and are connectable to the body 150 and 158, respectively. As such, the reinforcing members 154 and 162 are replaceable, for example, if worn or damaged.

The reinforcing members 154 and 162 may also be substitutable to provide a different capacity cart 10. For example, stronger reinforcing members 154 and 162 (which may also be heavier) may be provided so that the cart 10 more durable or is capable of carrying greater loads (but which may be heavier). The adaptable and/or modifiable frame assembly 146 forming the base 24 and/or the table 22 including the substitutable reinforcing members 154 and/or 162 allow easy manufacture of each type of cart and each different capacity cart with minimum modification and a minimum of additional non-common components.

In other constructions (not shown), the reinforcing members 154 and 162 may be formed integrally with (e.g., molded with) the body 150 and 158, respectively.

Lift or carry handles may be formed on the cart 10. For example, the handle 50 may provide a rear carry handle, and handles or surfaces (not shown) may be formed on the front of the base so that two people can lift and/or carry the cart 10 (e.g., around an obstacle, into and out of a transport vehicle, etc.).

The handle 50 and any front carry or lift handle(s)/surface(s) may include elastomeric material to, for example, improve the comfort of the user, provide improved gripping, reduce vibration transmitted to the user, etc. The handle 50 and/or the carrying handle(s)/surface(s) and/or the elastomeric material may also be contoured to fit a user's hand.

Elastomeric material may cover a portion of the periphery of the cart 10 (e.g., lateral surfaces and/or corner surfaces, etc.). The elastomeric material may inhibit damage to other objects during movement of the cart 10 (e.g., inhibit damage if the cart 10 impacts a wall, etc.), improve comfort to a user during movement of the cart 10 (e.g., cover points which may engage against a user during transport), etc.

Elastomeric material may cover a portion of a work surface (e.g., the upper surface of the table 22, the surface of the groove 62, etc.) to provide one or more of, among other things, protection (e.g., to prevent damage of the work surface, materials on the work surface), friction between the work surface and an items supported on the work surface (e.g., a power tool, material to be worked on, etc.), etc.

The elastomeric material may be a material such as, for example, rubber, Santoprene, etc. The elastomeric material may be formed as a separate member which is attachable to the cart 10 (e.g., to the handle 50, to any front carry or lift handle(s)/surface(s), lateral surfaces and/or corner surfaces, etc.). Alternatively, the elastomeric material may be provided as an overmold (e.g., on the handle 50 and any front carry or lift handle(s)/surface(s), lateral surfaces and/or corner surfaces, etc.).

Elastomeric material may be provided on portions of the cart 10 which may be engageable by an operator (e.g., gripping or handling surfaces, such as, for example, the handle 50, auxiliary carrying surface(s) or handle(s), the door member 110, the handle 122 of the latch member 114, the drawer 126, the handle 134 of the drawer 126, etc.) and on surfaces engageable with another object to provide one or more of, among other things, protection (e.g., to improve comfort, to prevent damage of the work surface, of an item on the work surface or other objects), friction between the work surface and an item on the work surface, etc.

As shown in FIGS. 2A-2D, in some constructions and in some aspects, the industrial cart may include a storage area 166 for relatively long items (e.g., long-handled tools, bits, material, pipes, conduit, etc.) configured to maintain the items generally within the periphery of the cart 10 (e.g., oriented vertically).

As illustrated, the storage area 166 may be within the width of the cart 10 and may extend through the upper shelf 22. The storage area 166 may includes full-length storage (extending from the base 24 through the upper shelf 22) provided by openings or holes 170 in the upper shelf 22 and a lip or ridge 174 formed on the lower shelf 24. The raised lip or ridge 174 matches or is aligned with the opening(s) of the vertical storage hole(s) 170 to keep long items (e.g., long-handled tools, bits, material, pipes, conduit, etc.) properly positioned/oriented vertically. The storage area 166 may include having one or more dividers to define separate compartments of the storage area 166. Each compartment may be used to retain different types of conduit. The cart 10 may include additional holders to store additional conduit sections. In alternate constructions (not shown), the storage area 166 may include a single elongated tubular holder having one closed end and one open end. As shown in FIGS. 2A-2E, 3A-3G and 4, the storage area 166 is provided within the periphery of the cart 10, although in a further construction, the storage area may extend outwardly from a wall of the cart.

The storage area 166 may also include less than full-length storage (e.g., half-length storage) and may include an intermediate or mid-height support 178 to keep mid-length items (e.g., auger bits, extensions, relatively shorter material, etc.) accessible from the top of the cart 10. In the illustrated construction, the position of the support 178 is adjustable to change the height of the support 178 (and the length of the storage). A connecting arrangement 182 is provided between the support 178 and the upright 82.

As shown in FIG. 2A-2E, in some constructions and in some aspects, the industrial cart 10 may include a support or holder 186 for a power tool. FIGS. 1A-1I illustrate a similar support or holder 186.

In the illustrated constructions, the holder 186 includes a holster 190 for a power tool, such as, for example, a drill, a screwdriver, an impact wrench, etc. In some constructions, the orientation of the holster 190 (e.g., a 90° location) relative to the handle 50 allows for quick access by either right or left hand or a user. A hole 194 may be provided in the bottom of the holster 190 in the chuck area to allow the drill bit to remain in the drill when stored in the holster 190. In some constructions, the relatively-deep holster 190 keeps the drill secure even when the cart 10 is moved over rough terrain. Other compartments 198 (e.g., storage compartments, beverage holders, etc.) may be formed adjacent the handle 50 for quick access by the operator of the cart 10.

As shown in FIGS. 2A-2E, in some constructions and in some aspects, the industrial cart 10 may include one or more storage hooks 202 molded with or assembled onto the top shelf 22. The industrial cart 10 may also or, in the alternative, include storage hooks 202 molded with or assembled onto other structural members of the cart (e.g., below the handle (as shown in FIGS. 1A-1I) and/or within the outer periphery of the cart). The storage hooks 202 may be used to store extension cords, hoses, radios, battery chargers (e.g., a multi-bay charger), other equipment, etc., on the cart 10. A locking assembly may be provided to lock the stored items to the cart 10.

In some constructions and in some aspects (see FIGS. 2A-2B and 2D) , the main handle 50 has a hole 206 in the middle to allow for the storage of a tool (e.g., a hammer), for the hanging of “S” hooks (e.g., to hang buckets and cords from the cart handle), etc.

In some constructions and in some aspects, the cart may include a dust collection system (not shown). In some constructions, the cart may include an on-board dust collection system. The on-board system may include a fan or vacuum for generating an air flow from a work area and a storage container for collecting and storing dust/debris removed from the work area. In other constructions, the cart may include a portion of a dust collection system. The portion of the system on the cart (e.g., hoses, vent passages, an air-flow producing device) may be connected to an off-board portion of the dust collection system (e.g., hoses, vent passages, an air-flow producing device, a dust/debris receptacle).

FIG. 1A illustrates a construction of a “base” cart 10A which may be modified by adding one or more modular accessory units 210. The cart 10A is similar to the cart 10 shown in FIGS. 2A-2E and 3A-3G; therefore, common structure will be identified by the same reference numerals. The front deck 30 may allow for the attachment of accessories 210 to modify the cart for use by an electrician, a plumber, a maintenance worker, etc.

FIG. 1B illustrates the attachment of a modular wire spool assembly 214 to the “base” cart 10A, for example, for a cart 10B modified for an electrician. FIG. 1C illustrates a fully-enclosed or “cabinet” cart 10C built from the “base” cart 10A with drawers 218 added. FIGS. 1D-1E illustrate the attachment of a modular drawer system 222 (e.g., for small parts, tools, etc.) to the “base” cart 10A, for example, for a cart 10D modified for a maintenance worker. FIG. 1F illustrates an open cart 10E built from the “base” cart 10A without a cabinet. FIGS. 1G-1H illustrate the attachment of a tank accessory system 226 (e.g., to hold one or more tanks, such as an acetylene tank, an oxygen tank, a propane tank, a fire extinguisher, etc.) to the “base” cart 10A, for example, for a cart 10F modified for a plumber. FIG. 1I illustrates the attachment of a tank accessory system 230 (e.g., to hold one or more tanks, such as an acetylene tank, an oxygen tank, a propane tank, a fire extinguisher, etc.) to the “base” cart 10A, for example, for a cart 10G modified for an electrician.

In some constructions (see FIGS. 1A, 1C and 1F-1I), the extended front deck 30 may, for example, provide for storage of common trade supplies, accessories, etc. (e.g., ladders, levels, material, accessories, wire spools, voice and data cable boxes, etc.). FIGS. 1G-1I illustrate the cart 10F and 10G supporting gas cylinders, a fire extinguisher, torch and hoses, etc. The cart 10F may include additional supports/brackets (not shown) to support the cylinders, fire extinguisher, torch, hoses, etc. Such additional supports/brackets may be quickly attachable, removable, replaceable, etc., in a manner similar to the modular accessories 210.

As shown in FIGS. 1A-1I, an extended work surface 234 (e.g., an extended steel work surface, a clamp/vise mount or mounting plate) may be provided on the front of the cart. Such an extended work surface 234 may be quickly attachable, removable, replaceable, etc., in a manner similar to the modular accessories 210.

Referring to FIGS. 2A-2E, to connect of accessories to the cart 10, connecting structure 238 is provided on the cart 10. The connecting structure 238 may allow different modular accessories to be connected to the cart 10 using the same connecting structure 238. For example, the connecting structure 238 may include projections (e.g., bosses), and each modular accessory may include receptacles for receiving the projections as the modular accessory is supported on the cart 10. In other constructions, the connecting structure 238 may include receptacles, and each modular accessory may include projections (e.g., bosses) to be received in the receptacles as the modular accessory is supported on the cart 10. In the illustrated construction, the connecting structure 238 is provided by the front wall 86.

The door member 110 covers a storage area (not shown) within the cart 10 for storing additional tools, accessories, other similar implements, supplies, etc.

In one construction (not shown), the door member 110 is pivotally connected to the frame 14 with the hinges near the bottom of the door 110 and the door 110 pivots downwardly to open. Alternatively, the door 110 may open in another manner (e.g., pivot upwardly, to one side, etc.) or may be the front wall of a sliding drawer in which the storage area is provided. In any such construction, the door 110 may pivot and/or move (e.g., slide) to a position in which the open door 110 does not extend outside of the periphery of the cart 10 so that the door 110, when open, does not increase the overall dimension (e.g., width, length, etc.) of the cart 10.

In another construction, the door 110 is connected to the frame 14 with hinges near the top of the door 110, and the door 110 pivots upwardly to open. The door 110 may swing open such that the front portion of the door 110 rests on the top of the cart 10 and the back portion of the door 110 is exposed and provides a table top surface 110 near the work surface 22 of the cart 10. In the open position, the door 110 may be positioned within the periphery of the cart 10 so that the door 110, when open, does not increase the overall dimension (e.g., width, length, etc.) of the cart 10.

The cart 10 may also include other various additional features such as, for example, a vise, a clamp or other device for securing a work piece, a tool, or other device or material to the cart 10 and/or relative to a component (e.g., the work surface 22, the tool 32, etc.) of the cart 10.

In addition, the cart 10 may support one or more battery chargers for charging the associated batteries, such as, for example, power tool batteries. In some constructions, each battery charger, and each other electrical device used with the cart 10 (e.g., the power tool 32), may be connected directly to a power source by its associated cord (not shown). In some aspects and in some constructions, the cart 10 may also include an electrical supply arrangement having a power strip or one or more outlets to which an electrical device (e.g., a battery charger, a power tool 32, etc.) may be connected. The cart 10 may also include a connector (e.g., a cord (not shown)) for connection to a power source, such as, for example, an AC power source, a DC power source, etc. The cart 10 may include an electrical circuit (not shown) connected between the cord and the outlet(s) such that power is supplied from the power source to the outlet(s). The power strip may be supported by a recessed portion of the top shelf 22 to maintain the cart width, and the cabinet 78 may include a hole proximate the power strip to allow for secure charging of cordless batteries from within the cabinet 78. In another construction, the cart 10 may include a pocket, or recess, for storing a power circuit that permits easy access to and removal of the power strip, including a cord wrap area.

In some aspects and in some constructions (not shown), the cart 10 and the electrical devices (e.g., the battery chargers , the power tool 32, etc.) may include cooperating electrical connectors other than the cord and outlet(s). For example, the cart 10 and the electrical devices may include electrical connectors (not shown) similar to that provided between a power tool battery and a battery charger, such as that shown and described in co-pending, jointly-owned U.S. patent application Ser. No. 10/289,621, filed Nov. 7, 2002, now Publication No. U.S. 2003/0090234 A1, published May 15, 2003, the entire contents of which is hereby incorporated by reference. The electrical connectors may be connected when and/or as the electrical device is supported on the cart 10.

In some constructions and in some aspects, the cart 10 may include an on-board power source (not shown) for supplying power to the outlet(s) and/or to the electrical devices (e.g., the battery chargers, the power tool 32, etc.). For example, the cart 10 may include a fuel-powered power source (e.g., a generator, an alternator, etc.), a supply battery, or other power source operable to supply electrical power. Such a fuel-powered power source may be similar to that shown and described in co-pending, jointly-owned U.S. patent application Ser. No. 09/941,192, filed Aug. 28, 2001, now U.S. Pat. No. 6,806,680, issued Oct. 19, 2004, the entire contents of which is hereby incorporated by reference.

Such a supply battery may include one or more power tool battery packs having a nominal voltage of between 9.6 V and 50 V and including cells having a chemistry of, for example, NiCd, NiMH, Li-ion, etc. Such a power tool battery pack may be similar to that shown and described in U.S. patent application Ser. No. 10/719,680, filed Nov. 20, 2003, now Publication No. U.S. 2004/0263119 A1, published Dec. 30, 2004; U.S. patent application Ser. No. 10/720,027, filed Nov. 20, 2003, now U.S. Pat. No. 7,157,882, issued Jan. 2, 2007; and U.S. patent application Ser. No. 10/721,800, filed Nov. 24, 2003, now Publication No. U.S. 2004/0257038 A1, published Dec. 23, 2004; the entire contents of all of which are hereby incorporated by reference.

In some constructions and in some aspects, the cart 10 may be a power-driven cart and may include a motor (not shown) drivingly connected to one or more of the wheels 18 to drive the cart 10 to, from and/or around a work site. In such constructions, the motor may be powered by a power source, such as, for example, a fuel-powered power source (e.g., the fuel-powered power source described above), a battery power source (e.g., the supply battery described above), or other power source operable to power the motor. In such constructions, the cart 10 may include a suitable drive arrangement (not shown) for transferring drive power from the motor to one or more drive wheels (such as one or more of the wheels 18) and a suitable control arrangement (not shown) for providing and controlling movement of the cart 10.

In some aspects and in some constructions, the cart 10 may be similar to the carts, including the carts 410, 510 and 610, described below and shown in the respective figures.

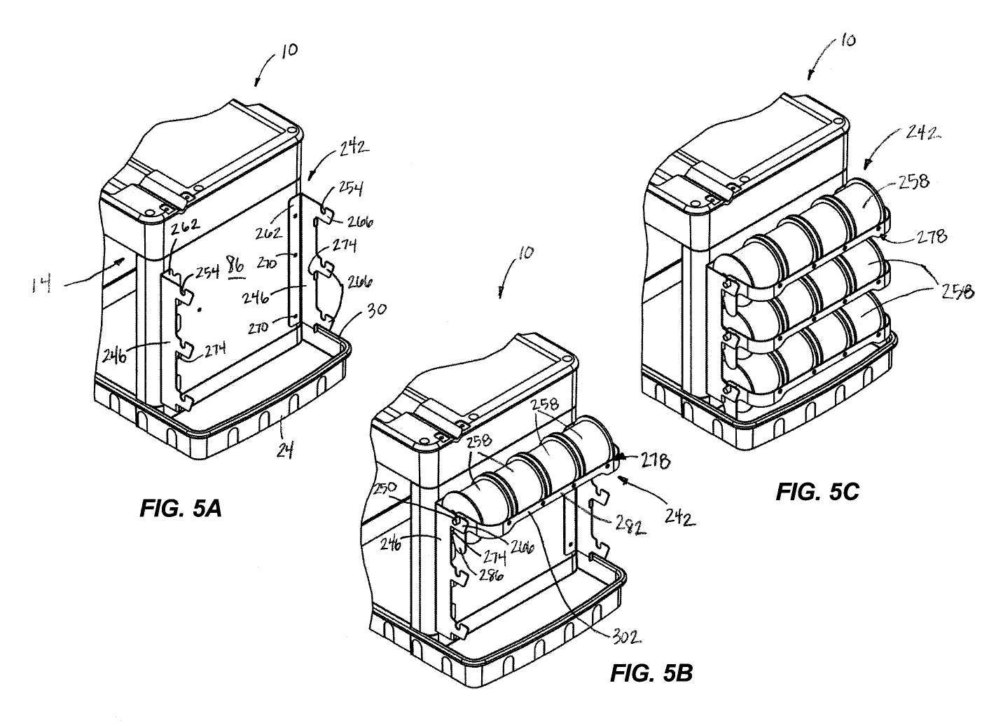

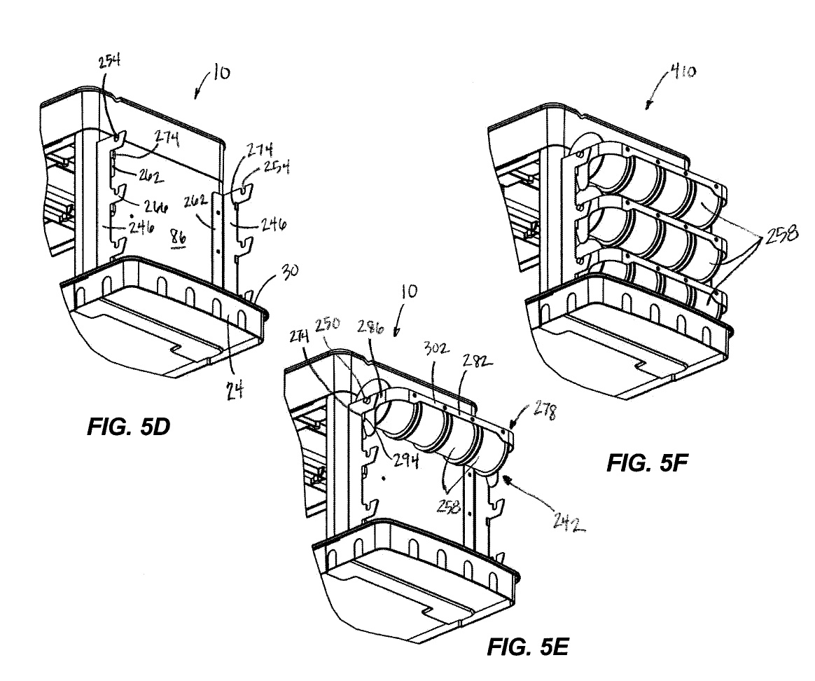

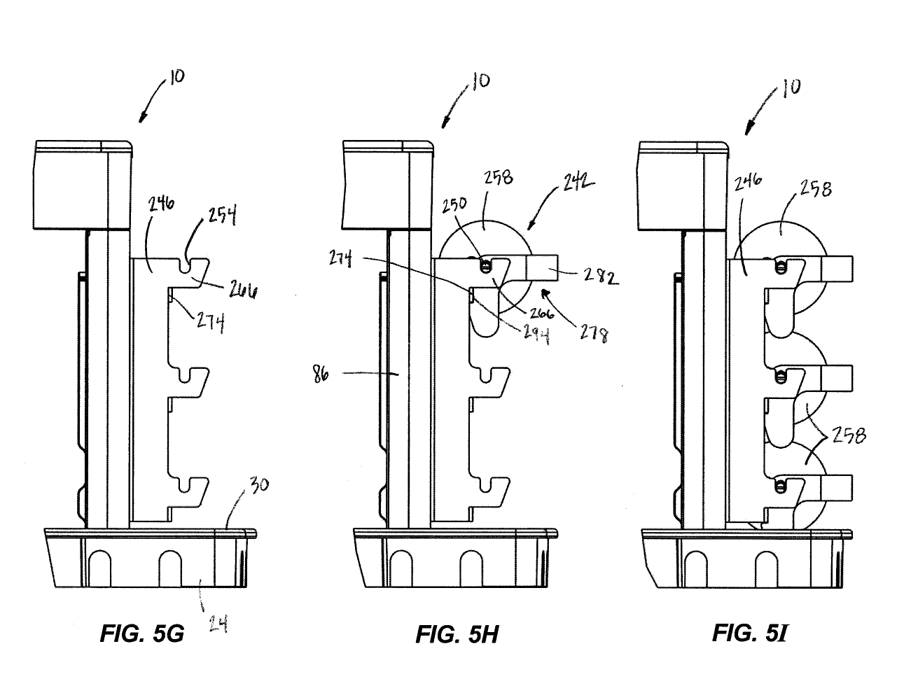

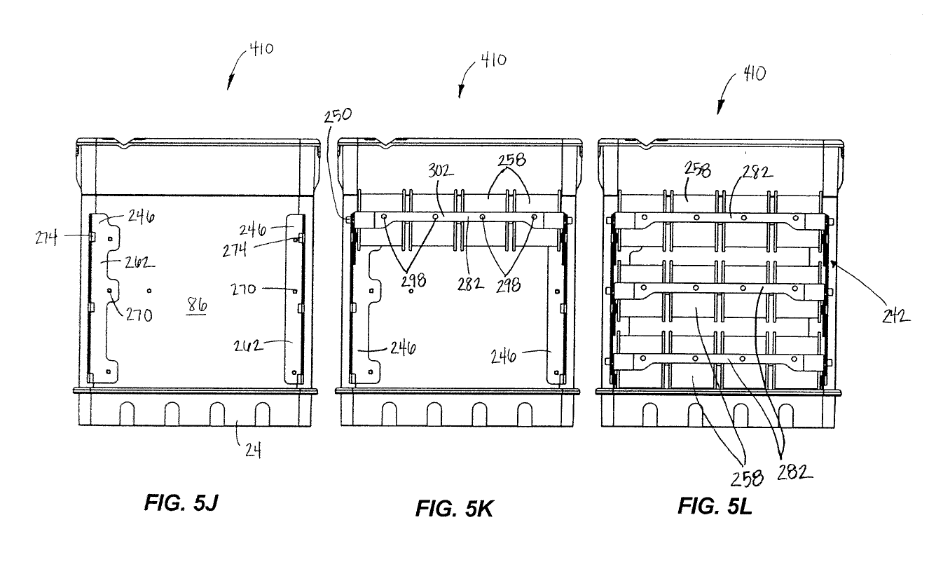

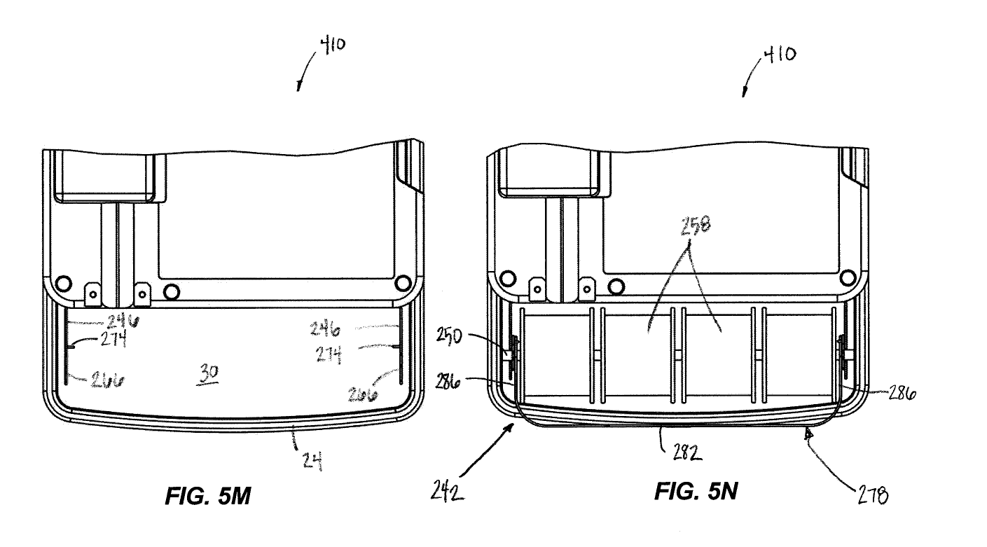

Referring to FIGS. 5A-50, in one construction, the cart 10 includes a reel rack assembly 242 connected to a wall 86 of the frame 14 for retaining reels of electrical wire. In the illustrated construction, the cart 10 includes three reel racks. Each rack includes opposing first and second brackets 246 at opposite ends of the rack for supporting a removable shaft 250. Each bracket 246 defines an aperture or slot 254 for retaining ends of the shaft 250. Multiple spools or reels 258 of electrical wire may be removably positioned on the shaft 250 and stored on the racks. The racks also include a frame 262 extending between the brackets 246 and at least partially protecting the reels 258. The user may add or remove reels 258 to select the desired electrical wire to suit the required application. The reels 258 may be standard reels that may be easily supported and stored in other areas such as, for example, a work shop, a truck, etc., and transferred to/from the cart 10 for use. In the illustrated construction, the reel rack assembly 242 is capable of supporting multiple reels 258 and multiple sets of reels 258.

As shown in FIG. 5O, the reel rack assembly 242 includes brackets or supports 250 having a base 262 and one or more support arms 266 extending from the base 262. The base 262 includes connecting structure 270 (e.g., fasteners) connectable to the connecting structure 238 on the front wall 86. The supports 246 are positioned to provide pairs of arms 266. A stop 274 is provided below each arm 266.

As shown in FIG. 5O, the reel rack assembly 242 also includes the shaft 250 having opposite ends. One or more reels 258 are rotatably supported on the shaft 250. Each end of the shaft 250 is receivable in a corresponding slot 254 in a corresponding arm 266 to support the shaft 250 (and any supported reel(s) 258) on the associated arms 266.

The reel rack assembly 242 also includes a frame 278 having a main or central frame member 282 and spaced apart end frame members 286. Each end member 286 defines a hole 290 for receiving an end of the shaft 250 to connect the frame 278 to the shaft 250. Connectors (e.g., cotter pins) prevent the shaft 250 from sliding out of the holes 290 and disconnecting from the frame 278. A notch 294 is defined in each end member 286.

To support the reel(s) 258 on the cart 10, the shaft 250 is supported by a pair of arms 266 with the ends being received in the associated slots 254. The frame 278 is pivoted relative to the supports 246 so that each notch 294 engages below a corresponding stop 274 to prevent the shaft 250 from disengaging the arms 266. When supported on the cart 10, the frame member 282 is generally in a horizontal plane including the shaft 250. As such, one frame 278 does not interfere with the reel(s) on another frame 278.

To remove the reel(s) 258 from the cart 10, the operator pivots and lifts the frame member 282, disengaging the stops 274 and the notches 294. The operator continues to lift the frame 278 to remove the shaft 250 from the pair of arms 266. The operator may then carry the frame 278 and supported reel(s) 258 to another location (e.g., to dispense wire in that location, to replace an empty reel 258, to substitute or add a reel 258 having different wire, etc.).

In some constructions, one or more arms 266 may be adjustable, replaceable and/or substitutable. For example, the supports 246 may be formed with one or more arms 266 separate from and connectable to the base 262. The arm(s) 266 may be replaced if, for example, damaged or worn. The arm(s) 266 may be substituted with an arm (not shown) having a different structure (e.g., a different size slot 254, a different shape (angled or offset to provide a greater space between the arms 266 in a pair), etc.) or dimension (e.g., length from the front wall 86) to accommodate a reel (not shown) having a different dimension (e.g., diameter, length, etc.).

The position of the arm(s) 266 may be adjustable to position the reel(s) in a desired position (e.g., for reels of different dimensions). For example, the base 262 and the arm(s) 266 may be relatively adjustable to change the orientation, the position, etc., of the arm(s) relative to the cart 10 (e.g., relative to the table 22, to the front wall 86, to the front deck 30, etc.).

In such constructions, structure may be provided between the base 262 and the arm(s) 266 to hold the arm(s) 266 in a selected orientation, position, etc. Such structure may allow quick connection, disconnection, adjustment, etc.

As shown in FIG. 5O, the end members 286 generally have a V-shape providing legs. The legs enable the frame 278 to be supported on a surface (e.g., on the ground, on a work table, etc., as shown in FIG. 5O) with the reel(s) 258 supported above the surface so that wire can be dispensed from the reel(s) in this orientation. The legs are arranged so that the legs do not interfere with dispensing or wire from the reel(s) 258 connected to the frame 278 or from the reel(s) connected to other frames 278 supported on the cart 10.

One or more holes or openings 298 are defined through the frame member 282. Wire from an associated reel 258 may be guided through an opening 298 when the reel 258 is supported on the cart 10 (as shown in FIGS. 5K-5L) or when the frame 278 is supported on a surface (e.g., on the ground, on a work table, etc., as shown in FIG. 5O).

The frame member 282 provides a grip portion 302 for engagement by an operator to carry the frame 278 and supported reel(s) 258. The grip portion 302 is narrowed to allow comfortable engagement by an operator's hand(s). The grip portion 302 may include suitable material (e.g., elastomeric material) to provide additional comfort to, control by the operator. Also, the grip portion 302 may include contours to fit the contours of the operator's hand(s).

The reel rack assembly 242 may be similar to the modular wire spool assembly 214, as described above with respect to FIG. 1B.

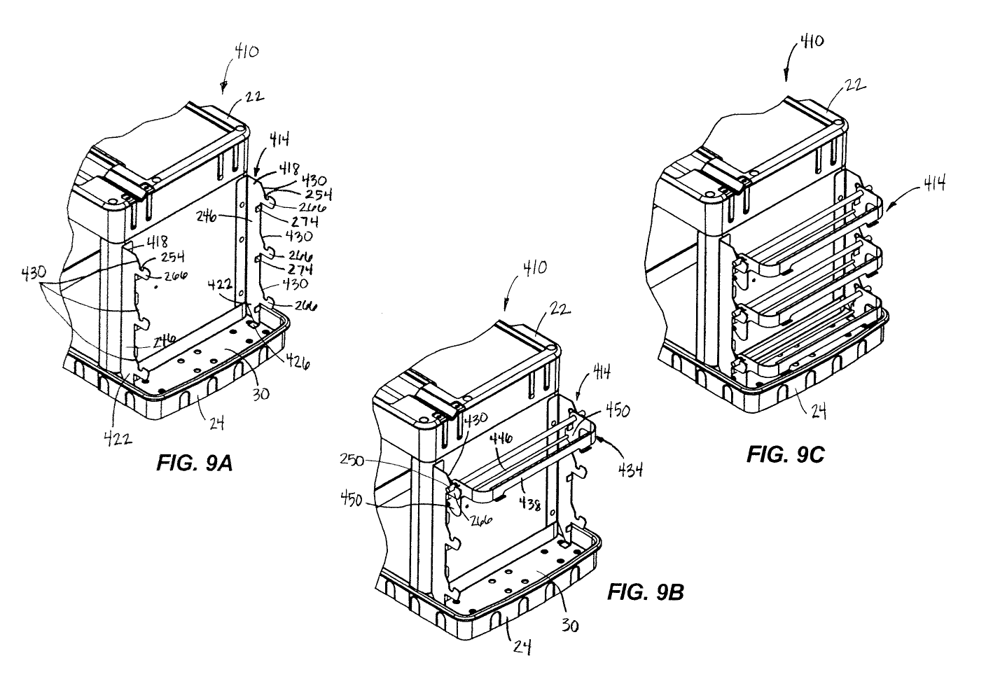

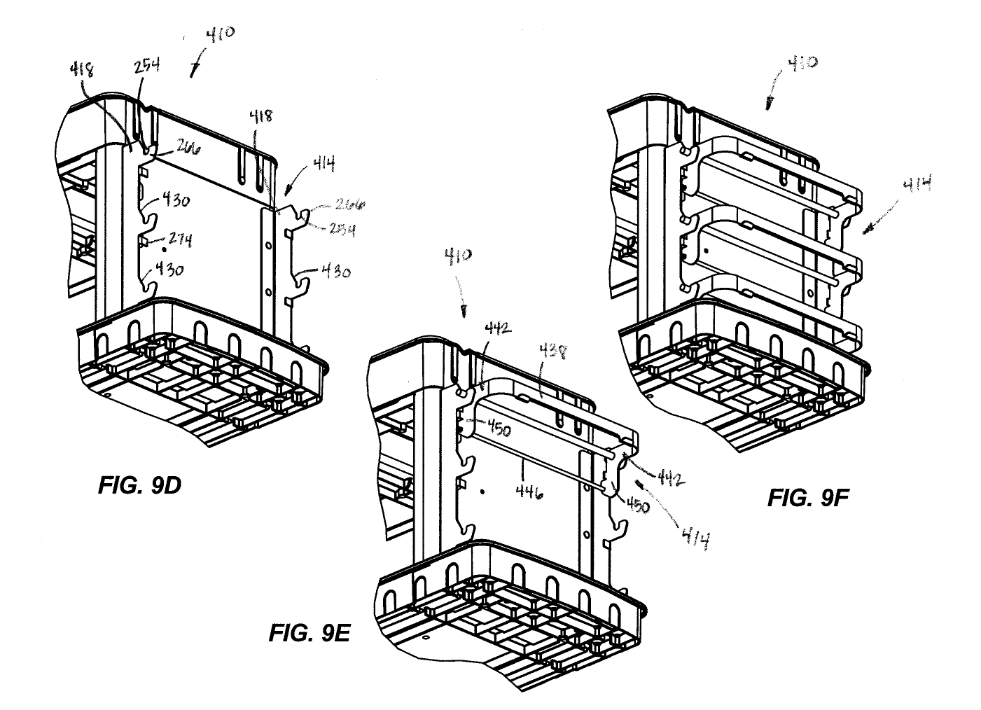

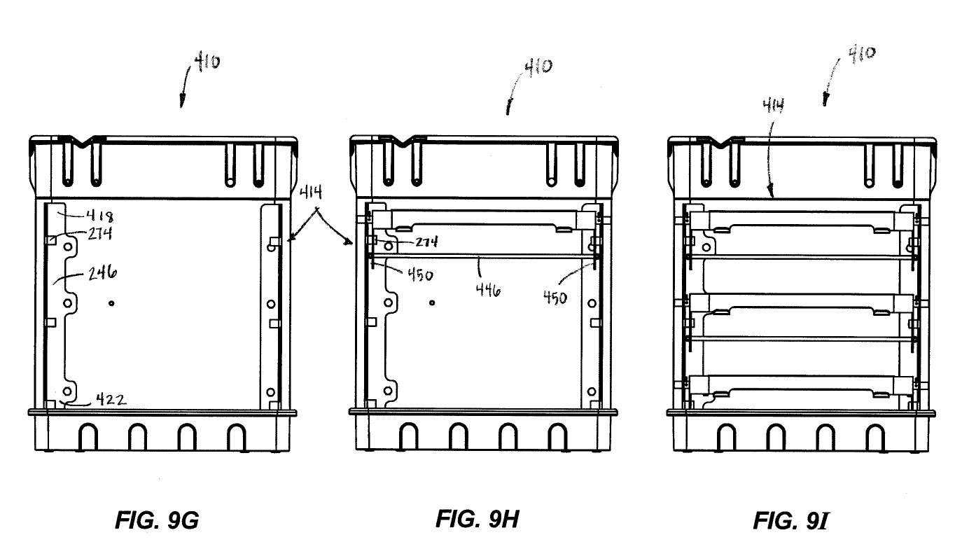

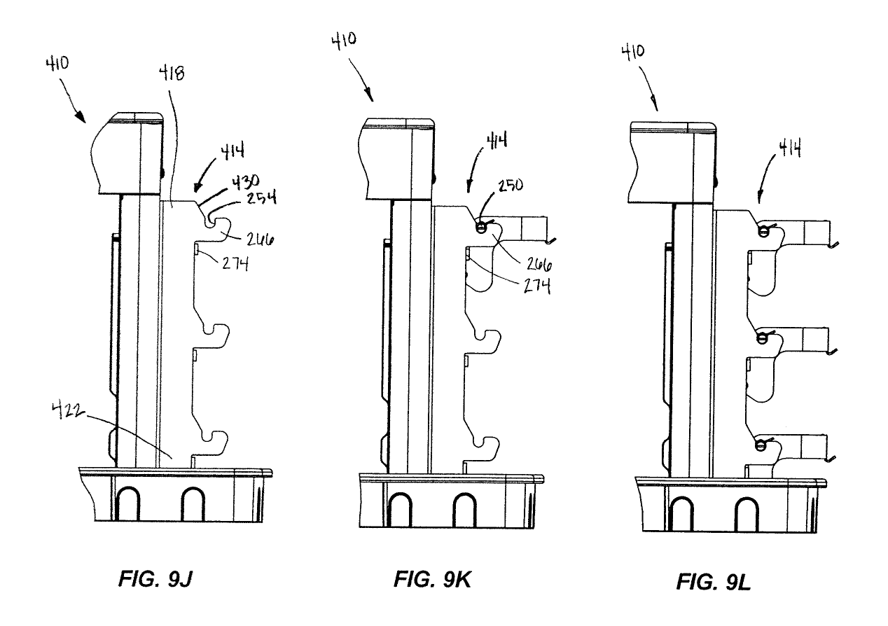

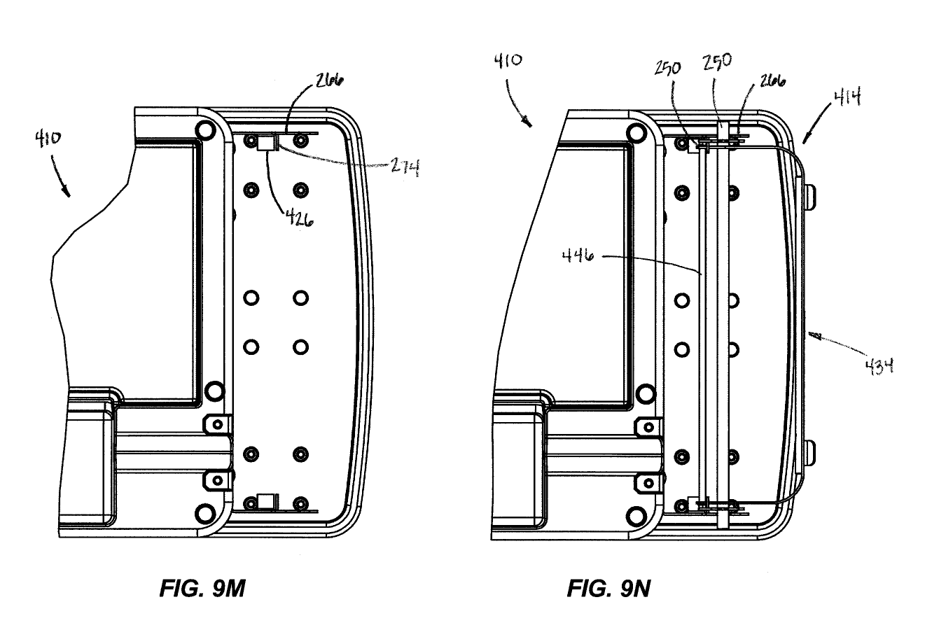

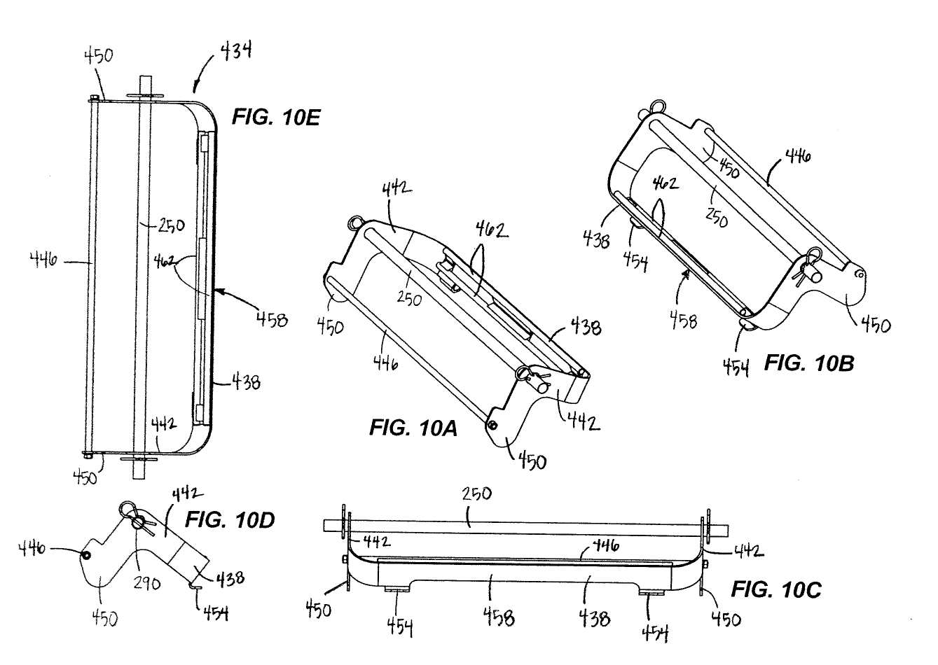

FIGS. 9A-9N illustrate a portion of another construction of an industrial cart 410, similar to the cart 10 shown in FIGS. 2A-2E and 5A-5O; therefore, common structure will be identified by the same reference numerals. The cart 410 includes a reel rack assembly 414 for supporting a reel (not shown but similar to the reel 258). FIGS. 10A-10E illustrate a portion of the assembly 414.

In the illustrated construction, the reel rack assembly 414 is capable of supporting multiple reels and multiple sets (not shown) of reels as units of reels. As shown in FIGS. 9A and 9J, an upper end 418 of each support 246 is extended upwardly relative to the upper arms 266 toward the lower edge of the table 22 (when compared to the relative position of the upper end of the associated support 246 and arm 266 shown in FIGS. 5A and 5G). As shown in FIGS. 9A, 9G and 9J, the lower end 422 of each support 246 is extended downwardly relative to the lower arm 266 into open area of the front deck 30 of the base 24. In the illustrated construction (see FIGS. 9A and 9M), the lower end 422 includes a flange 426 engageable with the upper surface of the front deck 30. The extended length and the arrangement of the supports 246 may provide, among other things, increased strength and/or rigidity, improved connectivity, etc.

An angled or tapered surface 430 is provided on each support 246 at the interface with the arm 266 to lead into the associated slot 254. The leading tapered surface 430 assists in mounting a set of reels on the associated pair of arms 266. In the illustrated construction (see FIGS. 9A and 9G), the length of the stop 274 is increased (when compared to the dimensions of the stop 274 illustrated in FIGS. 5A and 5J) to provide increased engagement area for the associated end frame member 442.

As shown in FIGS. 10A-10E, the reel rack assembly 414 also includes a frame 434 having a main or central frame member 438 and spaced apart end frame members 442. As shown in FIG. 10D, the end members 442 generally have a V-shape providing legs. In the illustrated construction, a shaft 446 is connected between the unconnected ends 450 of the legs. The ends 450 have an increased area to, among other things, provide support for the shaft 446.

The legs enable the frame 434 to be supported on a surface (e.g., on the ground, on a work table, etc., as shown in FIG. 10D) with the reel(s) supported above the surface so that wire can be dispensed from the reel(s) in this orientation. Tab members 454 are provided on the frame member 438 to provide, for example, additional support on a surface, resistance to tipping (e.g., during dispensing of wire from the reel(s)), etc. The legs are arranged so that the legs and the other structure of the reel rack assembly 414 do not interfere with dispensing or wire from the reel(s) connected to the frame 434 or from the reel(s) connected to other frames 434 supported on the cart 10. In the illustrated construction, a height of the frame 434, defined between the hole 290 and a support plane defined by support leg end 450 and support tab 454 (FIG. 10D), is greater than a radius of the reel 258.

The frame member 438 provides a grip portion 458 for engagement by an operator to carry the frame 434 and supported reel(s). The grip portion 458 is narrowed to allow comfortable engagement by an operator's hand(s). The grip portion 458 may include suitable material (e.g., elastomeric material) to provide additional comfort to, control by the operator. Also, the grip portion 458 may include contours to fit the contours of the operator's hand(s). In the illustrated construction, additional material (e.g., one or more shafts 462) is provided on the frame member 438 to provide, for example, additional strength to the frame member 438, an increased grip area for the grip portion 458, etc.

To support reel(s) and the associated frame(s) 438 on the cart 10, the shaft 250 is supported by a pair of arms 266 with the ends being received in the associated slots 254. Each end of the shaft 250 may ride down the tapered surface 430 into the associated slot 254. The frame 434 is pivoted relative to the supports 246 so that each notch 294 engages below a corresponding stop 274 to prevent the shaft 250 from disengaging the arms 266. When supported on the cart 10, the frame member 438 is generally in a horizontal plane including the shaft 250. As such, one frame 434 does not interfere with the reel(s) on another frame 434.

To remove reel(s) from the cart 10, the operator pivots and lifts the frame member 438, disengaging the stops 274 and notches 294. The operator continues to lift the frame 438 to remove the shaft 250 from the pair of arms 266. The operator may then carry the frame 434 and supported reel(s) to another location (e.g., to dispense wire in that location, to replace an empty reel, to substitute or add a reel having different wire, etc.).

FIGS. 6A-6L illustrate the industrial cart 10 modified to include a work piece holder or vise assembly 470. The assembly 470 is supported at the location 70 provided on the cart 10.

In the illustrated construction, the assembly 470 includes a support or bracket 474 having a connecting portion 478 and a support portion 482. The connecting portion 478 is connected to the connecting structure 238 on the cart 10 to support the bracket 474 on the cart 10.

A work piece holder, such as, for example, a clamp, a vise, a chain vise 74, is supported on the support portion 482. The bracket 474 is configured such that the material receiving portion of the vise 74 is aligned with the material cutting aids (e.g., the channel 62) on the table 22. Material to be worked on may thus be supported in the channel 62 and held by the vise 74.

The bracket 474 may accept existing bench-top work piece holders and may, in some constructions, be adjustable to position such holders in the appropriate position. For example, the connecting portion 478 and the support portion 482 may be relatively adjustable to change the orientation, the position, etc., of the support portion 482 relative to the cart 10 (e.g., relative to the table 22, to the channel 62, etc.). In such constructions, structure may be provided between the connecting portion 478 and the support portion 482 to hold the support portion 482 in a selected orientation, position, etc. Such structure may allow quick connection, disconnection, adjustment, etc.

As discussed above, a hanging storage location (not shown) for a power tool (e.g., a corded or cordless band saw, a grinder, a drill, a reciprocating saw, etc.) may be provided in proximity to the vise assembly 470. The storage location may be provided by a portion of the bracket 474 (e.g., below the support portion 482) or may be provided on the cart 10 in proximity to the bracket 474. The storage location may thus provide a location to quickly hang the power tool for out-of-the-way secure storage both between cutting operations and when transporting (rolling) the cart 10 and for quick retrieval of the power tool once the material to be cut is secured in position (e.g., in the vise 74).

The work piece holder or vise assembly 470 may be supported in a manner similar to the extended work surface 234, as described above with respect to FIGS. 1A-1I.

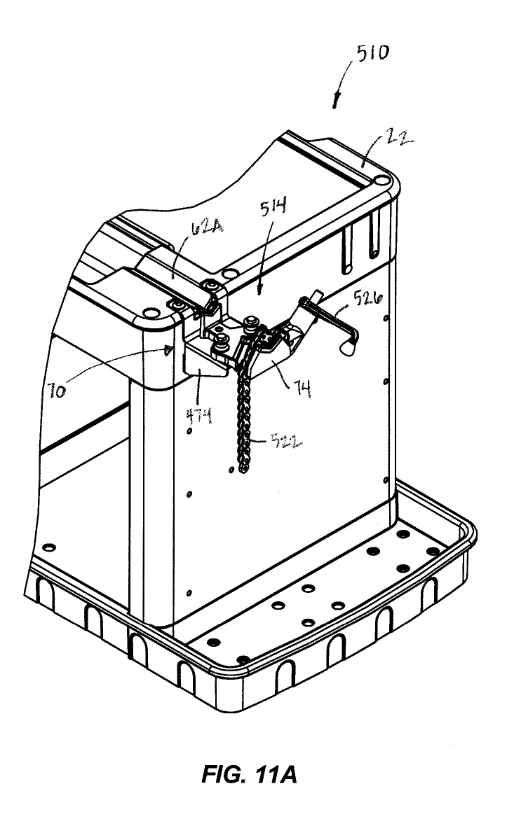

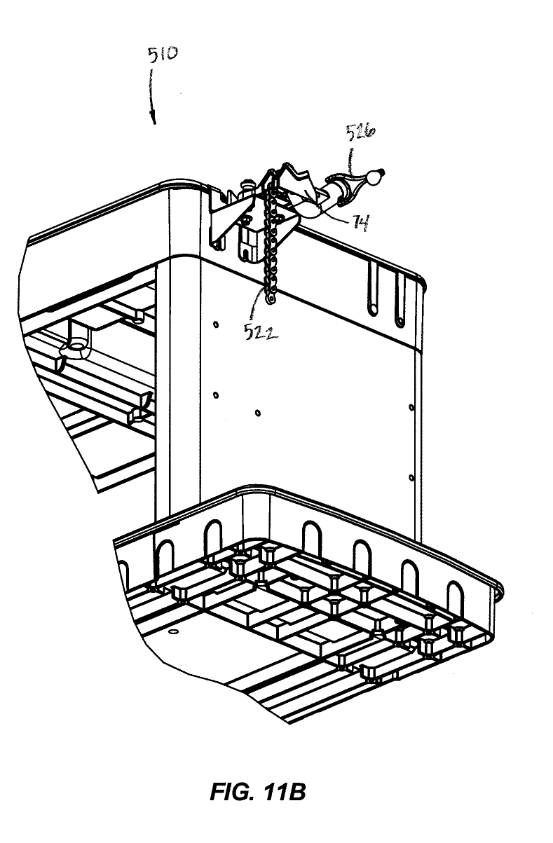

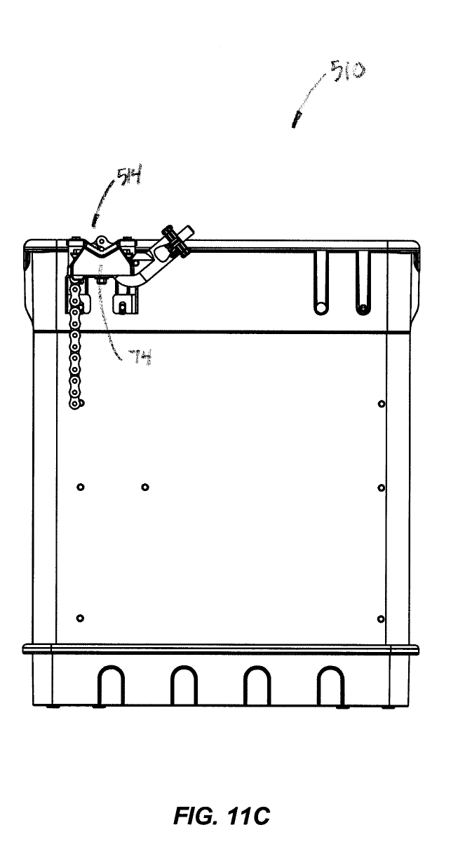

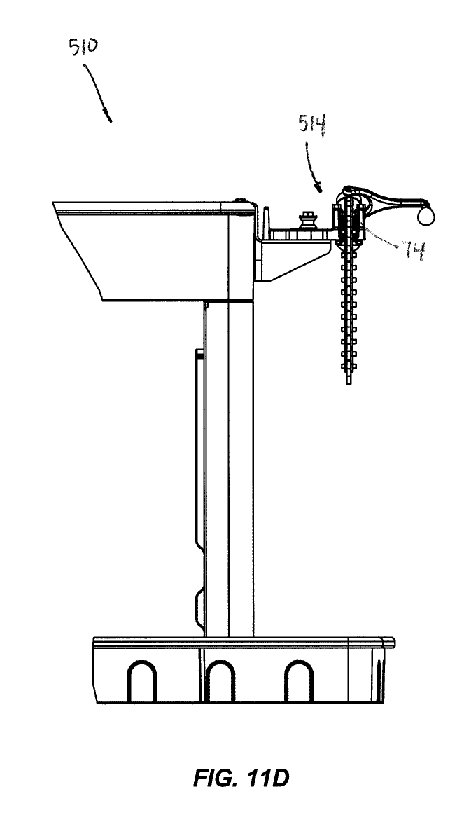

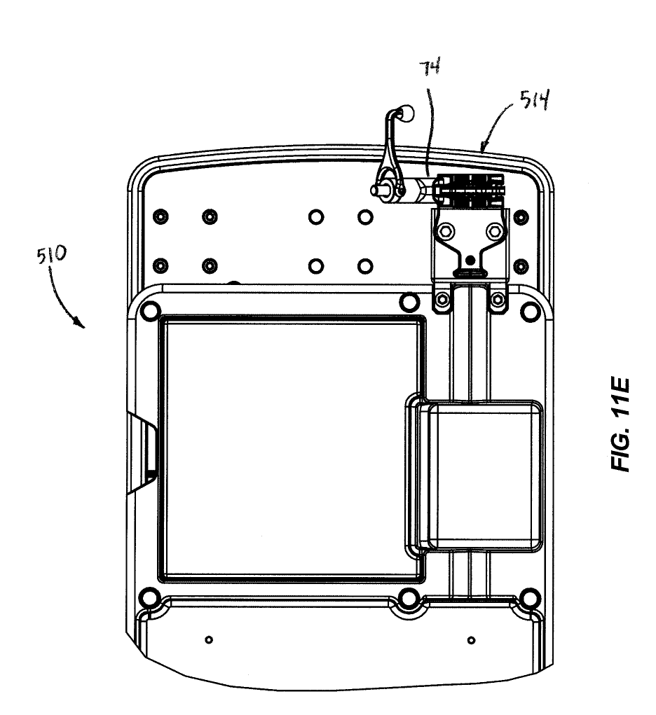

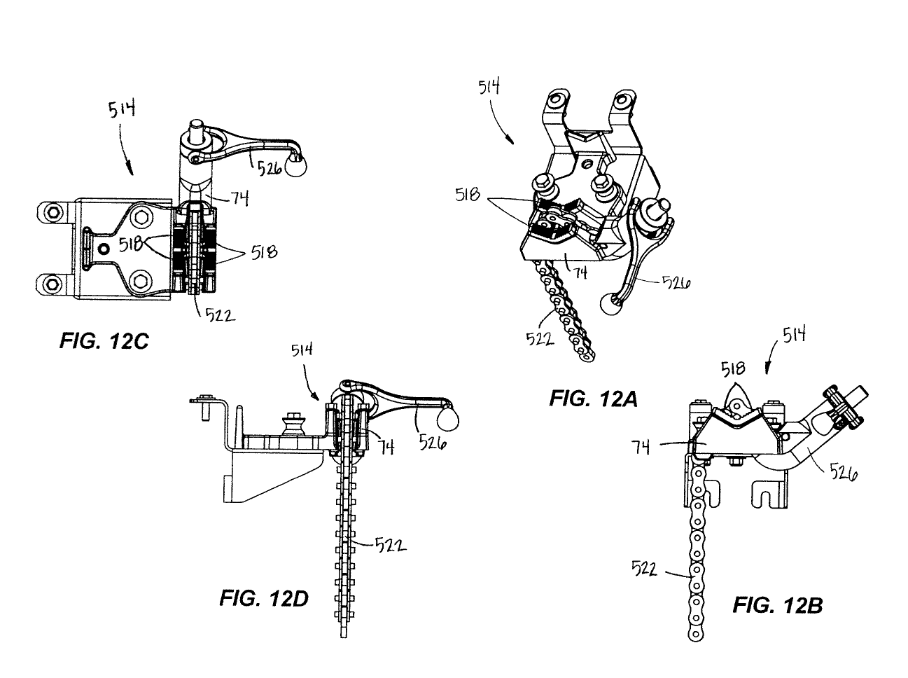

FIGS. 11A-11E illustrate a portion of another construction of an industrial cart 510, similar to the cart 10 shown in FIGS. 2A-2E and 6A-6L; therefore, common structure will be identified by the same reference numerals. The cart 510 includes a work piece holder or vise assembly 514. FIGS. 12A-12D illustrate a portion of the assembly 514.

As shown in FIGS. 12A-12C, the material receiving portion of the vise 74 includes teeth 518 to provide, for example, improved holding of the work piece. In the illustrated construction (see FIGS. 11A-11E and 12A-12D), the vise assembly 514 includes a chain member 522 for holding a work piece. An actuator, lever or handle 526 is provided to adjust the holding force applied by the vise assembly 514 (e.g., by the chain member 522) to hold the work piece.

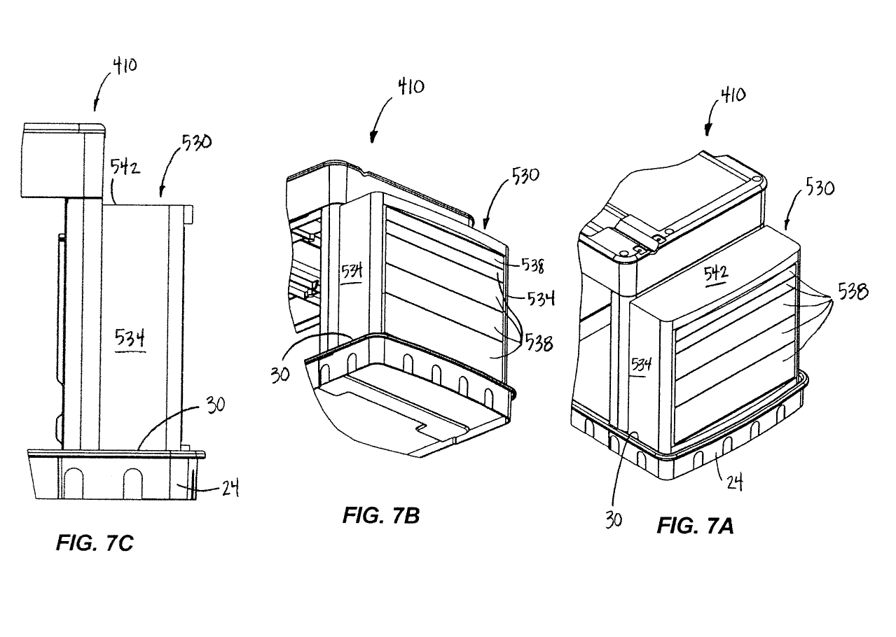

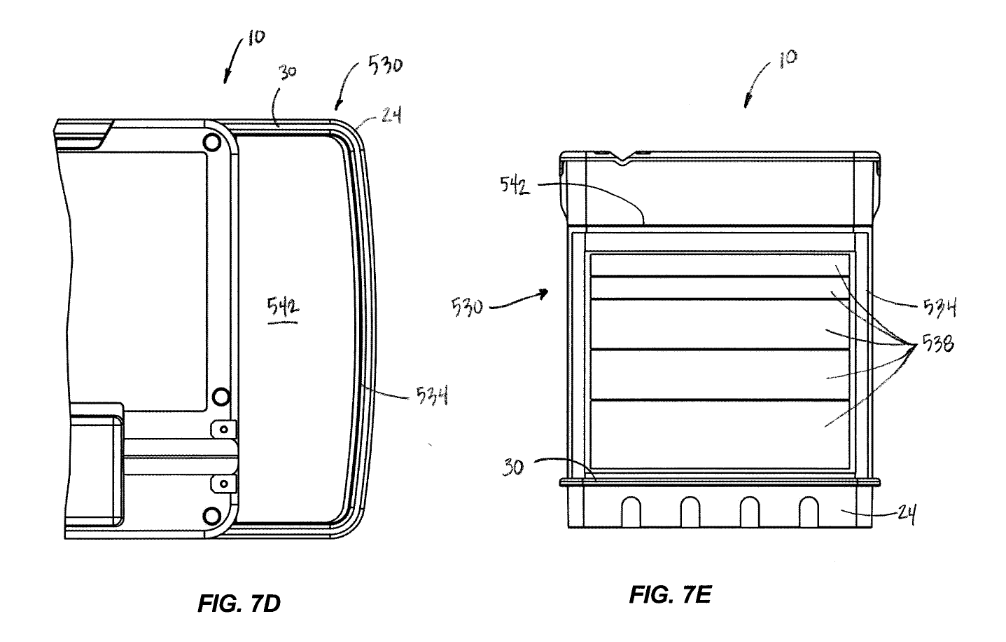

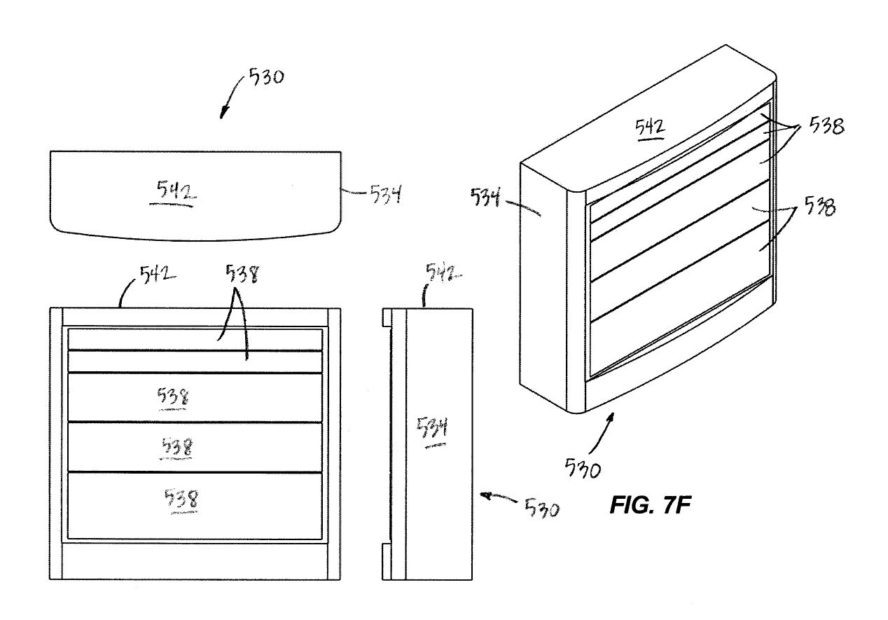

FIGS. 7A-7F illustrate the industrial cart 10 modified to include a storage assembly 530. The assembly 530 provides additional storage for/organization of tools, equipment, materials, consumables, etc.

The storage assembly 530 includes a housing 534 defining one or more storage locations (e.g., supporting one or more trays, bins, shelves 538, etc.). In the illustrated construction, the housing 534 is received in the well or opening provided on the extended front deck 30. Such engagement may be sufficient to retain the storage assembly 530 on the cart 10. Additional connectors (not shown) may be provided to connect the housing 534 to the front wall 86 (through the connecting structure 238).

The housing 534 has a top surface 542 which may provide additional storage, an additional work surface, etc. The top surface 542 may be aligned with the top surface of the table 22. The top surface 542 may have an outer or peripheral raised lip or rim to retain small items (parts, bits, etc.) on the top surface 542.

The storage assembly 530 may be similar to the modular drawer system 222, as described above with respect to FIGS. 1D and 1E.

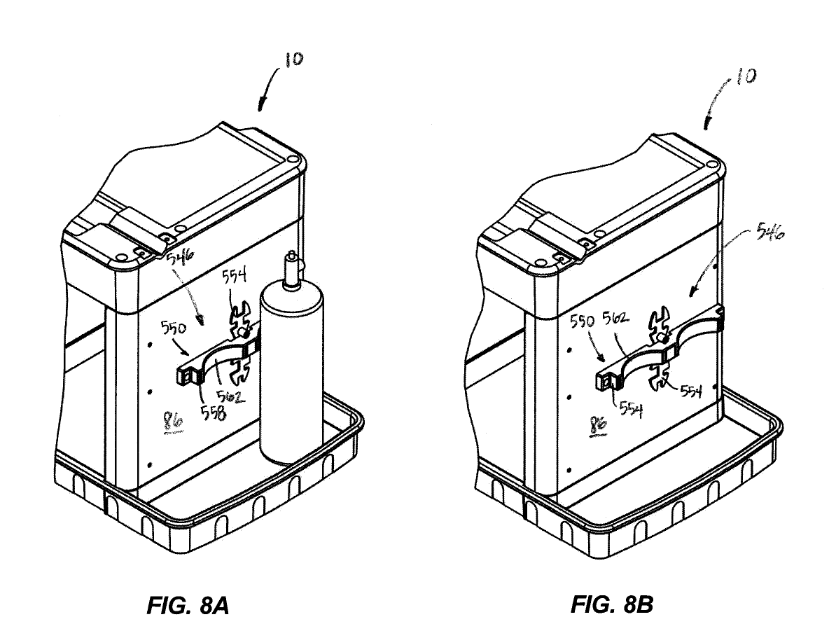

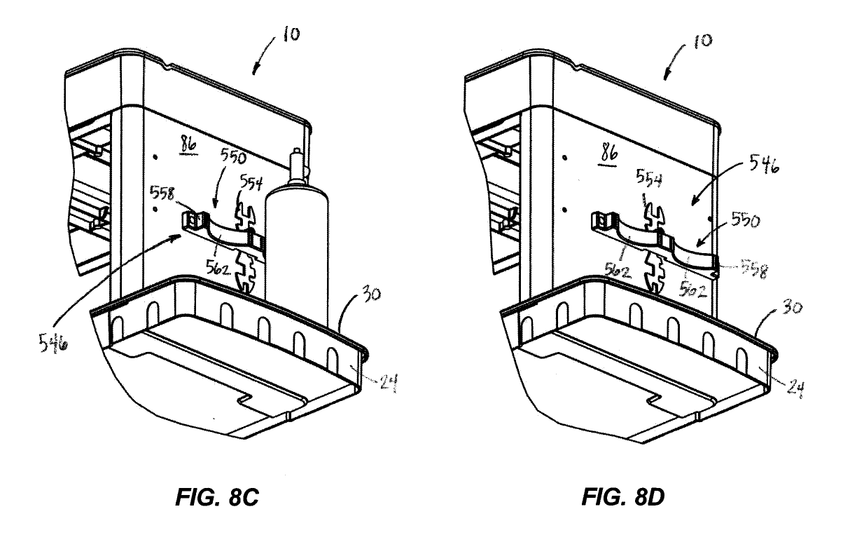

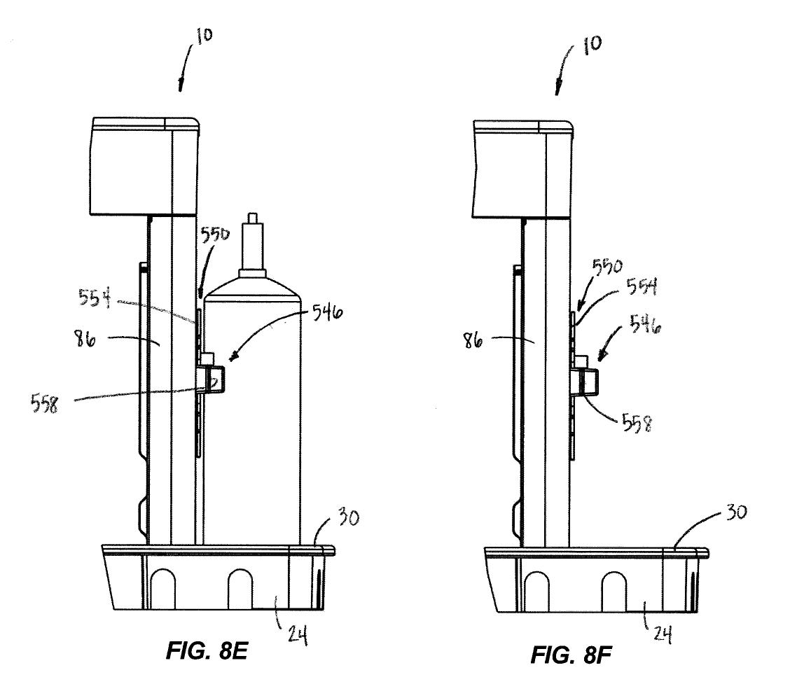

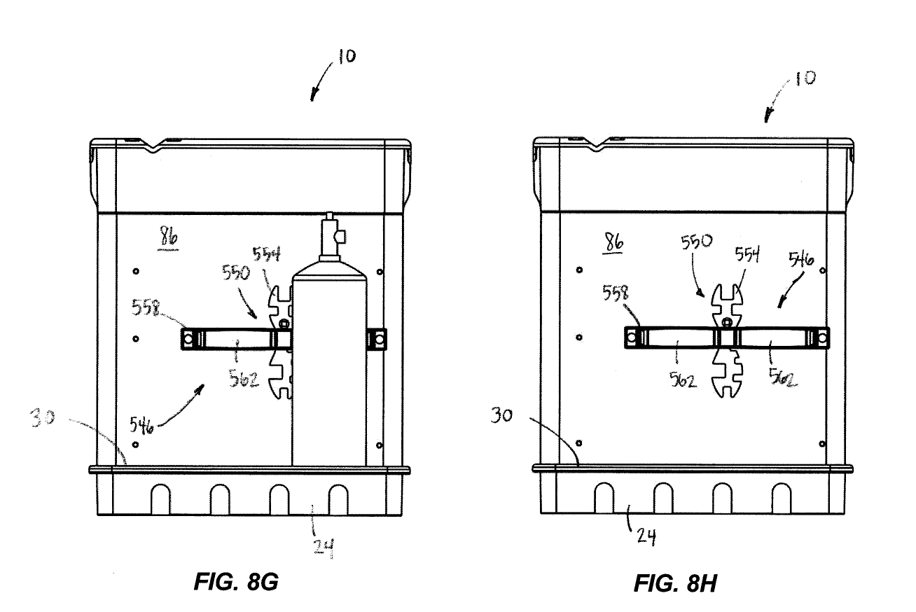

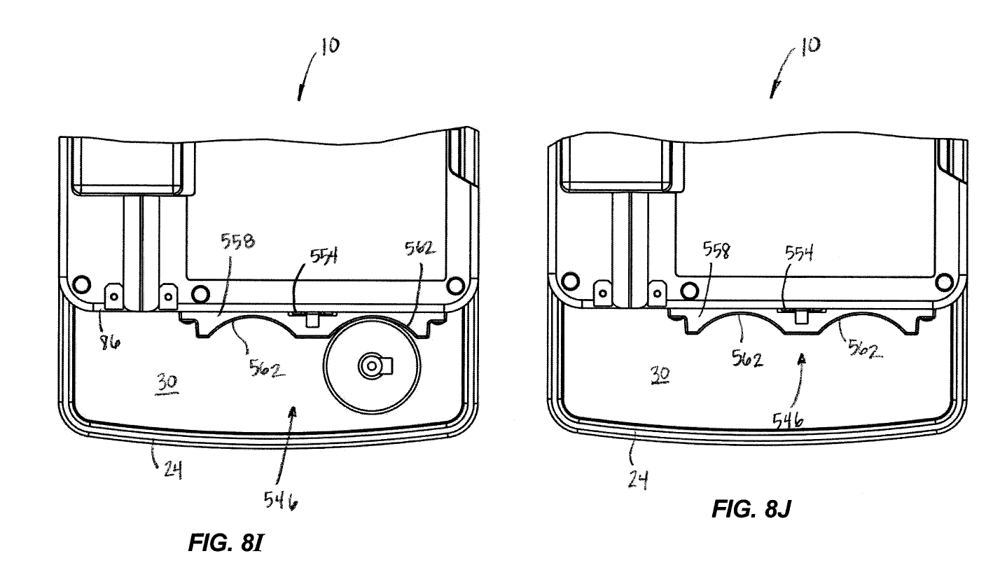

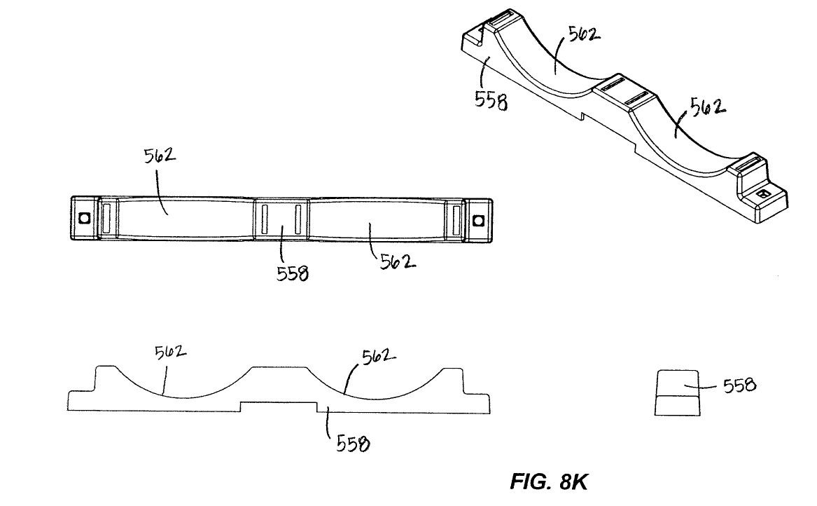

FIGS. 8A-8K illustrate the industrial cart 10 modified to include an assembly 546 for supporting and/or storing tanks. In the illustrated construction, the assembly 546 cooperates with the extended front deck 30 to support and/or retain the tank(s) on the cart 10.

The assembly 546 includes a bracket member 550 having a connecting portion 554 and a body portion 558. The connecting portion 554 is connectable to the cart 10 through the connecting structure 238 on the front wall 86. The body portion 558 defines contours 562 complementary to the outer surface of the tank(s) to be supported by the assembly 546. Retainers (not shown), such as, for example, straps, are connected to the body portion 558 and are engageable with (e.g., extending around) the tank(s) to support and/or retain the tank(s).

In the illustrated construction, the body portion 558 defines locations or contours 562 for two tanks. In other constructions (not shown), the body portion 558 may be provided by body sections (not shown) each defining a contour 562 for a tank. The body sections may be connectable together and/or independently to the cart 10 to support the associated tanks on the cart 10.

Each body section may have a different dimension and/or shape contour to accommodate a tank having a different dimension and/or shape. Accordingly, a user can select the appropriate body section(s) for the selected tank(s) to be supported on the cart 10. The body sections may be connectable at different heights relative to one another to accommodate different size (e.g. different height) tanks.

The assembly 546 may be similar to the tank accessory system 226, 230 include supports/brackets similar to the supports/brackets (not shown), as described above with respect to FIGS. 1G-1I.

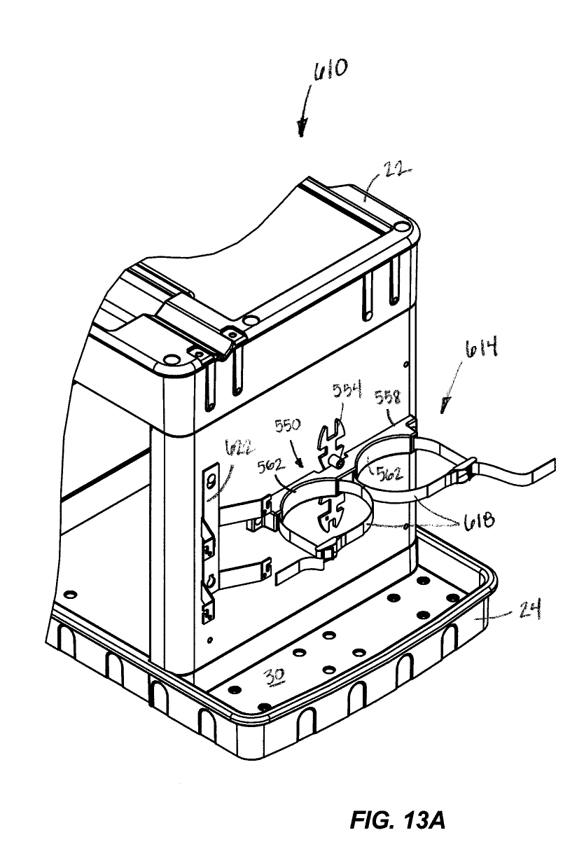

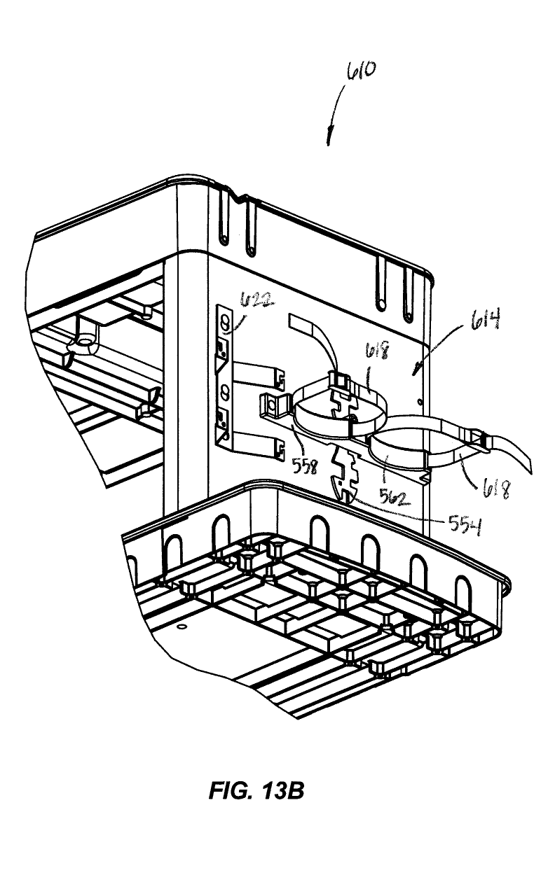

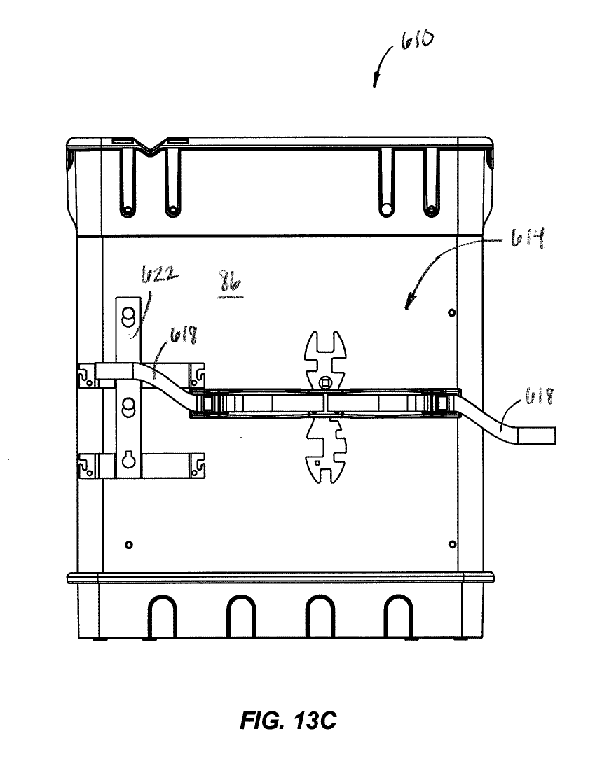

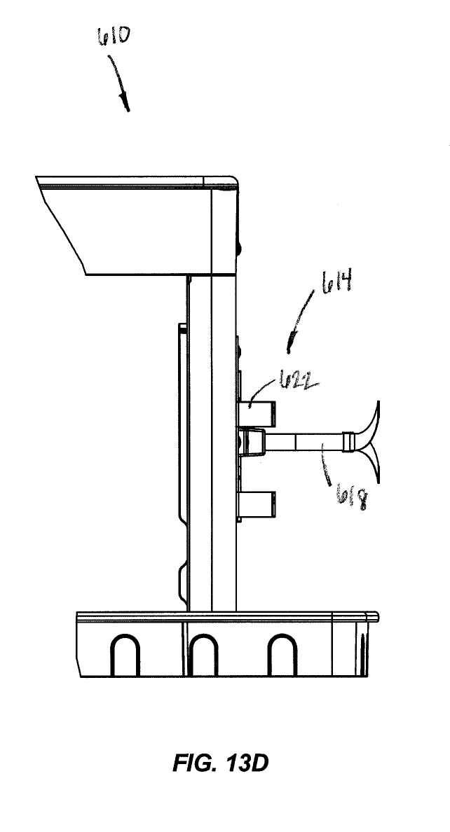

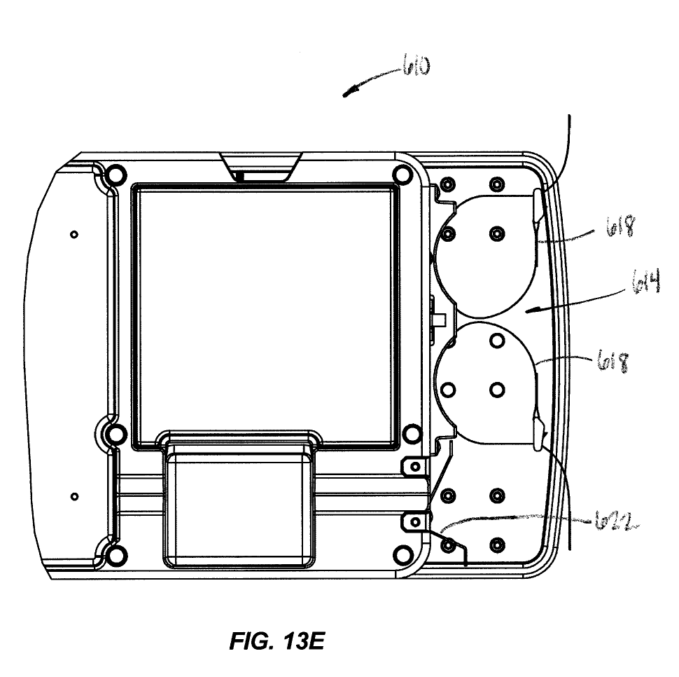

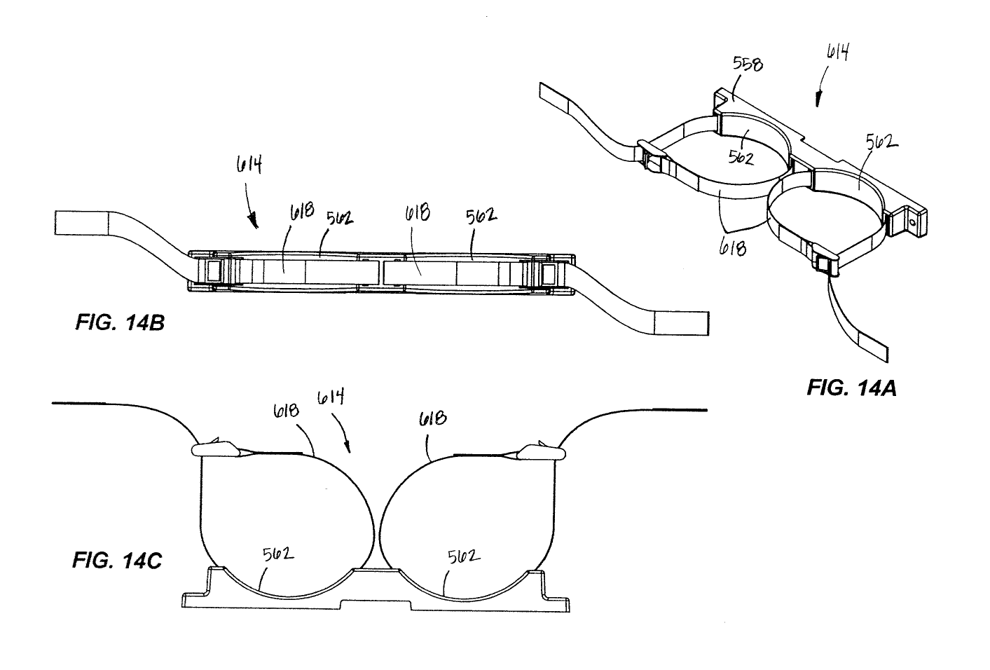

FIGS. 13A-13E illustrate a portion of another construction of an industrial cart 610, similar to the cart shown in FIGS. 2A-2E and 8A-8K; therefore, common structure will be identified by the same reference numerals. The cart 510 includes an assembly 614 for supporting and/or storing tanks. FIGS. 14A-15C and 16A-16D illustrate portions of the assembly 614.

As shown in FIGS. 13A-13E and 14A-14C, the assembly 614 includes retainers, such as, for example, straps 618, are connected to the body 558 and are engageable with (e.g., extending around) the tank(s) (not shown) to support and/or retain the tank(s). In addition, in the illustrated construction, the assembly 614 includes a bracket member 622 having a different configuration than the bracket member 550 to retain a different type of tank (e.g., a fire extinguisher).

Other modular accessories or assemblies (e.g., tool racks, dust collection systems, work supports, table mounted power tools, etc.) may be supportable on the cart 10 in a manner similar to those described above. Connection may be provided through the modular connecting structure 238 and/or the well or opening provided in the extended front deck 30.

In some constructions (not shown), the above-described and other accessories or assemblies may be supportable on a two-wheeled cart or dolly (not shown). Such a two-wheeled cart may be similar to that described and illustrated in U.S. Pat. No. 5,509,671, issued Apr. 23, 1996, the entire contents of which are hereby incorporated by reference.

The accessories may be supportable on two-wheeled cart in a manner similar to those described above. Connection may be provided through a modular connecting structure (similar to the connecting structure 238) provided on the two-wheeled cart.

In some constructions, the connecting structure may include a wall structure (similar to the front wall 86) which is connectable to the frame of the two-wheeled cart. In some constructions, the wall structure may be removably connectable to the frame of the two-wheeled cart. In other constructions, the wall structure may form at least a portion of the frame of the two-wheeled cart.

In other constructions (not shown), the accessories or assemblies may be modified to connect directly to the structure of the two-wheeled cart, as discussed below.

FIGS. 17A-17C are views of a two-wheeled cart 710 for use with modular accessories or assemblies, as described above. Generally, the cart includes a frame 714 supported by wheels 718 (e.g., two) for movement over ground. The cart 710 includes at least one handle 722 for engagement by a user. The cart 710 also includes a support plate 726 which may cooperate to support and/or support a load carried by the cart 710. The cart 710 may be modified by adding one or more modular accessory units to modify the cart 710 for use by an electrician, a plumber, a maintenance worker, etc.

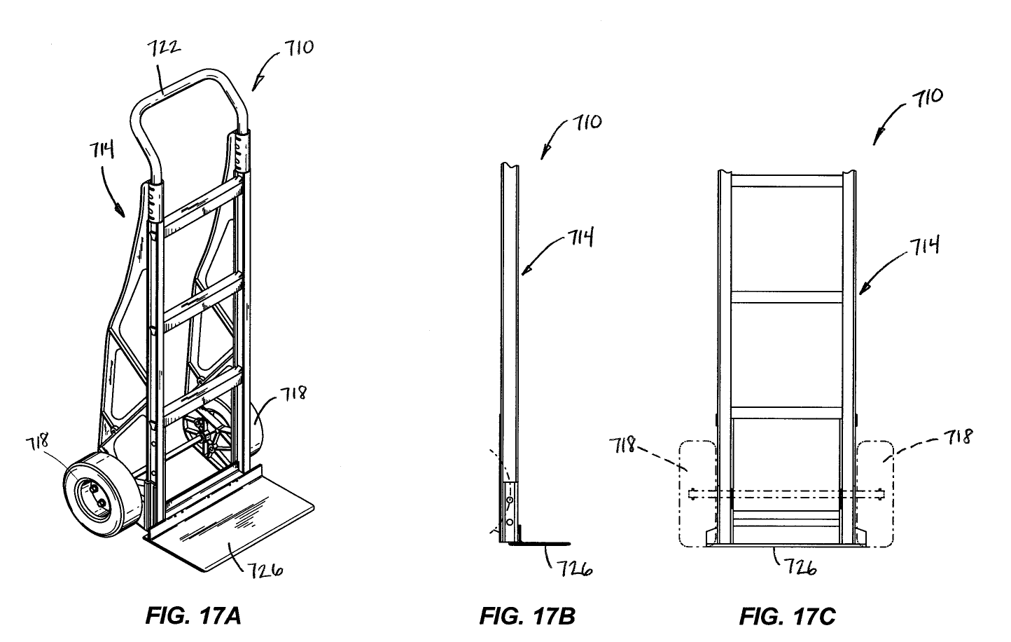

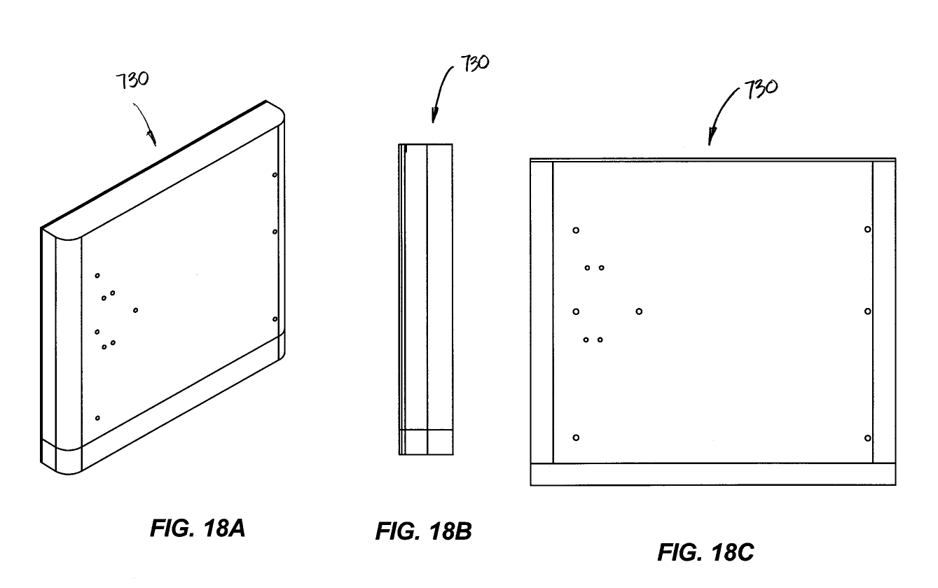

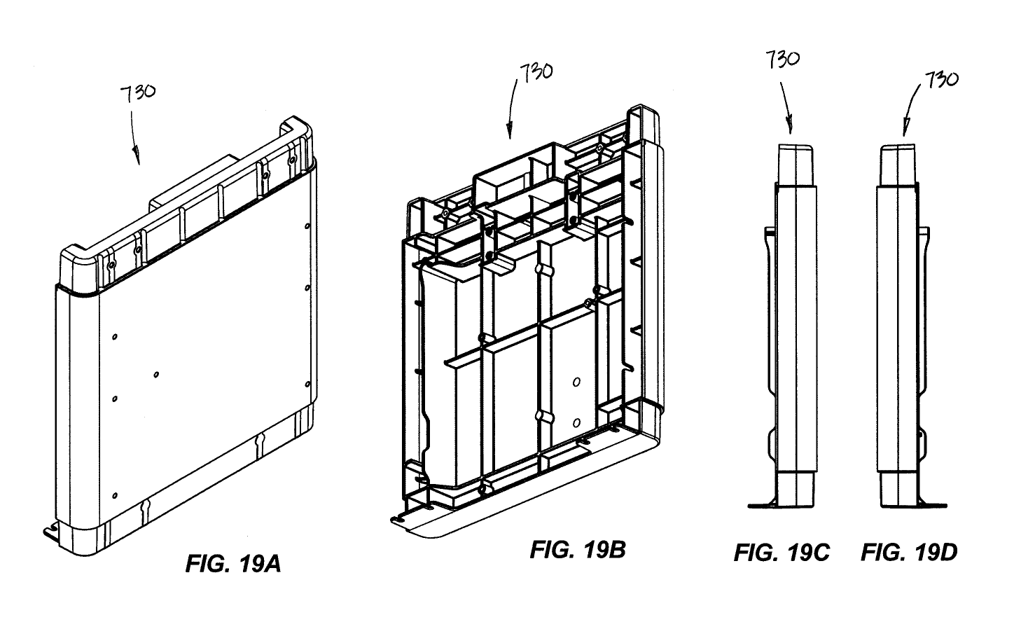

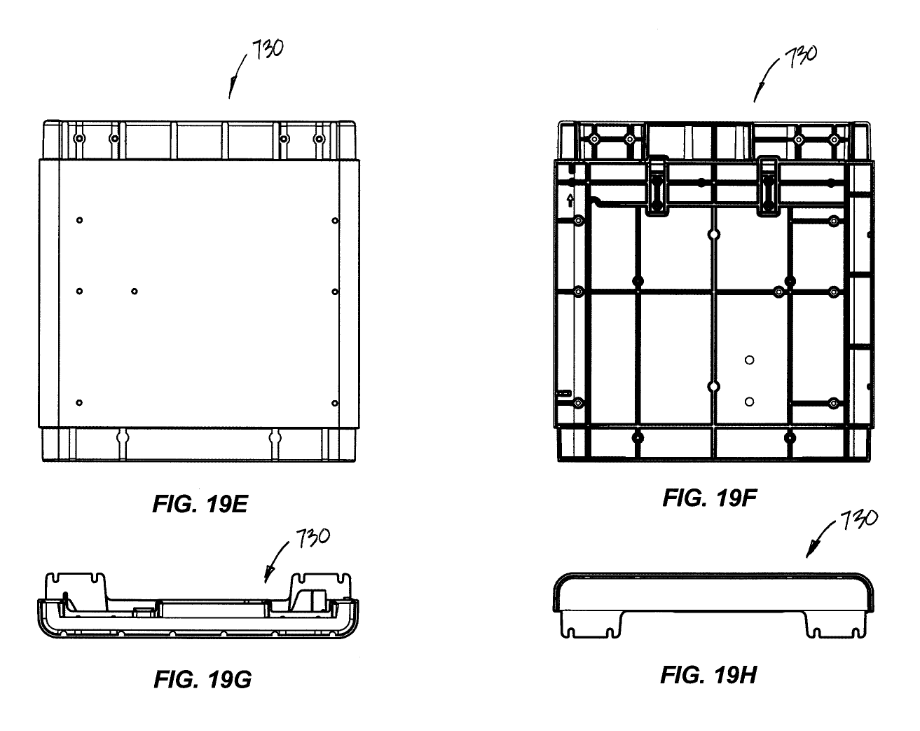

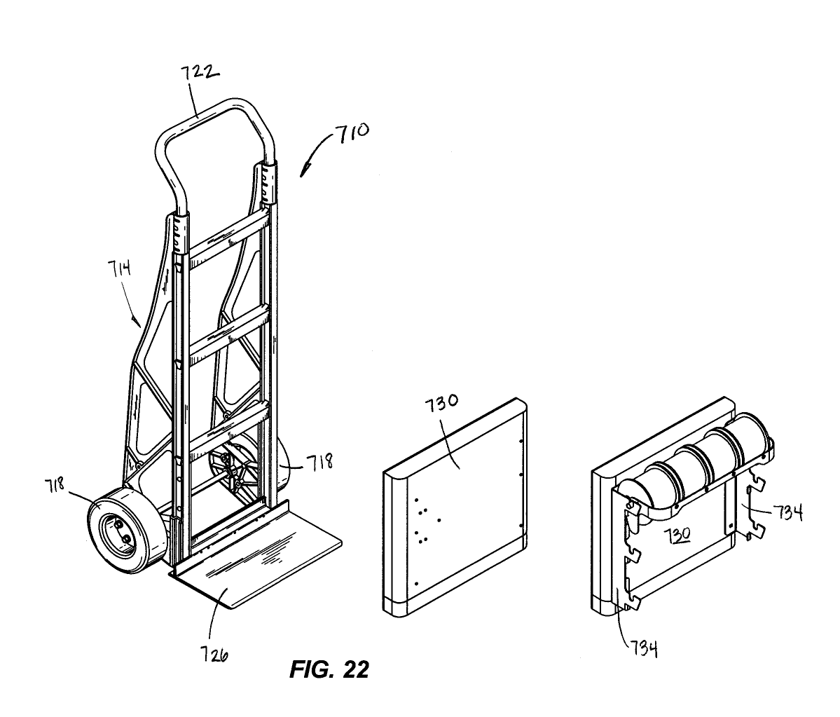

A wall 730, such as the wall shown in FIGS. 18A-18C or in FIGS. 19A-19H or similar to the front wall 86, may provide a connecting structure to connect an accessory to the cart 710, as described below in more detail. The wall 730 is connectable (see FIGS. 22, 23, and 24A-24C) to the frame of the two-wheeled cart 710. In some constructions, the wall structure 730 may be removably connectable (e.g., with fasteners, studs/slots, rails/grooves, etc.) to the frame 714 of the two-wheeled cart 710. In other constructions, the wall structure 730 may form at least a portion of the frame 714 of the two-wheeled cart 710.

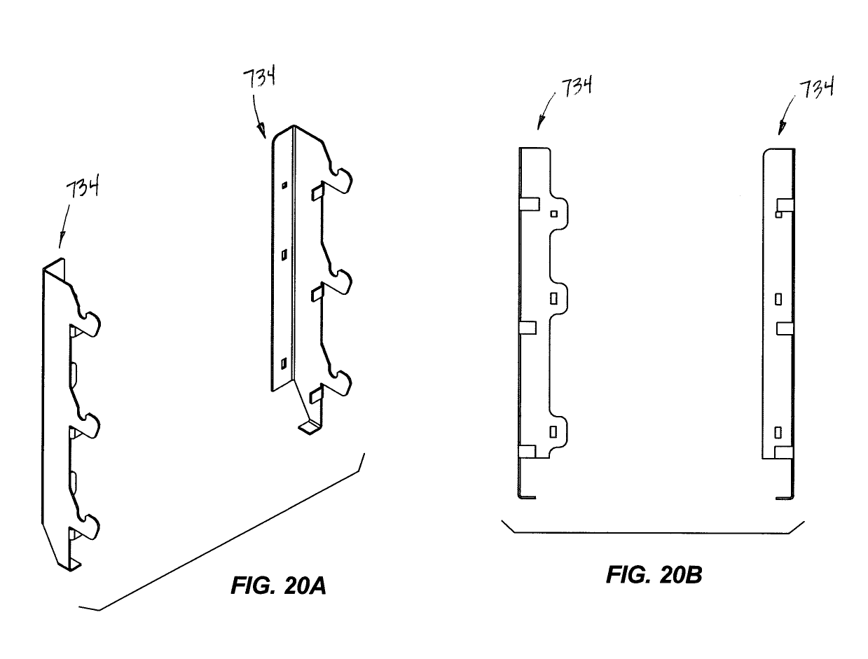

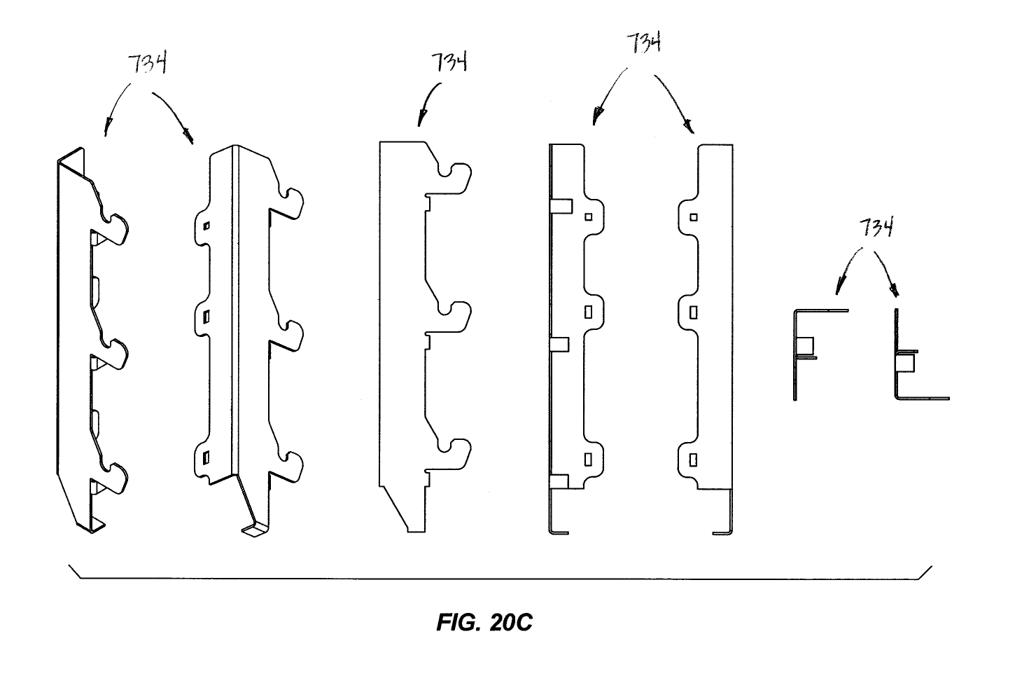

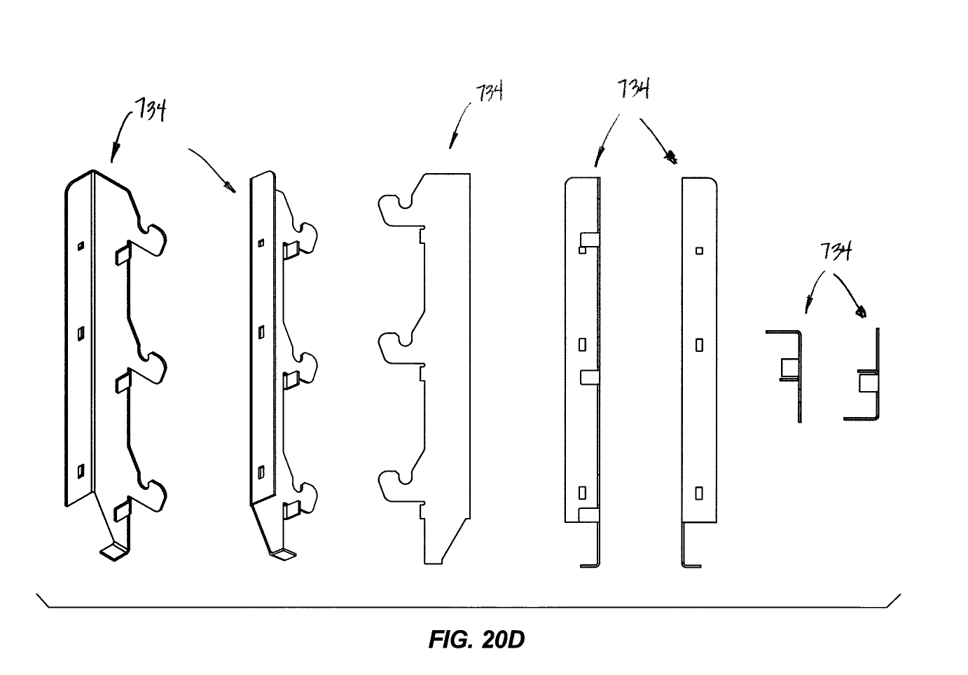

As discussed above, the two-wheeled cart 710 (shown in FIGS. 17A-17C) may be used with an accessory, such as, for example, an assembly for supporting one or more reels. Brackets 734, or supports, for use in an assembly for supporting one or more reels, are shown in FIGS. 20A-20D. The brackets may be similar to the supports 246 described above. The brackets 734 may be used to support other items (e.g., tool boxes, storage containers, etc.) having structure similar to the reel rack assembly 242 (e.g., the shaft 250, the frame 278, etc.).

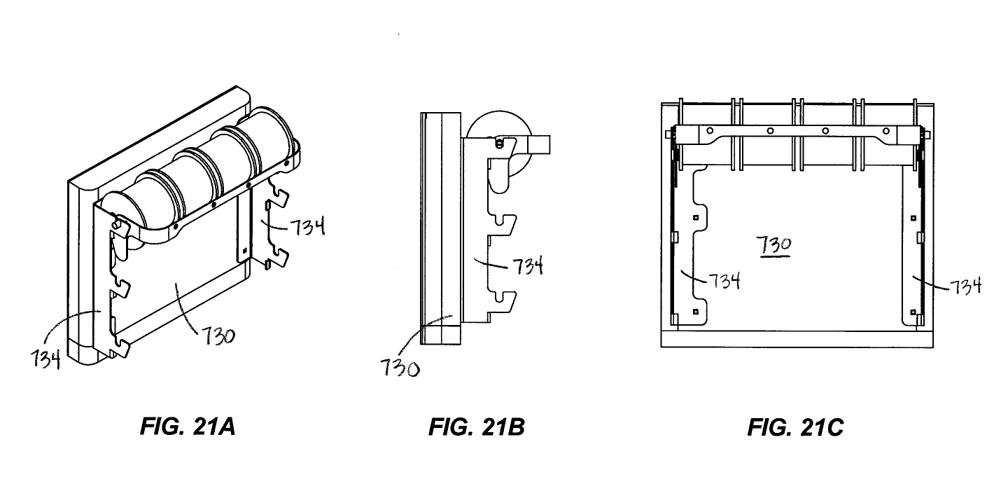

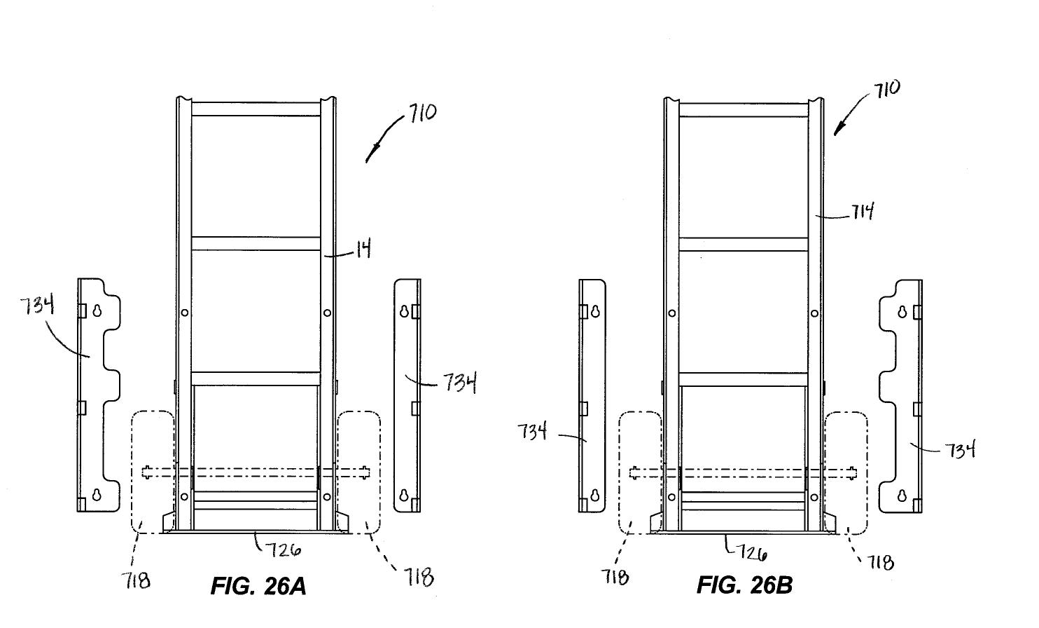

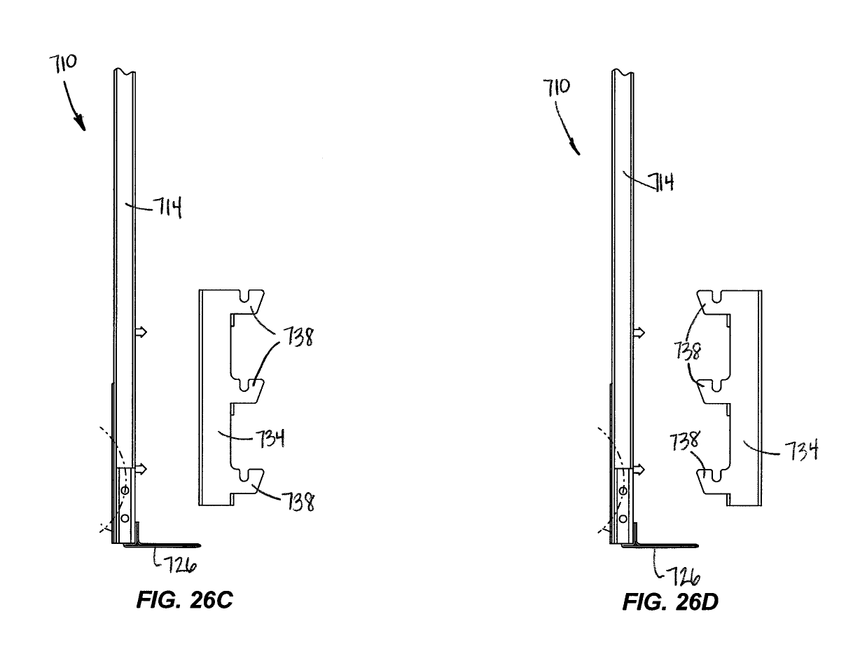

As shown in FIGS. 21A-21C, 22, 23 and 24A-24C, the brackets 734 may be used with/connectable to a wall, such as the wall 730 shown in FIGS. 18A-18C or in FIGS. 19A-19H, and connected to a two-wheeled cart, such as the cart 710 shown in FIGS. 17A-17C. As shown in FIGS. 26A-26D and 27, the brackets 734 may be used with/directly connectable to the frame 714 of the two-wheeled cart, such as the cart 710 shown in FIGS. 17A-17C.

The brackets 734 may be removably connected to the wall 730 or to the frame 714 of the cart 710. In such constructions, the brackets 734 may be removed when not in use so as to not interfere with the operation of the cart 710. The removable connection may be provided by, for example, removable fasteners (not shown).

In other constructions, the removable connection may be provided by quick-connecting arrangements. For example, the wall 730 or the frame 714 may include projections or headed-studs, and the brackets 734 may include complementary openings, through which the head or shaft of the stud is received, and slots, which restrict movement of the stud (e.g., by limiting movement of the head of the stud) to retain the bracket 734 on the wall 730 or the frame 714. In other constructions, the studs may be provided on the brackets 734, and the openings/slots may be provided on the wall 730 or the frame 714.

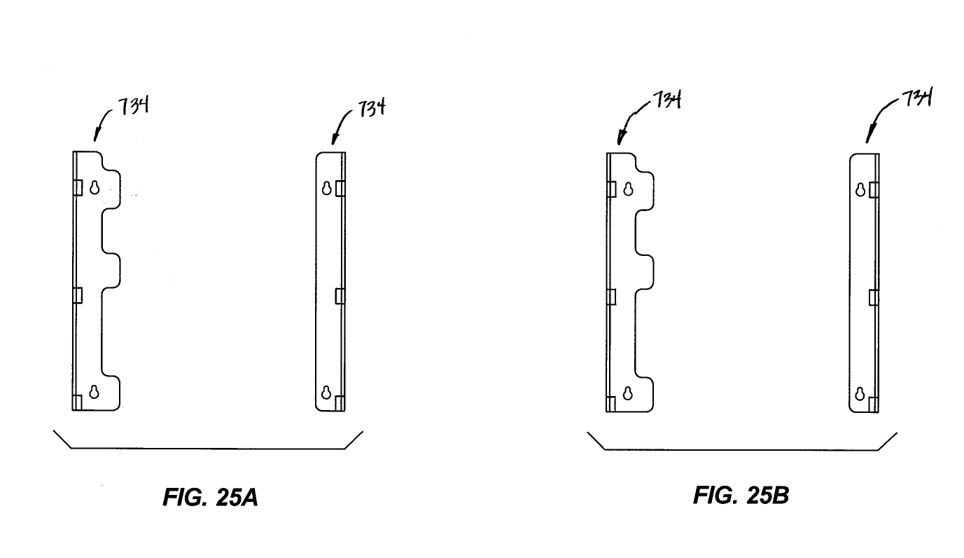

In some constructions, such as that shown in FIGS. 25A-25B and 26A-26D, the connecting arrangement may enable the brackets 734 to be stored on the cart 710 when not in use so as to not interfere with the operation of the cart 710. In such constructions, in the stored position, the brackets 734 are reversed, with support arms 738 extending towards the frame 714, and connected on the opposite side of the frame 714.

In some constructions, such as that shown in FIG. 27, the structure of the bracket 734 may enable the bracket 734 to be positioned so as to not interfere with the operation of the cart 710 when the bracket 734 is not in use. As shown in FIG. 27, the bracket 734 includes a base 742 connected to the frame 714 and a body 746 including the support arms 738. A hinge assembly 750 is provided between the base 742 and the body 746 such that the body 746 is movable from a use position (similar to that shown in FIGS. 21A, 22 and 26C), in which the support arms 738 extend from the frame 714 to support a reel rack assembly, and a stored position (as shown in FIG. 27), in which the support arms 738 are pivoted (e.g., outwardly) and generally into the plane of the frame 714. Such an arrangement, as shown in FIG. 27, may provide additional lateral support for material transported on the cart 710.

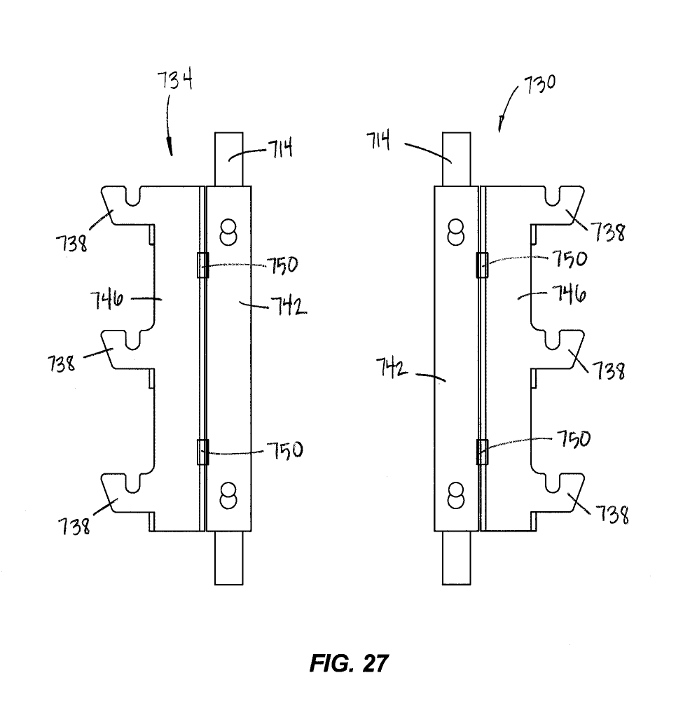

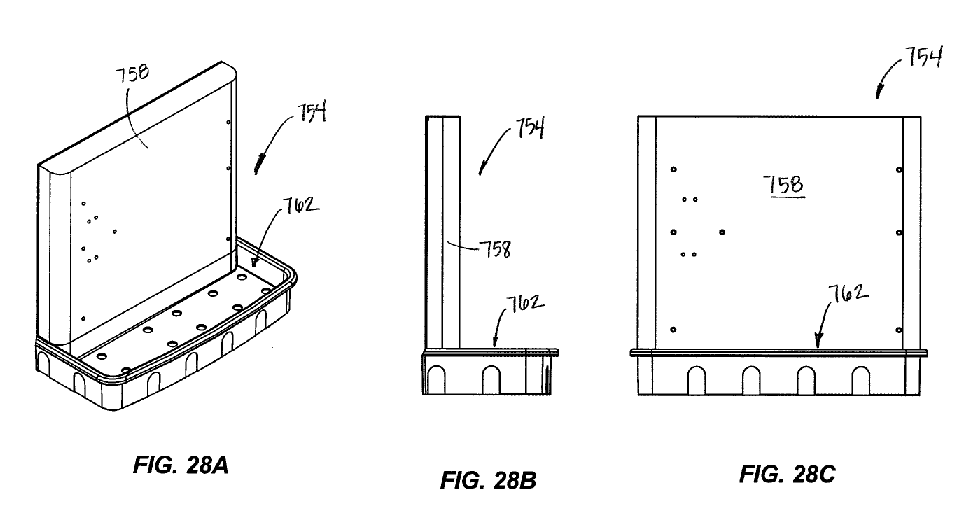

A storage/carrying assembly 754, for use with an industrial cart 10, such as the cart shown in FIGS. 2A-2E and 3A-3G, or with a two-wheeled cart, such as the cart 710 shown in FIGS. 17A-17C, is illustrated in FIGS. 28A-28C. The assembly 754 may include a wall 758, similar to the wall shown in FIGS. 18A-18C or in FIGS. 19A-19H, and a well 762 or support structure similar to that provided on the extended front deck 30, as described above.

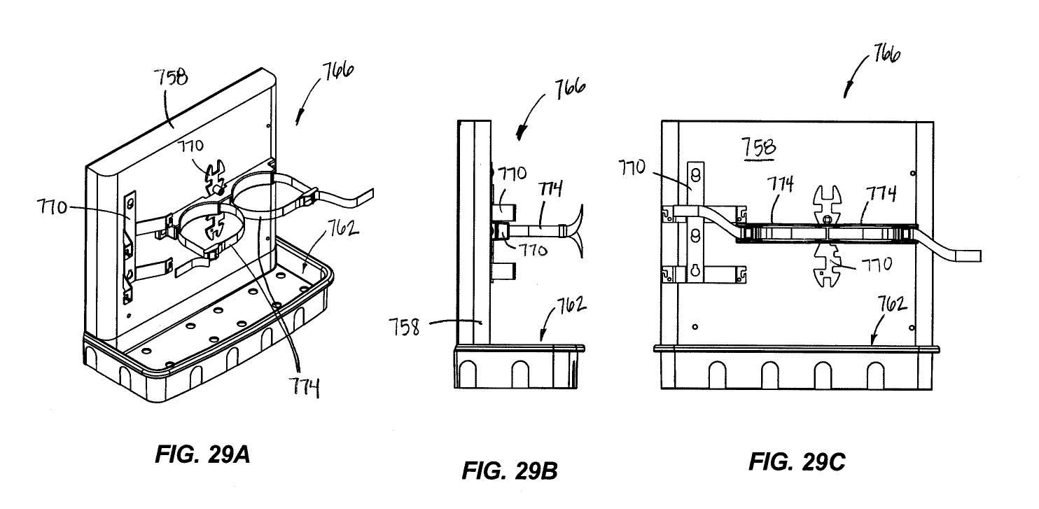

A similar arrangement providing a tank storage assembly 766 is shown in FIGS. 29A-29C. The tank storage assembly 766 also includes brackets 770 and retainers 774 to support and/or retain one or more tank(s) on the cart 710.

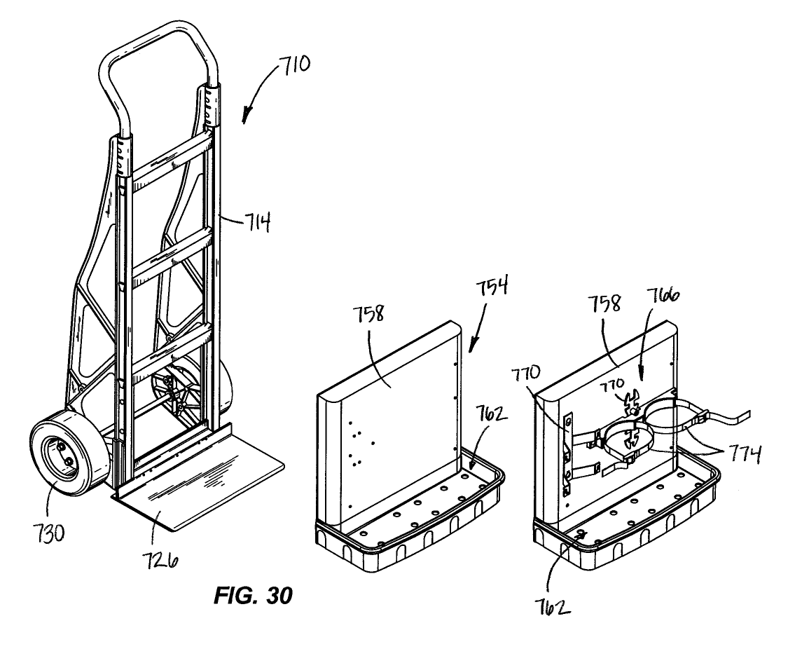

FIGS. 30, 31 and 32 illustrate the two-wheeled cart 710 usable with the storage/carrying assembly 754 or with the tank storage assembly 766. The assembly 754, 766 is connectable to the frame 714 of the two-wheeled cart 710. In some constructions, the assembly 754, 766 is removably connectable (e.g., with fasteners, studs/slots, rails/grooves, etc.) to the frame 714 of the two-wheeled cart 710. In other constructions, the assembly 754, 766 forms at least a portion of the frame 714 of the two-wheeled cart 710.

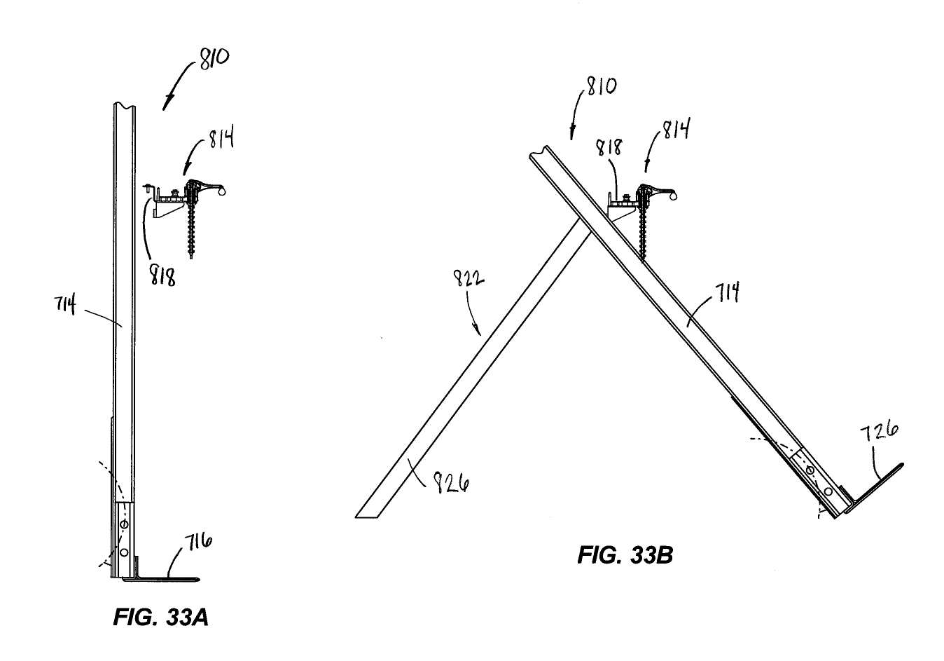

FIGS. 33A and 33B illustrate a two-wheeled cart 10 usable with a work piece holder or vise assembly 814. The cart 810 is similar to the cart 710 shown in FIGS. 17A-17C; therefore, common structure is identified by the same reference numerals. The cart 810 also includes a vise support 818 to which the vise assembly 814 is connected. In addition, the cart 810 includes an auxiliary support assembly 822 (see FIG. 33B). In the supporting position (FIG. 33B), a user may secure a work piece in the vise assembly 814 and perform an operation on the work piece (e.g., cutting, sanding, shaping, etc.).

The support assembly 822 may include one or more legs 826, frame members, etc. which are movable between a closed, stored position (shown in FIG. 33A), in which the support assembly 822 is stored, for example, during movement of the cart 810, and an open, supporting position (shown in FIG. 33B), in which the support assembly 822 is extended to convert the cart 810 to a work support. A locking assembly (not shown) may be provided to lock the support assembly in position.

It should be understood that the work piece holder or vise assembly 814 and the related structure, described above, may be added to any of the constructions described.

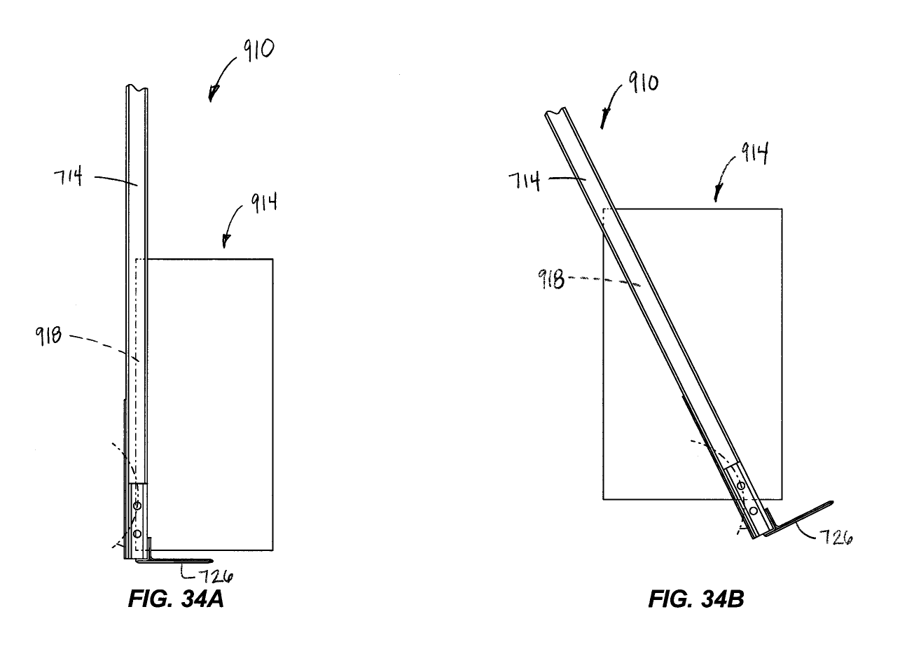

FIGS. 34A and 34B illustrate a two-wheeled cart 910 usable with a storage container 914, tool box or similar structure and illustrating operation of the assembly. The cart 910 may be similar to the cart 710 shown in FIGS. 17A-17C; therefore, common structure is identified by the same reference numerals. The cart 910 also includes a support arrangement 918 for pivotally supporting the container 914. As shown in FIG. 34B, the container 914 is pivotable to be retained in a substantially upright position during movement of the cart 910.

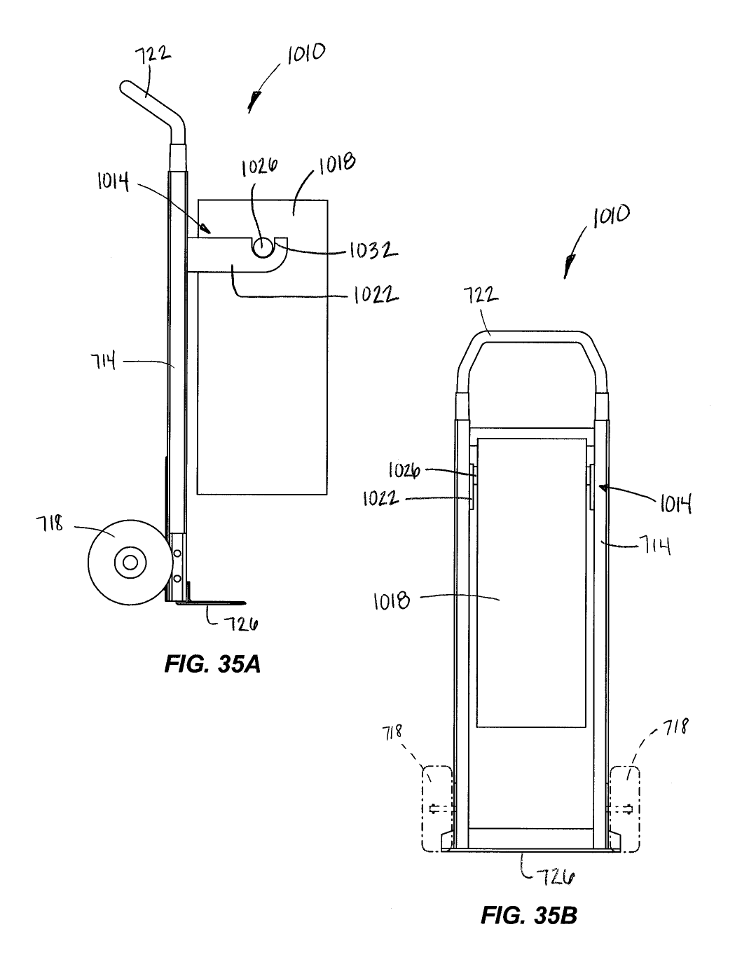

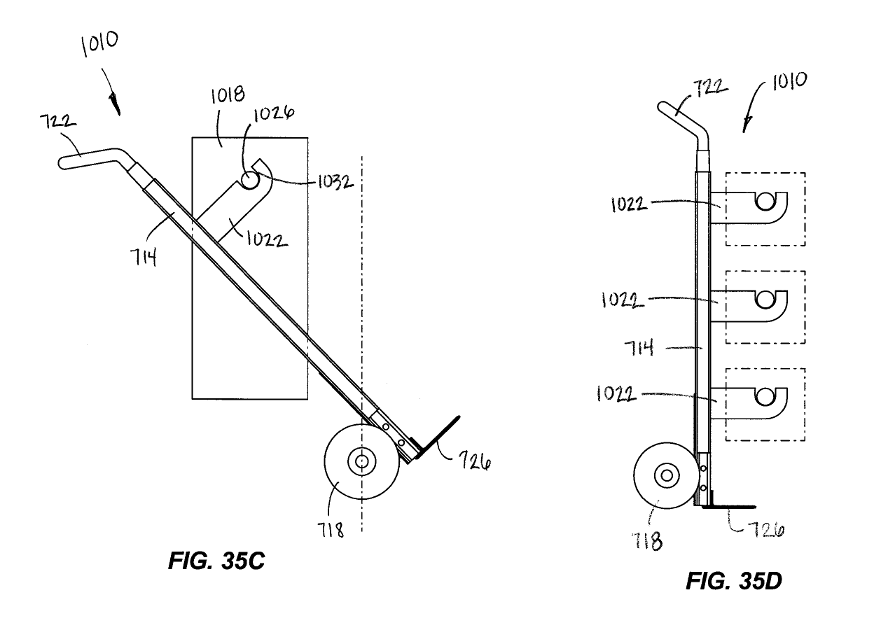

FIGS. 35A-35D illustrate another construction of a two-wheeled cart 1010 for use with one or more modular accessories or assemblies, as described above. The cart may be similar to that shown in FIGS. 17A-17C; therefore, common structure is identified by the same reference numerals. In the illustrated construction, the cart 1010 includes an assembly 1014 for supporting one or more storage containers 1018, tool box, or similar structure. The assembly 1014 includes a pair of supports 1022, or brackets, extending forward from the frame 714, which may be similar to the supports 734 described above or shown in FIGS. 20A-20D, 21A-21C, 22, 23 or 24A-24C.

The storage container 1018 includes a rod 1026 or shaft, extending from each side of the container 1018. Each support 1022 includes a slot 1032, or notch, for pivotally supporting the rods 1026 of the storage container 1018. As shown in FIG. 35C, as the cart 1010 is tilted for movement over the ground, the container 1018 pivots relative to the frame 714 and the supports 1022 such that the container 1018 remains in an upright position. Other constructions of the supports 1022 are described above with respect to FIGS. 25A-25B, 26A-26D and 27.

FIG. 35D illustrates a construction of the cart 1010 including three sets of supports 1022 for supporting modular accessories or assemblies. For example, each set of supports 1022 may support a storage container, a tool box, a wire reel, or similar structure.

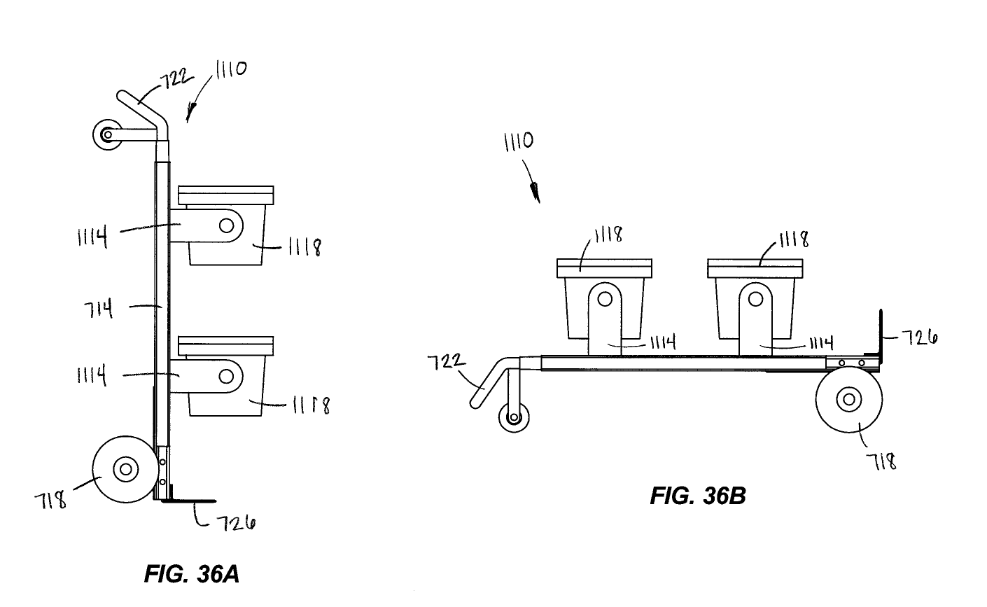

FIGS. 36A and 36B illustrate a wheeled cart 1110 for use with one or more modular accessories or assemblies, similar to the carts described above. The cart 1110 is configured for orientation in a first, upright position (FIG. 36A) as a two-wheeled cart and in a second, down position (FIG. 36B) as a four-wheeled cart. Similar to the cart 1010 described above with respect to FIGS. 35A-35D, the cart 1110 includes at least one set of supports 1114, or brackets, for supporting a storage container 1118, tool box or similar structure. The storage containers 1118 are removable supported by the supports 1114 and pivotal relative to the supports 1114. Therefore, whether the cart 1110 is in the first position or the second position, the containers 1118 remain in an upright position.

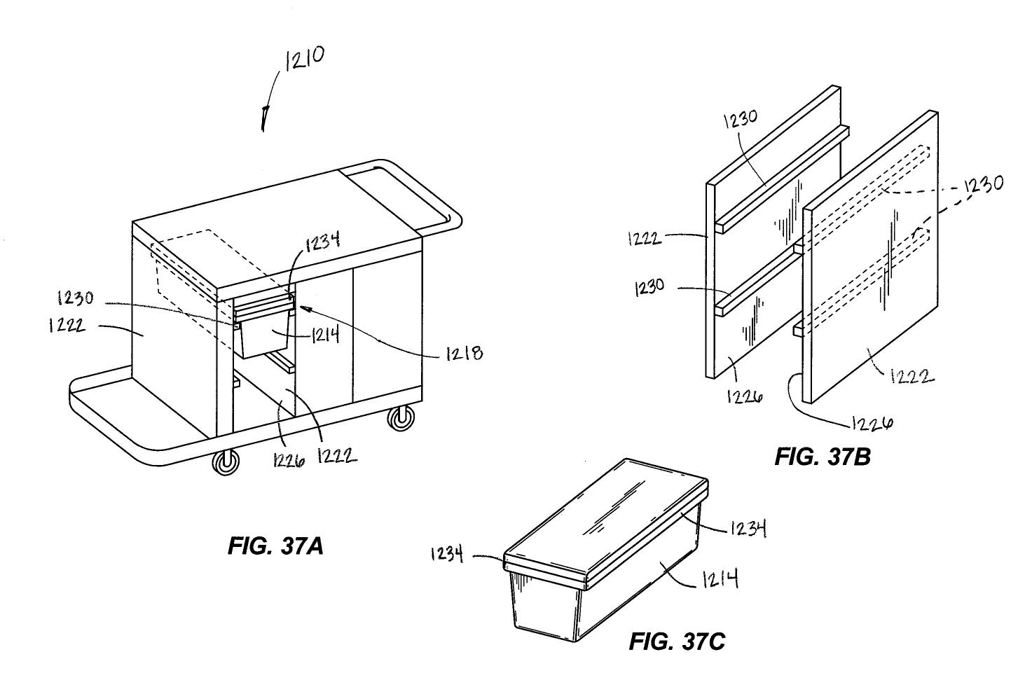

FIGS. 37A illustrates a four-wheeled cart 1210 supporting a slidable storage container 1214 and FIGS. 37B and 37C illustrate a slidable storage container assembly 1218. It should be readily apparent to those of skill in the art, that this construction may be used with any of the carts described above with respect to FIGS. 1A-1I, 2A-2E, 3A-3G or 17A-17C; therefore, common structure will be identified by the same reference numerals. The assembly 1218 includes at least one storage container 1214 (FIG. 37C; or tool box or similar structure) slidably supported by walls 1222 (FIG. 37B) of the cart 1210.

Referring to FIGS. 37A and 37B, in one construction the walls 1222 are spaced apart and extend between the base 24 and table surface 22 of the cart 1210. An interior surface 1226 of each wall 1222 includes at least one ledge 1230, or slide mechanism, which is opposed from and aligned with the ledge 1230 of the opposite wall 1222. The storage container 1214 includes projections 1234 extending from opposite sides of the container 1214. In use, the projections 1234 are slidably supported by the wall ledges 1230 such that the container 1214 may be slid in and out of the cart 1210. In another construction, slide mechanisms may be used to slidably support the container 1214 between the walls 1222.

In some aspects and in some constructions, the cart may provide one or more of durability and survivability on a job site (for the cart and/or for tools, equipment, materials, etc., supported on the cart), mobility (to, from and around a job site including movement through standard door openings), storage (e.g., organization), material handling, including relatively large open areas for large items (e.g., tools, tool bags and kits, equipment, coolers, packaged materials, etc.), versatility and adaptability (of the cart), security (of the cart and/or of tools, equipment, materials, etc., supported on the cart), etc. In some aspects and in some constructions, the cart may provide improved working surfaces and working areas for working on and/or assembly of materials, for working with tools, equipment, materials, etc.

In some aspects and in some constructions, the cart is sized to fit easily through standard door openings (having a maximum width of about 26″ to fit through a standard door opening of about 32″).

In some aspects and in some constructions, the cart is constructed to be durable and to carry tools, equipment, materials, etc. required on a typical job site while maintaining a reasonable unloaded weight (e.g., less than 150 lbs.) so that the cart may be carried by two people. In such aspects and in such constructions, the cart may include a frame assembly including relatively lightweight plastic materials providing large portions of many components (e.g., the base, the table, the cabinet, etc.) reinforced by stronger but heavy reinforcing members (e.g., steel bars supporting and/or reinforcing the base, the table, etc.).

It is to be understood that the invention is not limited in its application to the details of the construction and the arrangements of the components set forth in the above description or illustrated in the drawings. The invention is capable of other embodiments and of being practiced or carried out in various ways which are still within the spirit and scope of the present invention. Also, it is understood that the phraseology and terminology used herein is for the purpose of description and should not be regarded as limiting. Various features and advantages of the invention are set forth in the following claims.

What is claimed is:

1. A cart comprising:
a cart frame, the cart frame including a wall;
a wheel connected to the cart frame and operable to support the cart for movement over the ground;
a reel rack assembly coupled to the wall, the reel rack assembly including
a pair of support brackets coupled to the wall in a spaced apart relationship, each support bracket having a support arm extending outwardly from the support bracket such that the support arms are generally aligned with each other, and
a shaft selectively supported by the support arms and extending between the support arms wherein a reel is removably positionable on the shaft.

2. The cart of claim 1 wherein each support arm includes an angled surface proximate an interface between the support arm and the support bracket, and further wherein the angled surface extends generally upwardly from the support arm to the support bracket.

3. The cart of claim 1 wherein the reel rack assembly includes a frame removably coupled to the shaft and extending between opposite ends of the shaft, and further wherein when the shaft is selectively supported by the support arms, the frame is pivotable relative to the support brackets.

4. The cart of claim 3 wherein the frame includes a central portion extending between end portions, each end portion coupled to one end of the shaft.

5. The cart of claim 4 wherein each end portion is generally V-shaped and includes a first leg and a second leg, and further wherein the second leg of each end portion defines a support surface of the frame and the end of the shaft is coupled to the end portion at an intersection of the first and second legs.

6. The cart of claim 5 wherein a second shaft extends between the second legs of the end portions of the frame.

7. The cart of claim 5 wherein the second leg of each end portion of the frame defines a notch and each support arm includes a stop such that when the shaft is selectively supported by the support arms each notch engages the stop of the corresponding support arm.

8. The cart of claim 5 wherein a tab is coupled to the central portion and further defines the support surface of the frame.

9. The cart of claim 5 wherein the frame has a height between the shaft and the support surface, and further wherein the height is greater than a radius of the reel removably positionable on the shaft.

10. The cart of claim 4 wherein the central portion includes a strength member.

11. The cart of claim 1 wherein each support bracket includes a body coupled to the wall and a base defining the support arm, and further wherein the base is pivotally coupled to the body such that the body is movable between a use position, in which the support arm extends outwardly from the base, and a stored position, in which the support arm is positioned generally in a plane of the base.

12. An industrial cart comprising:
a base having a base support surface for supporting an item;
a wheel connected to the base and operable to support the car for movement over ground;
a table having a table support surface for supporting an item, the table being supported in spaced relation from and being at least partially above the base;
a plurality of uprights cooperating to support the table in spaced relation from the base wherein at least one of the plurality of uprights is provided by a wall; and
a reel rack assembly coupled to the wall, the reel rack assembly including
a pair of support brackets coupled to the wall in a spaced apart relationship, each support bracket having a support arm extending outwardly from the support bracket such that the support arms are generally aligned with each other, and
a shaft selectively supported by the support arms and extending between the support arms wherein reels are removably positionable on the shaft.

13. The industrial cart of claim 12 wherein each support arm includes an angled surface proximate the interface between the support arm and the support bracket, and further wherein the angled surface extends generally upwardly from the support arm towards the support bracket.

14. The industrial cart of claim 12 wherein the reel rack assembly includes a frame removably coupled to the shaft and extending between opposite ends of the shaft, the frame including a central portion and spaced apart end portions with each end portion coupled to one end of the shaft.

15. The industrial cart of claim 14 wherein each end portion is generally V-shaped and includes a first leg and a second leg, and further wherein the second leg of each end portion defines a support surface of the frame.

16. The industrial cart of claim 15 wherein a second shaft extends between the second legs of the end portions of the frame.

17. The industrial cart of claim 15 wherein a tab is coupled to the central portion and further defines the support surface of the frame.

18. The industrial cart of claim 14 wherein each end portion of the frame defines a notch and each support arm includes a stop such that when the shaft is selectively supported by the support arms each notch engages the stop of the corresponding support arm.

19. A cart comprising:
a cart frame, the cart frame including a wall;
a wheel connected to the cart frame and operable to support the cart for movement over the ground;
a reel rack assembly coupled to the wall, the reel rack assembly including
a pair of support brackets coupled to the wall in a spaced apart relationship, each support bracket having a support arm extending outwardly from the support bracket such that the support arms are generally aligned with each other,
a shaft selectively supported by the support arms and extending between the support arms wherein a reel is removably positionable on the shaft, and
a frame removably coupled to the shaft and extending between opposite ends of the shaft, the frame including a central portion extending between first and second end portions, wherein each end portion is generally V-shaped and includes a first leg and a second leg, the second leg defining a support surface of the frame, and the shaft being coupled to each end portion at an intersection of the first and second legs, and further wherein the frame has a height between the shaft and the support surface, the height being greater than a radius of the reel removably positionable on the shaft.

20. The cart of claim 19 wherein the second leg of each end portion of the frame defines a notch and each support arm includes a stop such that when the shaft is selectively supported by the support arms each notch engages the stop of the corresponding support arm.
